(19) United States
(12) Patent Application Publication
(10) Pub. No.: US 2022/0361492 A1
(43) Pub. Date: Nov. 17, 2022

(54) ACTIVE COMPOUND COMBINATIONS COMPRISING FATTY ACIDS

(71) Applicant: Bayer Aktiengesellschaft, Leverkusen (DE)

(72) Inventors: Sybille LAMPRECHT, Leverkusen (DE); Ludger TRIEBUS, Monheim am Rhein (DE); Christian ARNOLD, Monheim am Rhein (DE)

(21) Appl. No.: 17/762,889

(22) PCT Filed: Oct. 1, 2020
(86) PCT No.: PCT/EP2020/077463

§ 371 Date: Mar. 23, 2022

(30) Foreign Application Priority Data
Oct. 2, 2019 (EP) 19201121.1
Nov. 6, 2019 (EP) 19207495.3

(51) Int. Cl. A01N 37/02; A01N 37/06; A01N 59/20; A01N 59/16; A01N 59/02; A01P 21/00

(52) U.S. Cl. CPC A01N 37/02; A01N 37/06; A01N 59/20; A01N 59/16; A01N 59/02; A01P 21/00

(57) ABSTRACT

The present invention relates to active compound combinations, in particular within a fungicide composition, which comprise as compound (a) one or more fatty acids or derivatives thereof selected from unsaturated and saturated C₁₂₋₂₄ fatty acids, salts thereof, esters thereof or mixtures of any of the foregoing and as compound (b) at least one further agent active against at least one plant pathogen and/or active in plant growth promotion. Moreover, the invention relates to fungicide and/or plant health compositions comprising such compound combination and to the use of the compound combinations and the fungicide compositions as biologically active agent, especially for control of phytopathogenic fungi in crop protection and in the protection of industrial materials and as plant growth regulators and for improving plant health.

The present invention relates to active compound combinations, in particular within a fungicide composition, which comprise as compound (a) one or more fatty acids or derivatives thereof selected from unsaturated and saturated C₁₂₋₂₄ fatty acids, salts thereof, esters thereof or mixtures of any of the foregoing and as compound (b) at least one further agent active against at least one plant pathogen and/or active in plant growth promotion. Moreover, the invention relates to fungicide and/or plant health compositions comprising such compound combination and to the use of the compound combinations and the fungicide compositions as biologically active agent, especially for control of phytopathogenic fungi in crop protection and in the protection of industrial materials and as plant growth regulators and for improving plant health.

Throughout this application the terms “composition” and “formulation” are used synonymously and refer to mixtures of a compound combination of the invention and at least one agriculturally suitable auxiliary.

WO2016/189329 discloses the use of a combination of certain fatty acids and a Trichoderma strain to increase plant health or to combat nematodes or certain fungal diseases. WO2017/092978 discloses compositions of a metal compound and certain fatty acids for crop defense and against fungi, oomycetes and bacteria.

Albeit fatty acids or fatty acid derivatives provide excellent means in protecting plants from insect pests, there is still the need to even improve those means in order to address the ever increasing environmental and economic requirements imposed on modern-day crop protection agents and compositions. This includes, for example, improvement to the spectrum of action, safety profile, selectivity, application rate, formation of residues, and favorable preparation ability, and development of new compositions to deal with potential problems, like resistances.

The present invention provides active compound combinations and compositions comprising said combinations which at least in some aspects achieve the stated objective.

Accordingly, the present invention provides active compound combinations comprising (a) one or more fatty acids or derivatives thereof selected from unsaturated and saturated C₁₂₋₂₄ fatty acids, salts thereof, esters thereof or mixtures of any of the foregoing; and (b) at least one further agent active against at least one plant pathogen and/or active in plant growth promotion.

The term “one or more” in connection with the present invention relates to one or more different members of a kind, for example two, three, four etc. different kinds of fatty acids or derivatives thereof as described herein.

Compound a) as well as compound b) may comprise more than one active ingredient. For example, compound a) may comprise more than one different fatty acids or derivatives thereof as described hereunder. Equally, compound b) may comprise more than one further agent active against at least one plant pathogen and/or active in plant growth promotion. In such cases, such compound a) or b) may also be referred to as component a) or component b).

Compounds a) and b) of the present active compound combination may be present in a composition, which is obtained e.g. by mixing both compounds with at least one agriculturally acceptable auxiliary. Another way of obtaining a composition of both compounds is to mix a composition comprising compound a) and another composition comprising compound b), wherein each of these compositions comprise the respective compound mixed with at least one agriculturally acceptable auxiliary. In other words, the latter composition is composed of two formulations comprising one of compounds a) or b).

An “agent active against at least one plant pathogen” refers to an agent which is able to increase mortality or inhibit the growth rate of at least one plant pathogen. Plant pathogens include plant pathogenic bacteria, fungi and oomycetes.

Agents “active in plant growth promotion” relate to those agents which action leads to any one or more of tillering increase, increase in plant height, bigger leaf blade, bigger leaf surface, stronger tillers, timing of, e.g. earlier, flowering, reduced blossom drop, early grain maturity, earlier or prolonged fruit set, less plant verse (lodging), increased shoot growth, increased plant stand, early and/or better germination, earlier and/or increased emergence, improved crop yield, improved total vegetative weight or whole plant biomass, improved protein content, improved oil content, improved starch content, improved root growth (including root length), improved root size (including root surface), improved root weight and/or improved root effectiveness, improved shoot weight, increased root weight, increased plant biomass and improved fruit weight. The skilled person is aware that in some cases, the scope of terms here listed as falling within plant health may as well extend to plant growth and vice versa. Preferably, the term relates to leaf surface, root growth, root size, root weight, fruit weight, shoot weight, plant biomass and/or crop yield

Fatty acids are compounds of formula RCO2H where R is an aliphatic hydrocarbon group. Typically, R is a long chain aliphatic hydrocarbon group. For the purpose of the present invention, R may be a saturated or unsaturated aliphatic hydrocarbon group having from 11 to 23 carbons (i.e. a C12-24 fatty acid). Typically, R is a linear, saturated or unsaturated aliphatic hydrocarbon group having from 11 to 23 carbon atoms, e.g. a linear C11-23 alkane group or a linear C11-23 alkene group. R is often a linear, saturated or unsaturated, aliphatic hydrocarbon group having from 11 to 21 carbon atoms, e.g. a linear C11-21 alkane group or a linear C11-21 alkene group. Unsaturated aliphatic hydrocarbon groups typically contain from 1 to 4 double bonds, for instance 1 or 2 double bonds.

Derivatives of fatty acids include salts, esters and amides of the fatty acid. Typically, a derivative of the fatty acid, as used herein is a salt or an ester of the fatty acid.

An ester of a fatty acid is typically an ester of the fatty acid with an alcohol such as methanol, ethanol, propanol, butanol, ethane-1,2-diol, propane-1,3-diol and propane-1,2,3-triol (glycerol). The derivative of the fatty acid may be a salt of the fatty acid or a methyl ester of the fatty acid (i.e. RCO2Me). Alternatively, the derivative of the C12-C24 fatty acid may be an ester of methanol, ethanol, 1-propanol, 2-propanol, butanol or a mixture thereof

A salt of a fatty acid is typically a metal salt of the fatty acid. Often, the one or more fatty acids or derivatives thereof are one or more metal salts of fatty acids. The metal salts are typically alkali metal salts or earth alkali metal salts, but also comprise aluminum, copper, iron and zinc salts. Alkali metal salts of fatty acids include lithium, sodium, potassium and rubidium salts of fatty acids. The composition may therefore comprise one or more fatty acids or sodium or potassium salts thereof. For instance, compound/component (a) may be one or more sodium or potassium salt of fatty acids. Earth alkali metal salts of fatty acids include magnesium and calcium salts. The active compound combination may therefore comprise one or more fatty acids or magnesium or calcium salts thereof as component a). For instance, component (a) may be one or more magnesium or calcium salt of fatty acids. Alternatively, or in addition, component (a) may be one or more aluminum, copper, iron or zinc salt of fatty acids. Such salts may be formed by reacting the one or more fatty acids with a base comprising the desired metal cation, for instance by reacting one or more fatty acids with sodium hydroxide or potassium hydroxide in case of alkali metals, magnesium hydroxide or calcium hydroxide for earth alkali metals, or aluminum hydroxide, copper hydroxide, zinc hydroxide or iron hydroxide for other metals.

In a preferred embodiment, compound/component a) is one or more fatty acid (hereinafter also sometimes referred to as (I.01)). In other words, in this preferred embodiment, the active compound combination according to the invention comprises one or more fatty acids but not salts or derivatives thereof.

The one or more fatty acids or derivatives thereof as described above may be present in a mixture. For example, component a) may comprise one or more fatty acids and one or more esters of at least one fatty acid and/or one or more salt of a fatty acid. In this respect, the fatty acid forming the basis of the one or more ester and/or the one or more salt of fatty acids may be the same or a different fatty acid than a fatty acid comprised in the part of the composition according to a). For example, if a mixture of fatty acids and salts of fatty acids is present, the ratio of fatty acids:salts of fatty acids may range between 1:10000 and 10000:1, such as between 1:1000 and 1000:1.

The one or more fatty acids or derivatives thereof are typically selected from: saturated or unsaturated acids selected from

undecylic acid (C11), lauric acid (C12), tridecylic acid (C13), myristic acid (C14), pentadecanoic acid (C15), palmitic acid (C16), margaric acid (C17), stearic acid (C18), nonadecylic acid (C19), arachidic acid (C20), heneicosylic acid (C21), behenic acid (C22), tricosylic acid (C23), lignoceric acid (C24), and derivatives thereof; and unsaturated acids selected from u-linolenic acid (C18:3), stearidonic acid (C18:4), eicosapentaenoic acid (C20:5), docosahexaenoic acid (C22:6), linoleic acid (C18:2),y-linolenic acid (C18:3), dihomo-y-linolenic acid (C20:3), arachidonic acid (C20:4), adrenic acid (C22:4), palmitoleic acid (C16:1), vaccenic acid (C18:1), paullinic acid (C20:1), oleic acid (C18:1), elaidic acid (Ctrans-18:1), gondoic acid (C20:1), erucic acid (C22:1), nervonic acid (C24:1), mead acid (20:3) and derivatives thereof.

The notation CM:N fatty (where M and N are integers), as used herein, means that the fatty acid comprises M carbon atoms and N double bonds. The N double bonds may be at any position (cis or trans configuration), although two double bonds are not usually adjacent (i.e. bonded to the same carbon atom). Thus, C18:0 (or simply C18) covers only octadecanoic acid (stearic acid) and C18: lincludes all fatty acids having 18 carbons and one double bond, such as oleic acid ((Z)-octadec-9-enoic acid) and vaccenic acid ((E)-octadec-11-enoic acid).

The fatty acids or derivatives thereof may originate from any plant producing such fatty acids, preferably from an organ of a plant producing and/or containing high contents of fatty acids such as seeds. Examples of such seeds include apple seed, argan seed, coconut, colza, canola, corn, cottonseed, grape seed, hazelnut, macadamia, mustard, niger seed, olive, palm kernel, peanut, poppyseed, pumpkin seed, ramtil, rice bran, safflower, soybean, sesame, sunflower, tamarind seed, tea seed and walnut. Preferably, the fatty acids or derivatives thereof originate from olive oil, sunflower oil (both regular and high oleic acid sunflower oil), soybean oil and canola oil. More preferably, the fatty acids originate from olive oil obtained from the endocarp and/or olive seed (olive pits). The fatty acids or derivatives thereof may also be Tall Oil Fatty Acids (TOFA). TOFA are based on a by-product of the Kraft process of wood pulp manufacture when pulping mainly coniferous trees called tall oil and are a result of reducing rosin content of tall oil to between 1 and 10 wt. %, e.g. by fractional distillation. TOFA consists mainly of oleic acid.

The fatty acids or derivatives thereof may equally originate from animals (for a review see Food Processing: Principles and Applications, Second Edition. Edited by Stephanie Clark, Stephanie Jung, and Buddhi Lamsal® 2014 John Wiley & Sons, Ltd. Published 2014 by John Wiley & Sons, Ltd; Chapter 21: Fats and Oils—Animal Based).

In the course of the present invention, it has surprisingly been found that the action of certain pesticidal agents can be enhanced by co-application of one or more fatty acid or derivative thereof according to the invention. Fatty acids and derivatives thereof are themselves also considered to be biological plant protection agents and have obtained market authorization as such, thus the combination of such agents with other biological control agents results in an efficient measure for biological plant protection which can be similar to the application of chemical plant protection agents. In combinations comprising a chemical pesticidally active agent as compound/component b), combination of both may result in increased efficacy, a different efficacy spectrum or reduced residues due to less chemical agents needed to be applied.

In one embodiment, said one or more fatty acids or derivatives thereof are selected from unsaturated and saturated C14-20 fatty acids, salts thereof, esters thereof or mixtures of any of the foregoing. The one or more fatty acids or derivatives thereof may also be selected from unsaturated and saturated unsaturated and saturated C16-20 fatty acids, and salts or esters thereof

Preferably, the one or more fatty acids or derivatives thereof comprises two or more fatty acids selected from C16:0 fatty acids, C16:1 fatty acids, C18:0 fatty acid, C18:lfatty acids, C18:2 fatty acids, and C18:3 fatty acids, or salts (for instance potassium or sodium salts) or other derivatives thereof.

For instance, the one or more fatty acids may comprise the following fatty acids in the following proportions:

C16 fatty acids from 1 to 10 wt %;

C16:1 fatty acids from 0 to 5 wt %;

C18:1 fatty acids from 60 to 94 wt %; and

C18:2 fatty acids from 5 to 20 wt %.

In connection with this and the following embodiments, if reference is made to fatty acids, this equally encompasses salts and other derivatives of fatty acids. The term is used to denote the basic structural features of the underlying fatty acid(s).

Often, the one or more fatty acids comprise the following fatty acids in the following proportions:

C16 fatty acids from 3 to 7 wt %;

C16:1 fatty acids from 0 to 4 wt %;

C18:1 fatty acids from 70 to 89 wt %; and

C18:2 fatty acids from 8 to 18 wt %.

Fatty acid amounts in wt % as used in the present invention are relative to the total amount of fatty acids in the composition.

The one or more fatty acids or derivatives thereof may comprise:

sodium or potassium salts of C16 fatty acids in an amount of from 1 to 10 wt %;

sodium or potassium salts of C16:1 fatty acids in an amount of from 0 to 5 wt %;

sodium or potassium salts of C18:1 fatty acids in an amount of from 60 to 94 wt %;

and sodium or potassium salts of C18:2 fatty acids in an amount of from 5 to 20 wt %.

Often, the one or more fatty acids comprise the following fatty acids in the following proportions:

sodium or potassium salts of C16 fatty acids in an amount of from 3 to 7 wt %;

sodium or potassium salts of C16:1 fatty acids in an amount of from 0 to 4 wt %;

sodium or potassium salts of C18:1 fatty acids in an amount of from 70 to 89 wt %;

and sodium or potassium salts of C18:2 fatty acids in an amount of from 8 to 18 wt %.

It is preferred that the one or more fatty acid or derivative thereof, in particular sodium or potassium salts comprise C18, C18:1, C18:2 and C18:3 fatty acids or derivatives thereof which amount to at least 90 wt.-% of the total fatty acid content, preferably at least 95wt.-%, possibly up to 97 wt.-%.

In particular, the one or more fatty acids or derivatives thereof may comprise one or more of oleic acid (C18:1), linoleic acid (C18:2), y-linolenic acid (C18:3), palmitoleic acid (C16:1), vaccenic acid (C18:1), paullinic acid (C20:1), elaidic acid (Ctrans-18:1) or derivatives thereof or a mixture of any of the foregoing.

In one preferred embodiment, the one or more fatty acids or derivatives thereof comprises oleic acid or a salt thereof. The one or more fatty acid or derivatives thereof typically comprise at least 70 wt % of oleic acid or a salt thereof, for instance a potassium salt of oleic acid (potassium oleate). More preferably, in this embodiment, said one or more fatty acid in addition comprises a C16-C20 fatty acid or derivative thereof. It is even more preferred that the one or more fatty acid is not derivatized and comprises oleic acid. In an alternative much preferred embodiment, the one or more fatty acids are derivatives in the form of potassium salts.

Whereas up to 97% of the one or more fatty acids or derivatives thereof are in the range of C14-C20, minor percentages of fatty acids or derivatives thereof may be C12, C13, C21 or C22 fatty acids or derivatives thereof It is even more preferred that up to 95wt.-% of one or more fatty acids or derivatives thereof are C18, C18:1, C18:2 and C18:3. In this embodiment, the remaining percentage of fatty acids or derivatives thereof are in the range of C12 to C17, such as C14, C16, C16:1 and C17, and C19 to C22.

In one embodiment, no fatty acids or derivatives thereof in the range below C12 or above C22 are present.

Alternative preferred embodiments are those further comprising a metal complex selected from the group consisting of copper mandelate, copper salicylate, copper anthranilate, copper 2,6-dihydroxybenzoate, copper benzenesulphonate, zinc mandelate, zinc salicylate, zinc anthranilate, zinc benzenesulphonate, iron mandelate, iron salicylate, iron 2,6-dihydroxybenzoate, silver mandelate, silver anthranilate, silver benzenesulphonate, magnesium mandelate, magnesium 2,6-dihydroxybenzoate, and mixtures thereof, in addition to a C16-C20 fatty acid or derivative thereof, said fatty acid or derivative thereof being a mixture comprising at least 70 wt % of potassium oleate, on the weight of the derivative of C16-C20 fatty acid.

In another preferred embodiment, the one or more fatty acids or derivatives thereof comprise one or more metal or alkali metal salts of fatty acids. Such metal or alkali metal salts of fatty acids are obtainable by a process comprising (a) Providing a vegetable oil; (b) Hydrolyzing triglycerides in the vegetable oil; (c) Extracting fatty acids from the hydrolyzed vegetable oil; and (d) Forming the metal or alkali metal salts of the extracted fatty acids. Preferably the alkali metal is potassium and/or the composition of fatty acids is as described above.

The vegetable oil is an oil or fat derived from a plant or animal and may comprise triglycerides, lipids, and fatty acids. Examples of oils derived from plants include apple seed oil, argan oil, coconut oil, colza oil, canola oil, corn oil, cottonseed oil, grape seed oil, hazelnut oil, macadamia oil, mustard oil, niger seed oil, olive oil, palm kernel oil, peanut oil, poppyseed oil, pumpkin seed oil, ramtil oil, rice bran oil, safflower oil, soybean oil, sesame oil, sunflower oil, tamarind seed oil, tea seed oil and walnut oil. Examples of oils derived from animals include fats derived from animal rendering. Preferably, the vegetable oil is olive oil.

Hydrolysing triglycerides in the vegetable oil typically comprises treating the vegetable oil with an aqueous acid, for instance aqueous sulfuric acid, but may also be effected using other means such as heat treatment. The treated vegetable oil may be heated.

Extracting fatty acids from the hydrolysed vegetable oil may be done by any suitable method as are well known to the skilled person, for instance evaporation, solvent extraction, liquid-liquid extraction or chromatography.

Forming the metal or alkali metal salts of the extracted fatty acids may be done by any suitable method are well known to the skilled person. Typically, this comprises treating the fatty acids with a base comprising the metal or alkali metal, e.g. a metal or alkali metal hydroxide such as KOH or NaOH. The metal is often an alkali metal, e.g. Li, Na, K or Rb, oreferably K, or an alkali earth metal, e.g. Mg, Ca, Sr or Ba.

In some cases, the fatty acid derivatives may be formed starting simply from a composition comprising the fatty acids. Thus, the fatty acid component may be produced by providing one or more fatty acids and forming the metal or alkali metal salts of the extracted fatty acids.

In some embodiments, said fatty acid derivatives are salts of lithium, sodium, potassium, magnesium, calcium, or a mixture thereof.

In a more preferred embodiment, the one or more fatty acid derivatives are alkali metal salts of fatty acids, preferably potassium salts of fatty acids (hereinafter sometimes also referred to as (I.02)).

In an alternative embodiment, the fatty acid is not derivatized.

The total amount of the one or more fatty acids or derivatives thereof depends on the intended use and is often from 0.01 to 10 vol % for ready-to-use formulations, or from 0.5 to 7 vol %. For instance, the concentration of the fatty acid component may be from 0.5 to 30 g/L or from 1 to 20 g/L. Preferably, the concentration of the fatty acid component is from 3 to 15 g/L, for instance from 7 to 12 g/L. In concentrated formulations, the total amount of the one or more fatty acids or derivatives thereof may range between 20 and 60 wt.-%, such as between 25 and 55 wt.-%.

At the concentrations given above for the one or more fatty acid or derivatives thereof, the active compound combination is typically in a form suitable for application to plants. The composition may of course also be presented in a form suitable for storage or transport. In such cases, the concentration is typically much higher. For instance, the concentration of the fatty acid component may be greater than 100 ml/L or greater than 500 ml/L.

The active compound combinations according to the invention comprise as compound (b) at least one further active compound selected from the following groups
(1) inhibitors of the ergosterol synthesis,
(2) inhibitors of the respiratory chain at complex I or II,
(3) inhibitors of the respiratory chain at complex III,
(4) inhibitors of the mitosis and cell division,
(5) compounds capable of having a multisite action,
(6) compounds capable of inducing a host defense,
(7) inhibitors of the amino acid and/or protein biosynthesis,
(8) inhibitors of the ATP production,
(9) inhibitors of the cell wall synthesis,
(10) inhibitors of the lipid and membrane synthesis,
(11) inhibitors of the melanine biosynthesis,
(12) inhibitors of the nucleic acid synthesis,
(13) inhibitors of the signal transduction,
(14) compounds capable of acting as uncoupler,
(15) other fungicides selected from the group consisting of (15.001) Abscisic acid, (15.002) benthiazole, (15.003) bethoxazin, (15.004) capsimycin, (15.005) carvone, (15.006) chinomethionat, (15.007) cufraneb, (15.008) cyflufenamid, (15.009) cymoxanil, (15.010) cyprosulfamide, (15.011) flutianil, (15.012) fosetyl-aluminium, (15.013) fosetyl-calcium, (15.014) fosetyl-sodium, (15.015) methyl isothiocyanate, (15.016) metrafenone, (15.017) mildiomycin, (15.018) natamycin, (15.019) nickel dimethyldithiocarbamate, (15.020) nitrothal-isopropyl, (15.021) oxamocarb, (15.022) Oxathiapiprolin, (15.023) oxyfenthiin, (15.024) pentachlorophenol and salts, (15.025) phosphorous acid and its salts, (15.026) propamocarb-fosetylate, (15.027) pyriofenone (chlazafenone), (15.028) tebufloquin, (15.029) tecloftalam, (15.030) tolnifanide, (15.031) 1-(4-{4-[(5 R)-5-(2,6-difluorophenyl)-4,5-dihydro-1,2-oxazol-3-yl]-1,3-thiazol-2-yl}piperidin-1-yl)-2-[5-methyl-3-(trifluoromethyl)-1H-pyrazol-1-yl]ethanone, (15.032) 1-(4-{4-[(5S)-5-(2,6-difluorophenyl)-4,5-dihydro-1,2-oxazol-3-yl]-1,3-thiazol-2-yl}piperidin-1-yl)-2-[5-methyl-3-(trifluoromethyl)-1H-pyrazol-1-yl]ethanone, (15.033) 2-(6-benzylpyridin-2-yl)quinazoline, (15.034) dipymetitrone, (15.035) 2-[3,5-bis(difluoromethyl)-1H-pyrazol-1-yl]-1-[4-(4-{5-[2-(prop-2-yn-1-yloxy)phenyl]-4,5-dihydro-1,2-oxazol-3-yl}-1,3-thiazol-2-yl)piperidin-1-yl]ethanone, (15.036) 2-[3,5-bis(difluoromethyl)-1H-pyrazol-1-yl]-1-[4-(4-{5-[2-chloro-6-(prop-2-yn-1-yloxy)phenyl]-4,5-dihydro-1,2-oxazol-3-yl}-1,3-thiazol-2-yl)piperidin-1-yl]ethanone, (15.037) 2-[3,5-bis(difluoromethyl)-1H-pyrazol-1-yl]-1-[4-(4-{5-[2-fluoro-6-(prop-2-yn-1-yloxy)phenyl]-4,5-dihydro-1,2-oxazol-3-yl}-1,3-thiazol-2-yl)piperidin-1-yl]ethanone, (15.038) 2-[6-(3-fluoro-4-methoxyphenyl)-5-methylpyridin-2-yl]quinazoline, (15.039) 2-{(5R)-3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}-3-chlorophenyl methanesulfonate, (15.040) 2-{(5S)-3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}-3-chlorophenyl methanesulfonate, (15.041) Ipflufenoquin, (15.042) 2-{2-fluoro-6-[(8-fluoro-2-methylquinolin-3-yl)oxy]phenyl}propan-2-ol, (15.043)fluoxapiprolin, (15.044) 2-{3-[2-(1-{[3 ,5-bis(difluoromethyl)-1H-pyrazol-1-yl]acetyl}piperidin-4-yl)-1,3-thiazol-4-yl]-4,5-dihydro-1,2-oxazol-5-yl}phenyl methanesulfonate, (15.045) 2-phenylphenol and salts, (15.046) 3-(4,4,5-trifluoro-3,3-dimethyl-3,4-dihydroisoquinolin-1-yl)quinoline, (15.047) quinofumelin, (15.048) 4-amino-5-fluoropyrimidin-2-ol (tautomeric form: 4-amino-5-fluoropyrimidin-2(1H)-one), (15.049) 4-oxo-4-[(2-phenylethyl)amino]butanoic acid, (15.050) 5-amino-1,3,4-thiadiazole-2-thiol, (15.051) 5-chloro-N′-phenyl-N′-(prop-2-yn-1-yl)thiophene-2-sulfonohydrazide, (15.052) 5-fluoro-2-[(4-fluorobenzyl)oxy]pyrimidin-4-amine, (15.053) 5-fluoro-2-[(4-methylbenzyl)oxy]pyrimidin-4-amine, (15.054) 9-fluoro-2,2-dimethyl-5-(quinolin-3-yl)-2,3-dihydro-1,4-benzoxazepine, (15.055) but-3-yn-1-yl {6-[({[(Z)-(1-methyl-1H-tetrazol-5-yl)(phenyl)methylene]amino}oxy)methyl]pyridin-2-yl}carbamate, (15.056) ethyl (2Z)-3-amino-2-cyano-3-phenylacrylate, (15.057) phenazine-1-carboxylic acid, (15.058) propyl 3,4,5-trihydroxybenzoate, (15.059) quinolin-8-ol, (15.060) quinolin-8-ol sulfate (2:1), (15.061) tert-butyl {6-[({[(1-methyl-1H-tetrazol-5-yl)(phenyl)methylene]amino}oxy)methyl]pyridin-2-yl}carbamate, (15.062) 5-fluoro-4-imino-3-methyl-1-[(4-methylphenyl)sulfonyl]-3,4-dihydropyrimidin-2(1H)-one, (15.063) aminopyrifen, (15.064) (N′-[2-chloro-4-(2-fluorophenoxy)-5-methylphenyl]-N-ethyl-N-methylimidoformamide), (15.065) (N′-(2-chloro-5-methyl-4-phenoxyphenyl)-N-ethyl-N-methylimidoformamide), (15.066) (2-{2-[(7,8-difluoro-2-methylquinolin-3-yl)oxy]-6-fluorophenyl}propan-2-ol), (15.067) (5-bromo-1-(5,6-dimethylpyridin-3-yl)-3,3-dimethyl-3,4-dihydroisoquinoline), (15.068) (3-(4,4-difluoro-5,5-dimethyl-4,5-dihydrothieno[2,3-c]pyridin-7-yl)quinoline), (15.069) (1-(4,5-dimethyl-1H-benzimidazol-1-yl)-4,4-difluoro-3,3-dimethyl-3,4-dihydroisoquinoline), (15.070) 8-fluoro-3-(5-fluoro-3,3-dimethyl-3,4-dihydroisoquinolin-1-yl)quinolone, (15.071) 8-fluoro-3-(5-fluoro-3,3,4,4-tetramethyl-3,4-dihydroisoquinolin-1-yl)quinolone, (15.072) 3-(4,4-difluoro-3,3-dimethyl-3,4-dihydroisoquinolin-1-yl)-8-fluoroquinoline, (15.073) (N-methyl-N-phenyl-4-[5-(trifluoromethyl)-1,2,4-oxadiazol-3-yl]benzamide), (15.074) (methyl{4-[5-(trifluoromethyl)-1,2,4-oxadiazol-3-yl]phenyl}carbamate), (15.075) (N-{4-[5-(trifluoromethyl)-1,2,4-oxadiazol-3-yl]benzyl}cyclopropanecarboxamide), (15.076) N-methyl-4-(5-(trifluoromethyl)-1,2,4-oxadiazol-3-yl]benzamide, (15.077) N-[(E)-methoxyiminomethyl]-4-[5-(trifluoromethyl)-1,2,4-oxadiazol-3-yl]benzamide, (15.078) N-[(Z)-methoxyiminomethyl]-4-[5-(trifluoromethyl)-1,2,4-oxadiazol-3-yl]benzamide, (15.079) N-[4-[5-(trifluoromethyl)-1,2,4-oxadiazol-3-yl]phenyl]cyclopropanecarboxamide, (15.080) N-(2-fluorophenyl)-4-[5-(trifluoromethyl)-1,2,4-oxadiazol-3-yl]benzamide, (15.081) 2,2-difluoro-N-methyl-2-[4-[5-(trifluoromethyl)-1,2,4-oxadiazol-3-yl]phenyl]acetamide, (15.082) N-allyl-N-[[4-[5-(trifluoromethyl)-1,2,4-oxadiazol-3-yl)phenyl]methyl]acetamide, (15.083) N-[(E)-N-methoxy-C-methyl-carbonimidoyl]-4-[5-(trifluoromethyl)-1,2,4-oxadiazol-3-yl]benzamide, (15.084) N-[(Z)-N-methoxy-C-methyl-carbonimidoyl]-4-[5-(trifluoromethyl)-1,2,4-oxadiazol-3-yl]benzamide, (15.085) N-allyl-N-[[4-[5-(trifluoromethyl)-1,2,4-oxadiazol-3-yl]phenyl]methyl]propanamide, (15.086) 4,4-dimethyl-1-[[4-[5-(trifluoromethyl)-1,2,4-oxadiazol-3-yl]phenyl]methyl]pyrrolidin-2-one, (15.087) N-methyl-4-[5-(trifluoromethyl)-1,2,4-oxadiazol-3-yl]benzenecarbothioamide, (15.088) 5-methyl-1-[[4-[5-(trifluoromethyl)-1,2,4-oxadiazol-3-yl]phenyl]methyl]pyrrolidin-2-one, (15.089) N-((2,3-difluoro-4-[5-(trifluoromethyl)-1,2,4-oxadiazol-3-yl]phenyl]methyl]-3,3,3-trifluoro-propanamide, (15.090) 1-methoxy-1-methyl-3-[[4-[5-(trifluoromethyl-1,2,4-oxadiazol-3-yl]phenyl]methyl]urea, (15.091) 1,1-diethyl-3-[[4-[5-(trifluoromethyl}-1,2,4-oxadiazol-3-yl]phenyl]methyl]urea, (15.092) N-[[4-[5-(trifluoromethyl)-1,2,4-oxadiazol-3-yl]phen-yl]methyl]propanamide, (15.093) N-methoxy-N-[[4-[5-(trifluoromethyl)-1,2,4-oxadiazol-3-yl]phenyl]methyl]cyclopropanecarboxamide, (15.094) 1-methoxy-3-methyl-1-[[4-[5-(trifluoromethyl)-1,2,4-oxadiazol-3-yl]phenyl]methyl]urea, (15.095) N-methoxy-N-[[4-[5-(trifluoromethyl)-1,2,4-oxadiazol-3-yl]phenyl]methyl)cyclopropanecarboxamide, (15.096) N,2-dimethoxy-N-[[4-[5-(trifluoromethyl-1,2,4-oxadiazol-3-yl]phenyl]methyl]propanamide, (15.097) N-ethyl-2-methyl-N-[[4-[5-(trifluoromethyl)-1,2,4-oxadiazol-3-yl)phenyl]methyl]propanamide, (15.098) 1-methoxy-3-methyl-1-[[4-[5-(trifluoromethyl)-1,2,4-oxadiazol-3-yl]phenyl]methyl]urea, (15.099) 1,3-dimethoxy-1-[[4-[5-(trifluoromethyl)-1,2,4-oxadiazol-3-yl]phenyl]methyl]urea, (15.100) 3-ethyl-1-methoxy-1-[[4-[5-(trifluoromethyl)-1,2,4-oxadiazol-3-yl]phenyl]methyl]urea, (15.101) 1-[[4-[5-(trifluoromethyl)-1,2,4-oxadiazol-3-yl]phenyl]methyl]piperidin-2-one, (15.102) 4,4-dimethyl-2-[[4-[5-(trifluoromethyl)-1,2,4-oxadiazol-3-yl]phenyl]methyl]isooxazolidin-3-one, (15.103) 5,5-dimethyl-2-[[4-[5-(trifluoromethyl)-1,2,4-oxadiazol-3-yl]phenyl]methyl]isoxazolidin-3-one, (15.104) 3,3-dimethyl-1-[[4-[5-(trifluoromethyl)-1,2,4-oxadiazol-3-yl]phenyl]methyl]-piperidin-2-one, (15.105) 1-[[3-fluoro-4-(5-(trifluoromethyl)-1,2,4-oxadiazol-3-yl]phenyl]methyl]-azepan-2-one, (15.106) 4,4-dimethyl-2-[[4-(5-(trifluoromethyl)-1,2,4-oxadiazol-3-yl]phenyl]-methyl]isoxazolidin-3-one (15.107) 5,5-dimethyl-2-[[4-[5-(trifluoromethyl)-1,2,4-oxadiazol-3-yl]phenyl]methyl]isoxazolidin-3-one, (15.108) ethyl (1-{4-[5-(trifluoromethyl)-1,2,4-oxadiazol-3-yl]benzyl}-1H-pyrazol-4-ypacetate, (15.109) N,N-dimethyl-1-{4-[5-(trifluoromethyl)-1,2,4-oxadiazol-3-yl]benzyl}-1H-1,2,4-triazol-3-amine and (15.110) N-{2,3-difluoro-4-[5-(trifluoromethyl)-1,2,4-oxadiazol-3-yl]benzyl}butanamide.

Compound (B) is preferably selected from:

inhibitors of the ergosterol synthesis selected from the group consisting of (1.001) cyproconazole, (1.002) difenoconazole, (1.003) epoxiconazole, (1.004) fenhexamid, (1.005) fenpropidin, (1.006) fenpropimorph, (1.007) fenpyrazamine, (1.008) fluquinconazole, (1.009) flutriafol, (1.010) imazalil, (1.011) imazalil sulfate, (1.012) ipconazole, (1.013) metconazole, (1.014) myclobutanil, (1.015) paclobutrazol, (1.016) prochloraz, (1.017) propiconazole, (1.018) prothioconazole, (1.019) pyrisoxazole, (1.020) spiroxamine, (1.021) tebuconazole, (1.022) tetraconazole, (1.023) triadimenol, (1.024) tridemorph, (1.025) triticonazole, (1.026) (1R,2S,5S)-5-(4-chlorobenzyl)-2-(chloromethyl)-2-methyl-1-(1H-1,2,4-triazol-1-ylmethyl)cyclopentanol, (1.027) (1S,2R,5R)-5-(4-chlorobenzyl)-2-(chloromethyl)-2-methyl-1-(1H-1,2,4-triazol-1-ylmethyl)cyclopentanol, (1.028) (2R)-2-(1-chlorocyclopropyl)-4-[(1R)-2,2-dichlorocyclopropyl]-1-(1H-1,2,4-triazol-1-yl)butan-2-ol, (1.029) (2R)-2-(1-chlorocyclopropyl)-4-[(1S)-2,2-dichlorocyclopropyl]-1-(1H-1,2,4-triazol-1-yl)butan-2-ol, (1.030) (2R)-2-[4-(4-chlorophenoxy)-2-(trifluoromethyl)phenyl]-1-(1H-1,2,4-triazol-1-yl)propan-2-ol, (1.031) (2S)-2-(1-chlorocyclopropyl)-4-[(1R)-2,2-dichlorocyclopropyl]-1-(1H-1,2,4-triazol-1-yl)butan-2-ol, (1.032) (2S)-2-(1-chlorocyclopropyl)-4-[(1S)-2,2-dichlorocyclopropyl]-1-(1H-1,2,4-triazol-1-yl)butan-2-ol, (1.033) (2S)-2-[4-(4-chlorophenoxy)-2-(trifluoromethyl)phenyl]-1-(1H-1,2,4-triazol-1-yl)propan-2-ol, (1.034) (R)-[3-(4-chloro-2-fluorophenyl)-5-(2,4-difluorophenyl)-1,2-oxazol-4-yl](pyridin-3-yl)methanol, (1.035) (S)-[3-(4-chloro-2-fluorophenyl)-5-(2,4-difluorophenyl)-1,2-oxazol-4-yl](pyridin-3-yl)methanol, (1.036) [3-(4-chloro-2-fluorophenyl)-5-(2,4-difluorophenyl)-1,2-oxazol-4-yl](pyridin-3-yl)methanol, (1.037) 1-({(2R,4S)-2-[2-chloro-4-(4-chlorophenoxy)phenyl]-4-methyl-1,3-dioxolan-2-yl}methyl)-1H-1,2,4-triazole, (1.038) 1-({(2S,4S)-2-[2-chloro-4-(4-chloro-phenoxy)phenyl]-4-methyl-1,3-dioxolan-2-yl}methyl)-1H-1,2,4-triazole, (1.039) 1-{[3-(2-chlorophenyl)-2-(2,4-difluorophenyl)oxiran-2-yl]methyl}-1H-1,2,4-triazol-5-yl thiocyanate, (1.040) 1-{[rel(2R,3R)-3-(2-chlorophenyl)-2-(2,4-difluorophenyl)oxiran-2-yl]methyl}-1H-1,2,4-triazol-5-yl thiocyanate, (1.041) 1-{[rel(2R,3S)-3-(2-chlorophenyl)-2-(2,4-difluorophenyl)oxiran-2-yl]methyl}-1H-1,2,4-triazol-5-yl thiocyanate, (1.042) 2-[(2R,4R,5R)-1-(2,4-dichlorophenyl)-5-hydroxy-2,6,6-trimethylheptan-4-yl]-2,4-dihydro-3H-1,2,4-triazole-3-thione, (1.043) 2-[(2R,4R,5S)-1-(2,4-dichlorophenyl)-5-hydroxy-2,6,6-trimethylheptan-4-yl]-2,4-dihydro-3H-1,2,4-triazole-3-thione, (1.044) 2-[(2R,4S,5R)-1-(2,4-dichloro-phenyl)-5-hydroxy-2,6,6-trimethylheptan-4-yl]-2,4-dihydro-3H-1,2,4-triazole-3-thione, (1.045) 2-[(2R,4S,5S)-1-(2,4-dichlorophenyl)-5-hydroxy-2,6,6-trimethylheptan-4-yl]-2,4-dihydro-3H-1,2,4-triazole-3-thione, (1.046) 2-[(2S,4R,5R)-1-(2,4-dichlorophenyl)-5-hydroxy-2,6,6-trimethylheptan-4-yl]-2,4-dihydro-3H-1,2,4-triazole-3-thione, (1.047) 2-[(2S,4R,5S)-1-(2,4-dichlorophenyl)-5-hydroxy-2,6,6-trimethylheptan-4-yl]-2,4-dihydro-3H-1,2,4-triazole-3-thione, (1.048) 2-[(2S,4S,5R)-1-(2,4-dichloro-phenyl)-5-hydroxy-2,6,6-trimethylheptan-4-yl]-2,4-dihydro-3H-1,2,4-triazole-3-thione, (1.049) 2-[(2S,4S,5S)-1-(2,4-dichlorophenyl)-5-hydroxy-2,6,6-trimethylheptan-4-yl]-2,4-dihydro-3H-1,2,4-triazole-3-thione, (1.050) 2-[1-(2,4-dichlorophenyl)-5-hydroxy-2,6,6-trimethylheptan-4-yl]-2,4-dihydro-3H-1,2,4-triazole-3-thione, (1.051) 2-[2-chloro-4-(2,4-dichlorophenoxy)phenyl]-1-(1H-1,2,4-triazol-1-yl)propan-2-ol, (1.052) 2-[2-chloro-4-(4-chlorophenoxy)phenyl]-1-(1H-1,2,4-triazol-1-yl)butan-2-ol, (1.053) 2-[4-(4-chlorophenoxy)-2-(trifluoromethyl)phenyl]-1-(1H-1,2,4-triazol-1-yl)butan-2-ol, (1.054) 2-[4-(4-chlorophenoxy)-2-(trifluoromethyl)phenyl]-1-(1H-1,2,4-triazol-1-yl)pentan-2-ol, (1.055) Mefentrifluconazole, (1.056) 2-{[3-(2-chlorophenyl)-2-(2,4-difluorophenyl)oxiran-2-yl]methyl}-2,4-dihydro-3H-1,2,4-triazole-3-thione, (1.057) 2-{[rel(2R,3R)-3-(2-chlorophenyl)-2-(2,4-difluorophenyl)oxiran-2-yl]methyl}-2,4-dihydro-3H-1,2,4-triazole-3-thione, (1.058) 2-{[rel(2R,3S)-3-(2-chlorophenyl)-2-(2,4-difluorophenyl)oxiran-2-yl]methyl}-2,4-dihydro-3H-1,2,4-triazole-3-thione, (1.059) 5-(4-chlorobenzyl)-2-(chloromethyl)-2-methyl-1-(1H-1,2,4-triazol-1-ylmethyl)cyclopentanol, (1.060) 5-(allylsulfanyl)-1-{[3-(2-chlorophenyl)-2-(2,4-difluorophenyl)oxiran-2-yl]methyl}-1H-1,2,4-triazole, (1.061) 5-(allylsulfanyl)-1-{[rel(2R,3R)-3-(2-chlorophenyl)-2-(2,4-difluorophenyl)oxiran-2-yl]methyl}-1H-1,2,4-triazole, (1.062) 5-(allylsulfanyl)-1-{[rel(2R,3S)-3-(2-chlorophenyl)-2-(2,4-difluoro-phenyl)oxiran-2-yl]methyl}-1H-1,2,4-triazole, (1.063) N′-(2,5-dimethyl-4-{[3-(1,1,2,2-tetrafluoro-ethoxy)phenyl]sulfanyl}phenyl)-N-ethyl-N-methylimidoformamide, (1.064) N′-(2,5-dimethyl-4-{[3-(2,2,2-trifluoroethoxy)phenyl]sulfanyl}phenyl)-N-ethyl-N-methylimidoformamide, (1.065) N′-(2,5-dimethyl-4-{[3-(2,2,3,3-tetrafluoropropoxy)phenyl]sulfanyl}phenyl)-N-ethyl-N-methylimidoformamide, (1.066) N′-(2,5-dimethyl-4-{[3-(pentafluoroethoxy)phenyl]sulfanyl}phenyl)-N-ethyl-N-methylimidoformamide, (1.067) N′-(2,5-dimethyl-4-{3-[(1,1,2,2-tetrafluoroethyl)sulfanyl]phenoxyl}phenyl)-N-ethyl-N-methylimidoformamide, (1.068) N′-(2,5-dimethyl-4-{3-[(2,2,2-trifluoroe thyl)sulfanyl]phenoxy}phenyl)-N-ethyl-N-methylimidoformamide, (1.069) N′-(2,5-dimethyl-4-{3-[(2,2,3,3-tetrafluoro-propyl)sulfanyl]phenoxy}phenyl)-N-ethyl-N-methylimidoformamide, (1.070) N′-(2,5-dimethyl-4-{3-[pentafluoroethyl)sulfanyl]phenoxy}phenyl)-N-ethyl-N-methylimidoformamide, (1.071) N′-(2,5-dimethyl-4-phenoxyphenyl)-N-ethyl-N-methylimidoformamide, (1.072) N′-(4-{[3-(difluoro-methoxy)phenyl]sulfanyl}-2,5-dimethylphenyl)-N-ethyl-N-methylimidoformamide, (1.073) N′-(4-{3-[difluoromethyl)sulfanyl]phenoxyl}-2,5-dimethylphenyl)-N-ethyl-N-methylimidoformamide, (1.074) N′-[5-bromo-6-(2,3-dihydro-1H-inden-2-yloxy)-2-methylpyridin-3-yl]-N-ethyl-N-methylimidoformamide, (1.075) N′-{4-[(4,5-dichloro-1,3-thiazol-2-yl)oxy]-2,5-dimethylphenyl}-N-ethyl-N-methylimido-formamide, (1.076) N′-{5-bromo-6-[(1R)-1-(3,5-difluorophenyl)ethoxy]-2-methylpyridin-3-yl}-N-ethyl-N-methylimidoformamide, (1.077) N′-{5-bromo-6-[(1S)-1-(3,5-difluorophenyl)ethoxy]-2-methylpyridin-3-yl}-N-ethyl-N-methylimidoformamide, (1.078) N′-{5-bromo-6-[(cis-4-isopropylcyclohexyl)oxy]-2-methylpyridin-3-yl}-N-ethyl-N-methylimidoformamide, (1.079) N′-{5-bromo-6-[(trans-4-isopropyl-cyclohexyl)oxy]-2-methylpyridin-3-yl}-N-ethyl-N-methylimidoformamide, (1.080) N′-{5-bromo-6-[1-(3,5-difluorophenyl)ethoxy]-2-methylpyridin-3-yl}-N-ethyl-N-methylimidoformamide, (1.081) ipfentrifluconazole, (1.082) 2-[4-(4-chlorophenoxy)-2-(trifluoromethyl)phenyl]-1-(1H-1,2,4-triazol-1-yl)propan-2-ol, (1.083) 2-[6-(4-bromophenoxy)-2-(trifluoromethyl)-3-pyridyl]-1-(1,2,4-triazol-1-yl)propan-2-ol, (1.084) 2-[6-(4-chlorophenoxy)-2-(trifluoromethyl)-3-pyridyl]-1-(1,2,4-triazol-1-yl)propan-2-ol, (1.085) 3-[2-(1-chlorocyclopropyl)-3-(3-chloro-2-fluoro-phenyl)-2-hydroxy-propyl]imidazole-4-carbonitrile and (1.086) 4-[[6-[rac-(2R)-2-(2,4-difluorophenyl)-1,1-difluoro-2-hydroxy-3-(5-thioxo-4H-1,2,4-triazol-1-yl)propyl]-3-pyridyl]oxy]benzonitrile; (1.087) 2-[6-(4-chlorophenoxy)-2-(trifluoromethyl)-3-pyridyl]-1-(1,2,4-triazol-1-yl)propan-2-ol;

inhibitors of the respiratory chain at complex I or II selected from the group consisting of (2.001) benzovindiflupyr, (2.002) bixafen, (2.003) boscalid, (2.004) carboxin, (2.005) fluopyram, (2.006) flutolanil, (2.007) fluxapyroxad, (2.008) furametpyr, (2.009) Isofetamid, (2.010) isopyrazam (anti-epimeric enantiomer 1R,4S,9S), (2.011) isopyrazam (anti-epimeric enantiomer 1S,4R,9R), (2.012) isopyrazam (anti-epimeric racemate 1RS,4SR,9SR), (2.013) isopyrazam (mixture of syn-epimeric racemate 1RS,4SR,9RS and anti-epimeric racemate 1RS,4SR,9SR), (2.014) isopyrazam (syn-epimeric enantiomer 1R,4S,9R), (2.015) isopyrazam (syn-epimeric enantiomer 1S,4R,9S), (2.016) isopyrazam (syn-epimeric racemate 1RS,4SR,9RS), (2.017) penflufen, (2.018) penthiopyrad, (2.019) pydiflumetofen, (2.020) Pyraziflumid, (2.021) sedaxane, (2.022) 1,3-dimethyl-N-(1,1,3-trimethyl-2,3-dihydro-1H-inden-4-yl)-1H-pyrazole-4-carboxamide, (2.023) 1,3-dimethyl-N-[(3R)-1,1,3-trimethyl-2,3-dihydro-1H-inden-4-yl]-1H-pyrazole-4-carboxamide, (2.024) 1,3-dimethyl-N-[(3S)-1,1,3-trimethyl-2,3-dihydro-1H-inden-4-yl]-1H-pyrazole-4-carboxamide, (2.025) 1-methyl-3-(trifluoromethyl)-N-[2′-(trifluoromethyl)biphenyl-2-yl]-lH-pyrazole-4-carboxamide, (2.026) 2-fluoro-6-(trifluoromethyl)-N-(1,1,3-trimethyl-2,3-dihydro-1H-inden-4-yl)benzamide, (2.027) 3-(difluoromethyl)-1-methyl-N-(1,1,3-trimethyl-2,3-dihydro-1H-inden-4-yl)-1H-pyrazole-4-carboxamide, (2.028) inpyrfluxam, (2.029) 3-(difluoromethyl)-1-methyl-N-[(3S)-1,1,3-trimethyl-2,3-dihydro-1H-inden-4-yl]-1H-pyrazole-4-carboxamide, (2.030) fluindapyr, (2.031) 3-(difluoromethyl)-N-[(3R)-7-fluoro-1,1,3-trimethyl-2,3-dihydro-1H-inden-4-yl]-1-methyl-1H-pyrazole-4-carboxamide, (2.032) 3-(difluoromethyl)-N-[(3S)-7-fluoro-1,1,3-trimethyl-2,3-dihydro-1H-inden-4-yl]-1-methyl-1H-pyrazole-4-carboxamide, (2.033) 5,8-difluoro-N-[2-(2-fluoro-4-{[4-(trifluoromethyppyridin-2-yl]oxy}phenyl)ethyl]quinazolin-4-amine, (2.034) N-(2-cyclopentyl-5-fluorobenzyl)-N-cyclopropyl-3-(difluoromethyl)-5-fluoro-1-methyl-1H-pyrazole-4-carboxamide, (2.035) N-(2-tert-butyl-5-methylbenzyl)-N-cyclopropyl-3-(difluoromethyl)-5-fluoro-1-methyl-1H-pyrazole-4-carboxamide, (2.036) N-(2-tert-butylbenzyl)-N-cyclopropyl-3-(difluoromethyl)-5-fluoro-1-methyl-1H-pyrazole-4-carboxamide, (2.037) N-(5-chloro-2-ethylbenzyl)-N-cyclopropyl-3-(difluoromethyl)-5-fluoro-1-methyl-1H-pyrazole-4-carboxamide, (2.038) isoflucypram, (2.039) N-[(1R,4S)-9-(dichloromethylene)-1,2,3,4-tetrahydro-1,4-methanonaphthalen-5-yl]-3-(difluoromethyl)-1-methyl-1H-pyrazole-4-carboxamide, (2.040) N-[(1S,4R)-9-(dichloromethylene)-1,2,3,4-tetrahydro-1,4-methanonaphthalen-5-yl]-3-(difluoromethyl)-1-methyl-1H-pyrazole-4-carboxamide, (2.041) N-[1-(2,4-dichlorophenyl)-1-methoxypropan-2-yl]-3-(difluoromethyl)-1-methyl-1H-pyrazole-4-carboxamide, (2.042) N-[2-chloro-6-(trifluoromethyl)benzyl]-N-cyclopropyl-3-(difluoromethyl)-5-fluoro-1-methyl-1H-pyrazole-4-carboxamide, (2.043) N-[3-chloro-2-fluoro-6-(trifluoromethyl)benzyl]-N-cyclopropyl-3-(difluoromethyl)-5-fluoro-1-methyl-1H-pyrazole-4-carboxamide, (2.044) N-[5-chloro-2-(trifluoromethyl)benzyl]-N-cyclopropyl-3-(difluoromethyl)-5-fluoro-1-methyl-1H-pyrazole-4-carboxamide, (2.045) N-cyclopropyl-3-(difluoromethyl)-5-fluoro-1-methyl-N-[5-methyl-2-(trifluoromethyl)benzyl]-1H-pyrazole-4-carboxamide, (2.046) N-cyclopropyl-3-(difluoromethyl)-5-fluoro-N-(2-fluoro-6-isopropylbenzyl)-1-methyl-1H-pyrazole-4-carboxamide, (2.047) N-cyclopropyl-3-(difluoromethyl)-5-fluoro-N-(2-isopropyl-5-methylbenzyl)-1-methyl-1H-pyrazole-4-carboxamide, (2.048) N-cyclopropyl-3-(difluoromethyl)-5-fluoro-N-(2-isopropylbenzyl)-1-methyl-1H-pyrazole-4-carbothioamide, (2.049) N-cyclopropyl-3-(difluoromethyl)-5-fluoro-N-(2-isopropylbenzyl)-1-methyl-1H-pyrazole-4-carboxamide, (2.050) N-cyclopropyl-3-(difluoromethyl)-5-fluoro-N-(5-fluoro-2-isopropylbenzyl)-1-methyl-1H-pyrazole-4-carboxamide, (2.051) N-cyclopropyl-3-(difluoromethyl)-N-(2-ethyl-4,5-dimethylbenzyl)-5-fluoro-1-methyl-1H-pyrazole-4-carboxamide, (2.052) N-cyclopropyl-3-(difluoromethyl)-N-(2-ethyl-5-fluorobenzyl)-5-fluoro-1-methyl-1H-pyrazole-4-carboxamide, (2.053) N-cyclopropyl-3-(difluoromethyl)-N-(2-ethyl-5-methylbenzyl)-5-fluoro-1-methyl-1H-pyrazole-4-carboxamide, (2.054) N-cyclopropyl-N-(2-cyclopropyl-5-fluorobenzyl)-3-(difluoromethyl)-5-fluoro-1-methyl-1H-pyrazole-4-carboxamide, (2.055) N-cyclopropyl-N-(2-cyclopropyl-5-methylbenzyl)-3-(difluoromethyl)-5-fluoro-1-methyl-1H-pyrazole-4-carboxamide, (2.056) N-cyclopropyl-N-(2-cyclopropylbenzyl)-3-(difluoromethyl)-5-fluoro-1-methyl-1H-pyrazole-4-carboxamide, (2.057) pyrapropoyne;

inhibitors of the respiratory chain at complex III selected from the group consisting of (3.001) ametoctradin, (3.002) amisulbrom, (3.003) azoxystrobin, (3.004) coumethoxystrobin, (3.005) coumoxystrobin, (3.006) cyazofamid, (3.007) dimoxystrobin, (3.008) enoxastrobin, (3.009) famoxadone, (3.010) fenamidone, (3.011) flufenoxystrobin, (3.012) fluoxastrobin, (3.013) kresoxim-methyl, (3.014) metominostrobin, (3.015) orysastrobin, (3.016) picoxystrobin, (3.017) pyraclostrobin, (3.018) pyrametostrobin, (3.019) pyraoxystrobin, (3.020) trifloxystrobin, (3.021) (2E)-2-{2-[({[(1E)-1-(3-{[(E)-1-fluoro-2-phenylvinyl]oxy}phenyl)ethylidene]amino}oxy)methyl]phenyl}-2-(methoxyimino)-N-methylacetamide, (3.022) (2E,3Z)-5-{[1-(4-chlorophenyl)-1H-pyrazol-3-yl]oxy}-2-(methoxyimino)-N,3-dimethylpent-3-enamide, (3.023) (2R)-2-{2-[(2,5-dimethylphenoxy)methyl]phenyl}-2-methoxy-N-methylacetamide, (3.024) (2S)-2-{2-[(2,5-dimethylphenoxy)methyl]phenyl}-2-methoxy-N-methylacetamide, (3.025)fenpicoxamid, (3.026) mandestrobin, (3.027) N-(3-ethyl-3,5,5-trimethylcyclohexyl)-3-formamido-2-hydroxybenzamide, (3.028) (2E,3Z)-5-{[1-(4-chloro-2-fluorophenyl)-1H-pyrazol-3-yl]oxy}-2-(methoxyimino)-N,3-dimethylpent-3-enamide, (3.029) methyl {5-[3-(2,4-dimethylphenyl)-1H-pyrazol-1-yl]-2-methylbenzyl}carbamate, (3.030) metyltetraprole, (3.031) florylpicoxamid;

inhibitors of the mitosis and cell division selected from the group consisting of (4.001) carbendazim, (4.002) diethofencarb, (4.003) ethaboxam, (4.004) fluopicolide, (4.005) pencycuron, (4.006) thiabendazole, (4.007) thiophanate-methyl, (4.008) zoxamide, (4.009) 3-chloro-4-(2,6-difluorophenyl)-6-methyl-5-phenylpyridazine, (4.010) 3-chloro-5-(4-chlorophenyl)-4-(2,6-difluorophenyl)-6-methylpyridazine, (4.011) 3-chloro-5-(6-chloropyridin-3-yl)-6-methyl-4-(2,4,6-trifluorophenyl)pyridazine, (4.012) 4-(2-bromo-4-fluorophenyl)-N-(2,6-difluorophenyl)-1,3-dimethyl-1H-pyrazol-5-amine, (4.013) 4-(2-bromo-4-fluorophenyl)-N-(2-bromo-6-fluorophenyl)-1,3-dimethyl-1H-pyrazol-5-amine, (4.014) 4-(2-bromo-4-fluorophenyl)-N-(2-bromophenyl)-1,3-dimethyl-1H-pyrazol-5-amine, (4.015) 4-(2-bromo-4-fluorophenyl)-N-(2-chloro-6-fluorophenyl)-1,3-dimethyl-1H-pyrazol-5-amine, (4.016) 4-(2-bromo-4-fluorophenyl)-N-(2-chlorophenyl)-1,3-dimethyl-1H-pyrazol-5-amine, (4.017) 4-(2-bromo-4-fluorophenyl)-N-(2-fluorophenyl)-1,3-dimethyl-1H-pyrazol-5-amine, (4.018) 4-(2-chloro-4-fluorophenyl)-N-(2,6-difluorophenyl)-1,3-dimethyl-1H-pyrazol-5-amine, (4.019) 4-(2-chloro-4-fluorophenyl)-N-(2-chloro-6-fluorophenyl)-1,3-dimethyl-1H-pyrazol-5-amine, (4.020) 4-(2-chloro-4-fluorophenyl)-N-(2-chlorophenyl)-1,3-dimethyl-1H-pyrazol-5-amine, (4.021) 4-(2-chloro-4-fluorophenyl)-N-(2-fluorophenyl)-1,3-dimethyl-1H-pyrazol-5-amine, (4.022) 4-(4-chlorophenyl)-5-(2,6-difluorophenyl)-3,6-dimethylpyridazine, (4.023) N-(2-bromo-6-fluorophenyl)-4-(2-chloro-4-fluorophenyl)-1,3-dimethyl-1H-pyrazol-5-amine, (4.024) N-(2-bromophenyl)-4-(2-chloro-4-fluorophenyl)-1,3-dimethyl-1H-pyrazol-5-amine, (4.025) N-(4-chloro-2,6-difluorophenyl)-4-(2-chloro-4-fluorophenyl)-1,3-dimethyl-1H-pyrazol-5-amine;

compounds capable of having a multisite action selected from the group consisting of (5.001) bordeaux mixture, (5.002) captafol, (5.003) captan, (5.004) chlorothalonil, (5.005) copper hydroxide, (5.006) copper naphthenate, (5.007) copper oxide, (5.008) copper oxychloride, (5.009) copper(2+) sulfate, (5.010) dithianon, (5.011) dodine, (5.012) folpet, (5.013) mancozeb, (5.014) maneb, (5.015) metiram, (5.016) metiram zinc, (5.017) oxine-copper, (5.018) propineb, (5.019) sulfur and sulfur preparations including calcium polysulfide, (5.020) thiram, (5.021) zineb, (5.022) ziram, (5.023) 6-ethyl-5,7-dioxo-6,7-dihydro-5H-pyrrolo [3′, 4′: 5,6][1,4]dithiino [2,3-c][1,2]thiazole-3-carbonitrile;

compounds capable of inducing a host defense selected from the group consisting of (6.001) acibenzolar-S-methyl, (6.002) isotianil, (6.003) probenazole, (6.004) tiadinil;

inhibitors of the amino acid and/or protein biosynthesis selected from the group consisting of (7.001) cyprodinil, (7.002) kasugamycin, (7.003) kasugamycin hydrochloride hydrate, (7.004) oxytetracycline, (7.005) pyrimethanil, (7.006) 3-(5-fluoro-3,3,4,4-tetramethyl-3,4-dihydroisoquinolin-1-yl)quinolone;

inhibitors of the ATP production selected from the group consisting of (8.001) silthiofam;

inhibitors of the cell wall synthesis selected from the group consisting of (9.001) benthiavalicarb, (9.002) dimethomorph, (9.003) flumorph, (9.004) iprovalicarb, (9.005) mandipropamid, (9.006) pyrimorph, (9.007) valifenalate, (9.008) (2E)-3-(4-tert-butylphenyl)-3-(2-chloropyridin-4-yl)-1-(morpholin-4-yl)prop-2-en-1-one, (9.009) (2Z)-3-(4-tert-butylphenyl)-3-(2-chloropyridin-4-yl)-1-(morpholin-4-yl)prop-2-en-1-one ;

inhibitors of the lipid and membrane synthesis selected from the group consisting of (10.001) propamocarb, (10.002) propamocarb hydrochloride, (10.003) tolclofos-methyl;

inhibitors of the melanine biosynthesis selected from the group consisting of (11.001) tricyclazole, (11.002) tolprocarb;

inhibitors of the nucleic acid synthesis selected from the group consisting of (12.001) benalaxyl, (12.002) benalaxyl-M (kiralaxyl), (12.003) metalaxyl, (12.004) metalaxyl-M (mefenoxam);

inhibitors of the signal transduction selected from the group consisting of (13.001) fludioxonil, (13.002) iprodione, (13.003) procymidone, (13.004) proquinazid, (13.005) quinoxyfen, (13.006) vinclozolin;

compounds capable of acting as uncoupler selected from the group consisting of (14.001) fluazinam and (14.002) meptyldinocap;

other fungicides selected from the group consisting of (15.001) abscisic acid, (15.002) benthiazole, (15.003) bethoxazin, (15.004) capsimycin, (15.005) carvone, (15.006) chinomethionat, (15.007) cufraneb, (15.008) cyflufenamid, (15.009) cymoxanil, (15.010) cyprosulfamide, (15.011) flutianil, (15.012) fosetyl-aluminium, (15.013) fosetyl-calcium, (15.014) fosetyl-sodium, (15.015) methyl isothiocyanate, (15.016) metrafenone, (15.017) mildiomycin, (15.018) natamycin, (15.019) nickel dimethyldithiocarbamate, (15.020) nitrothal-isopropyl, (15.021) oxamocarb, (15.022) Oxathiapiprolin, (15.023) oxyfenthiin, (15.024) pentachlorophenol and salts, (15.025) phosphorous acid and its salts, (15.026) propamocarb-fosetylate, (15.027) pyriofenone (chlazafenone), (15.028) tebufloquin, (15.029) tecloftalam, (15.030) tolnifanide, (15.031) 1-(4-{4-[(5R)-5-(2,6-difluorophenyl)-4,5-dihydro-1,2-oxazol-3-yl]-1,3-thiazol-2-yl}piperidin-1-yl)-2-[5-methyl-3-(trifluoromethyl)-1H-pyrazol-1-yl]ethanone, (15.032) 1-(4-{4-[(5S)-5-(2,6-difluorophenyl)-4,5-dihydro-1,2-oxazol-3-yl]-1,3-thiazol-2-yl}piperidin-1yl)-2-[5-methyl-3-(trifluoromethyl)-1H-pyrazol-1-yl]ethanone, (15.033) 2-(6-benzylpyridin-2-yl)quinazoline, (15.034) dipymetitrone, (15.035) 2-[3,5-bis(difluoromethyl)-1H-pyrazol-1-yl]-1-[4-(4-{5-[2-(prop-2-yn-1-yloxy)phenyl]-4,5-dihydro-1,2-oxazol-3-yl}-1,3-thiazol-2-yl)piperidin-1-yl]ethanone, (15.036) 2-[3,5-bis(difluoromethyl)-1H-pyrazol-1-yl]-1-[4-(4-{5-[2-chloro-6-(prop-2-yn-1-yloxy)phenyl]-4,5-dihydro-1,2-oxazol-3-yl}-1,3-thiazol-2-yl)piperidin-1-yl]ethanone, (15.037) 2-[3,5-bis(difluoromethyl)-1H-pyrazol-1-yl]-1-[4-(4-{5-[2-fluoro-6-(prop-2-yn-1-yloxy)phenyl]-4,5-dihydro-1,2-oxazol-3-yl}-1,3-thiazol-2-yl)piperidin-1-yl]ethanone, (15.038) 2-[6-(3-fluoro-4-methoxyphenyl)-5-methylpyridin-2-yl]quinazoline, (15.039) 2-{(5R)-3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}-3-chlorophenyl methanesulfonate, (15.040) 2-{(5S)-3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}-3-chlorophenyl methanesulfonate, (15.041) Ipflufenoquin, (15.042) 2-{2-fluoro-6-[(8-fluoro-2-methylquinolin-3-yl)oxy]phenyl}propan-2-ol, (15.043) fluoxapiprolin, (15.044) 2-{3-[2-(1-{[3,5-bis(difluoromethyl)-1H-pyrazol-1-yl]acetyl} piperidin-4-yl)-1,3-thiazol-4-yl]-4,5-dihydro-1,2-oxazol-5-yl}phenyl methanesulfonate, (15.045) 2-phenylphenol and salts, (15.046) 3-(4,4,5-trifluoro-3,3-dimethyl-3,4-dihydroisoquinolin-1-yl)quinoline, (15.047) quinofumelin, (15.048) 4-amino-5-fluoropyrimidin-2-ol (tautomeric form: 4-amino-5-fluoropyrimidin-2(1H)-one), (15.049) 4-oxo-4-[(2-phenylethyl)amino]butanoic acid, (15.050) 5-amino-1,3,4-thiadiazole-2-thiol, (15.051) 5-chloro-N′-phenyl-N′-(prop-2-yn-1-yl)thiophene-2-sulfonohydrazide, (15.052) 5-fluoro-2-[(4-fluorobenzyl)oxy]pyrimidin-4-amine, (15.053) 5-fluoro-2-[(4-methylbenzyl)oxy]pyrimidin-4-amine, (15.054) 9-fluoro-2,2-dimethyl-5-(quinolin-3-yl)-2,3-dihydro-1,4-benzoxazepine, (15.055) but-3-yn-1-yl {6-[({[(Z)-(1-methyl-1H-tetrazol-5-yl)(phenyl)methylene]amino}oxy)methyl]pyridin-2-yl}carbamate, (15.056) ethyl (2Z)-3-amino-2-cyano-3-phenylacrylate, (15.057) phenazine-1-carboxylic acid, (15.058) propyl 3,4,5-trihydroxybenzoate, (15.059) quinolin-8-ol, (15.060) quinolin-8-ol sulfate (2:1), (15.061) tert-butyl {6-[({[(1-methyl-1H-tetrazol-5-yl)(phenyl)methylene]amino}oxy)methyl]pyridin-2-yl}carbamate, (15.062) 5-fluoro-4-imino-3-methyl-1-[(4-methylphenyl)sulfonyl]-3,4-dihydropyrimidin-2(1H)-one, (15.063) aminopyrifen, (15.064) (N′-[2-chloro-4-(2-fluorophenoxy)-5-methylphenyl]-N-ethyl-N-methylimidoformamide), (15.065) (N′-(2-chloro-5-methyl-4-phenoxyphenyl)-N-ethyl-N-methylimido-formamide), (15.066) (2-{2-[(7,8-difluoro-2-methylquinolin-3-yl)oxy]-6-fluorophenyl}propan-2-ol), (15.067) (5-bromo-1-(5,6-dimethylpyridin-3-yl)-3,3-dimethyl-3,4-dihydroisoquinoline), (15.068) (3-(4,4-difluoro-5,5-dimethyl-4,5-dihydrothieno[2,3-c]pyridin-7-yl)quinoline), (15.069) (1-(4,5-dimethyl-1H-benzimidazol-1-yl)-4,4-difluoro-3,3-dimethyl-3,4-dihydroisoquinoline), (15.070) 8-fluoro-3-(5-fluoro-3,3-dimethyl-3,4-dihydroisoquinolin-1-yl)quinolone, (15.071) 8-fluoro-3-(5-fluoro-3,3,4,4-tetramethyl-3,4-dihydroisoquinolin-1-yl)quinolone, (15.072) 3-(4,4-difluoro-3,3-dimethyl-3,4-dihydroisoquinolin-1-yl)-8-fluoroquinoline, (15.073) (N-methyl-N-phenyl-4-[5-(trifluoromethyl)-1,2,4-oxadiazol-3-yl]benzamide), (15.074) (methyl{4-[5-(trifluoromethyl)-1,2,4-oxadiazol-3-yl]phenyl}carbamate), (15.075) (N-{4-[5-(trifluoromethyl)-1,2,4-oxadiazol-3-yl]benzyl}cyclopropanecarboxamide), (15.076) N-methyl-4-(5-(trifluoromethyl)-1,2,4-oxadiazol-3-yl]benzamide, (15.077) N-[(E)-methoxyiminomethyl]-4-[5-(trifluoromethyl)-1,2,4-oxadiazol-3-yl]benzamide, (15.078) N-[(Z)-methoxyiminomethyl]-4-[5-(trifluoromethyl)-1,2,4-oxadiazol-3-yl]benzamide, (15.079) N-[4-[5-(trifluoromethyl)-1,2,4-oxadiazol-3-yl]phenyl]cyclopropanecarboxamide, (15.080) N-(2-fluorophenyl)-4-[5-(trifluoromethyl)-1,2,4-oxadiazol-3-yl]benzamide, (15.081) 2,2-difluoro-N-methyl-2-[4-[5-(trifluoromethyl)-1,2,4-oxadiazol-3-yl]phenyl]-acetamide, (15.082) N-allyl-N-[[4-[5-(trifluoromethyl)-1,2,4-oxadiazol-3-yl)phenyl]methyl]acetamide, (15.083) N-[(E)-N-methoxy-C-methyl-carbonimidoyl]-4-(5-(trifluoromethyl)-1,2,4-oxadiazol-3-yl]-benzamide, (15.084) N-[(Z)-N-methoxy-C-methyl-carbonimidoyl]-4-[5-(trifluoromethyl)-1,2,4-oxadiazol-3-yl]benzamide, (15.085) N-allyl-N-[[4-[5-(trifluoromethyl)-1,2,4-oxadiazol-3-yl]phenyl]methyl]-propanamide, (15.086) 4,4-dimethyl-1-[[4-[5-(trifluoromethyl)-1,2,4-oxadiazol-3-yl]phenyl]methyl]-pyrrolidin-2-one, (15.087) N-methyl-4-[5-(trifluoromethyl)-1,2,4-oxadiazol-3-yl]benzenecarbothioamide, (15.088) 5-methyl-1-[[4-[5-(trifluoromethyl)-1,2,4-oxadiazol-3-yl]phenyl]methyl]pyrrolidin-2-one, (15.089) N-((2,3-difluoro-4-[5-(trifluoromethyl)-1,2,4-oxadiazol-3-yl]phenyl]methyl]-3,3,3-trifluoro-propanamide, (15.090) 1-methoxy-1-methyl-3-[[4-[5-(trifluoromethyl}-1,2,4-oxadiazol-3-yl]phenyl]-methyl]urea, (15.091) 1,1-diethyl-3-[[4-[5-(trifluoromethyl}-1,2,4-oxadiazol-3-yl]phenyl]methyl]urea, (15.092) N-[[4-[5-(trifluoromethyl)-1,2,4-oxadiazol-3-yl]phenyl]methyl]propanamide, (15.093) N-methoxy-N-[[4-[5-(trifluoromethyl)-1,2,4-oxadiazol-3-yl]phenyl]methyl]cyclopropanecarboxamide, (15.094) 1-methoxy-3-methyl-1-[[4-[5-(trifluoromethyl)-1,2,4-oxadiazol-3-yl]phenyl]methyl]urea, (15.095) N-methoxy-N-[[4-[5-(trifluoromethyl)-1,2,4-oxadiazol-3-yl]phenyl]methyl)cyclopropane-carboxamide, (15.096) N,2-dimethoxy-N-[[4-[5-(trifluoromethyl-1,2,4-oxadiazol-3-yl]phenyl]methyl]-propanamide, (15.097) N-ethyl-2-methyl-N-[[4-[5-(trifluoromethyl)-1,2,4-oxadiazol-3-yl)phenyl]methyl]-propanamide, (15.098) 1-methoxy-3-methyl-1-[[4-[5-(trifluoromethyl)-1,2,4-oxadiazol-3-yl]phenyl]-methyl]urea, (15.099) 1,3-dimethoxy-1-[[4-[5-(trifluoromethyl)-1,2,4-oxadiazol-3-yl]phenyl]methyl]urea, (15.100) 3-ethyl-1-methoxy-1-[[4-[5-(trifluoromethyl)-1,2,4-oxadiazol-3-yl]phenyl]methyl]urea, (15.101) 1-[[4-[5-(trifluoromethyl)-1,2,4-oxadiazol-3-yl]phenyl]methyl]piperidin-2-one, (15.102) 4,4-dimethyl-2-[[4-[5-(trifluoromethyl)-1,2,4-oxadiazol-3-yl]phenyl]methyl]isooxazolidin-3-one, (15.103) 5,5-dimethyl-2-[[4-[5-(trifluoromethyl)-1,2,4-oxadiazol-3-yl]phenyl]methyl]isoxazolidin-3-one, (15.104) 3,3-dimethyl-1-[[4-[5-(trifluoromethyl)-1,2,4-oxadiazol-3-yl]phenyl]methyl]piperidin-2-one, (15.105) 14[3-fluoro-4-(5-(trifluoromethyl)-1,2,4-oxadiazol-3-yl]phenyl]methyl]azepan-2-one, (15.106) 4,4-dimethyl-2-[[4-(5-(trifluoromethyl)-1,2,4-oxadiazol-3-yl]phenyl]methyl]isoxazolidin-3-one (15.107) 5,5-dimethyl-2-[[4-[5-(trifluoromethyl)-1,2,4-oxadiazol-3-yl]phenyl]methyl]isoxazolidin-3-one, (15.108) ethyl (1-{4-[5-(trifluoromethyl)-1,2,4-oxadiazol-3-yl]benzyl}-1H-pyrazol-4-yl)acetate, (15.109) N,N-dimethyl-1-{4-[5-(trifluoromethyl)-1,2,4-oxadiazol-3-yl]benzyl}-1H-1,2,4-triazol-3-amine, (15.110) N-{2,3-difluoro-4-[5-(trifluoromethyl)-1,2,4-oxadiazol-3-yl]benzyl}butanamide (15.111) N-(1-methylcyclopropyl)-4-[5-(trifluoromethyl)-1,2,4-oxadiazol-3-yl]benzamide, (15.112) N-(2,4-difluorophenyl)-4-[5-(trifluoromethyl)-1,2,4-oxadiazol-3-yl]benzamide, (15.113) 1-(5,6-dimethylpyridin-3-yl)-4,4-difluoro-3,3-dimethyl-3,4-dihydroisoquinoline, (15.114) 1-(6-(difluoromethyl)-5-methyl-pyridin-3-yl)-4,4-difluoro-3,3-dimethyl-3,4-dihydroisoquinoline, (15.115) 1-(5-(fluoromethyl)-6-methyl-pyridin-3-yl)-4,4-difluoro-3,3-dimethyl-3,4-dihydroisoquinoline and (15.116) 1-(6-(difluoromethyl)-5-methoxy-pyridin-3-yl)-4,4-difluoro-3,3-dimethyl-3,4-dihydroisoquinoline

Compound (B) is more preferably selected from:

(1.001) cyproconazole, (1.002) difenoconazole, (1.003) epoxiconazole, (1.004) fenhexamid, (1.005) fenpropidin, (1.006) fenpropimorph, (1.007) fenpyrazamine, (1.008) fluquinconazole, (1.009) flutriafol (1.010) imazalil, (1.011) imazalil sulfate, (1.012) ipconazole, (1.013) metconazole, (1.014) myclobutanil, (1.015) paclobutrazol, (1.016) prochloraz, (1.017) propiconazole, (1.018) prothioconazole, (1.019) pyrisoxazole, (1.020) spiroxamine, (1.021) tebuconazole, (1.022) tetraconazole, (1.023) triadimenol, (1.025) triticonazole, and (1.082) 2-[6-(4-bromophenoxy)-2-(trifluoromethyl)-3-pyridyl]-1-(1,2,4-triazol-1-yl)propan-2-ol, (1.087) 2-[6-(4-chlorophenoxy)-2-(trifluoromethyl)-3-pyridyl]-1-(1,2,4-triazol-1-yl)propan-2-ol

(2.001) benzovindiflupyr, (2.002) bixafen, (2.003) boscalid, (2.005) fluopyram, (2.007) fluxapyroxad, (2.009) isofetamid, (2.010) isopyrazam (anti-epimeric enantiomer 1R,4S,9S), (2.011) isopyrazam (anti-epimeric enantiomer 1S,4R,9R), (2.012) isopyrazam (anti-epimeric racemate 1RS,4SR,9SR), (2.013) isopyrazam (mixture of syn-epimeric racemate 1RS,4SR,9RS and anti-epimeric racemate 1RS,4SR,9SR), (2.014) isopyrazam (syn-epimeric enantiomer 1R,4S,9R), (2.015) isopyrazam (syn-epimeric enantiomer 1S,4R,9S), (2.016) isopyrazam (syn-epimeric racemate 1RS,4SR,9RS), (2.017) penflufen, (2.018) penthiopyrad, (2.019) pydiflumetofen, (2.020) Pyraziflumid, (2.021) sedaxane, (2.030) fluindapyr, (2.038) isoflucypram and (2.057) pyrapropoyne,

(3.003) azoxystrobin, (3.006) cyazofamid, (3.010) fenamidone, (3.012) fluoxastrobin, (3.014) metominostrobin, (3.016) picoxystrobin, (3.017) pyraclostrobin, (3.020) trifloxystrobin, (3.025) fenpicoxamid, and (3.031) florylpicoxamid,

(4.004) fluopicolide, (4.005) pencycuron, (4.008) zoxamide,

(5.001) bordeaux mixture, (5.003) captan, (5.004) chlorothalonil, (5.005) copper hydroxide, (5.006) copper naphthenate, (5.007) copper oxide, (5.008) copper oxychloride, (5.009) copper(2+) sulfate, (5.012) folpet, (5.013) mancozeb, (5.015) metiram, (5.018) propineb, (5.019) sulfur and sulfur preparations including calcium polysulfide,

(6.001) acibenzolar-S-methyl, (6.002) isotianil, (6.003) probenazole, and (6.004) tiadinil, (7.001) cyprodinil, (7.002) kasugamycin, (7.003) kasugamycin hydrochloride hydrate, (7.005) pyrimethanil,

(9.001) benthiavalicarb, (9.002) dimethomorph, (9.004) iprovalicarb, (9.005) mandipropamid, (9.006) pyrimorph, (9.007) valifenalate,

(10.001) propamocarb, (10.002) propamocarb hydrochloride

(12.003) metalaxyl, (12.004) metalaxyl-M (mefenoxam),

(13.001) fludioxonil, (13.002) iprodione,

(15.009) cymoxanil (15.011) flutianil, (15.012) fosetyl-aluminium, (15.014) fosetyl-sodium, (15.022) oxathiapiprolin, (15.041) ipflufenoquin, (15.047) quinofumelin, (15.063) aminopyrifen.

Compound (B) is even more preferably selected from:

(1.002) difenoconazole, (1.004) fenhexamid, (1.005) fenpropidin, (1.006) fenpropimorph, (1.012) ipconazole, (1.013) metconazole, (1.017) propiconazole, (1.018) prothioconazole, (1.020) spiroxamine, (1.021) tebuconazole, (1.082) 2-[6-(4-bromophenoxy)-2-(trifluoromethyl)-3-pyridyl]-1-(1,2,4-triazol-1-yl)propan-2-ol, (1.087) 2-[6-(4-chlorophenoxy)-2-(trifluoromethyl)-3-pyridyl]-1-(1,2,4-triazol-1-yl)propan-2-ol

(2.001) benzovindiflupyr, (2.002) bixafen, (2.003) boscalid, (2.005) fluopyram, (2.007) fluxapyroxad, (2.010) isopyrazam (anti-epimeric enantiomer 1R,4S,9S), (2.011) isopyrazam (anti-epimeric enantiomer 1S,4R,9R), (2.012) isopyrazam (anti-epimeric racemate 1RS,4SR,9SR), (2.013) isopyrazam (mixture of syn-epimeric racemate 1RS,4SR,9RS and anti-epimeric racemate 1RS,4SR,9SR), (2.014) isopyrazam (syn-epimeric enantiomer 1R,4S,9R), (2.015) isopyrazam (syn-epimeric enantiomer 1S,4R,9S), (2.016) isopyrazam (syn-epimeric racemate 1RS,4SR,9RS), (2.017) penflufen, (2.018) penthiopyrad, (2.019) pydiflumetofen, (2.038) isoflucypram,

(3.003) azoxystrobin, (3.012) fluoxastrobin, (3.016) picoxystrobin, (3.017) pyraclostrobin, (3.020) trifloxystrobin, (3.025) fenpicoxamid, (3.031) florylpicoxamid,

(4.004) fluopicolide, (4.008) zoxamide,

(5.005) copper hydroxide, (5.006) copper naphthenate, (5.007) copper oxide, (5.008) copper oxychloride, (5.009) copper(2+) sulfate, (5.012) folpet, (5.013) mancozeb, (5.018) propineb, (5.019) sulfur and sulfur preparations including calcium polysulfide

(6.002) isotianil,

(7.005) pyrimethanil,

(9.001) benthiavalicarb, (9.002) dimethomorph, (9.004) iprovalicarb, (9.005) mandipropamid,

(10.001) propamocarb, (10.002) propamocarb hydrochloride

(13.001) fludioxonil, (13.002) iprodione,

(15.012) fosetyl-aluminium, (15.022) oxathiapiprolin, (15.041) ipflufenoquin, (15.047) quinofumelin, (15.063) aminopyrifen.

Compound (B) is most preferably selected from:

(1.012) ipconazole, (1.018) prothioconazole, (1.020) spiroxamine, (1.021) tebuconazole, (1.082) 2-[6-(4-bromophenoxy)-2-(trifluoromethyl)-3-pyridyl]-1-(1,2,4-triazol-1-yl)propan-2-ol, (1.087) 2-[6-(4-chlorophenoxy)-2-(trifluoromethyl)-3-pyridyl]-1-(1,2,4-triazol-1-yl)propan-2-ol

(2.002) bixafen, (2.003) boscalid, (2.005) fluopyram, (2.017) penflufen, (2.038) isoflucypram,

(3.012) fluoxastrobin, (3.020) trifloxystrobin, (3.025) fenpicoxamid,

(4.004) fluopicolide,

(5.005) copper hydroxide, (5.006) copper naphthenate, (5.007) copper oxide, (5.008) copper oxychloride, (5.009) copper(2+) sulfate, (5.019) sulfur and sulfur preparations including calcium polysulfide, (5.013) mancozeb, (5.018) propineb,

(6.002) isotianil,

(9.002) dimethomorph, (9.004) iprovalicarb,

(10.001) propamocarb

(13.001) fludioxonil,

(15.012) fosetyl-aluminium, (15.022) oxathiapiprolin .

The compound combinations according to the invention may comprise 1, 2 or even more compounds (b). Preferably, the compound combinations according to the invention comprise 1 or 2 compound(s) (b).

In case two or more compound(s) (b) are present, those compounds may be selected from different groups (1) to (15). For example, if one compound (b) is selected from group (1), the further compound(s) (b) may be selected from groups (2) to (15).

Preferred compound combinations are selected from group (G1) consisting of the following mixtures:

(I.01)+(1.001), (I.01)+(1.002), (I.01)+(1.003), (I.01)+(1.004), (I.01)+(1.005), (I.01)+(1.006), (I.01)+(1.007), (1.01)+(1.008), (1.01)+(1.009), (1.01)+(1.010), (1.01)+(1.011), (1.01)+(1.012), (1.01)+(1.013), (1.01)+(1.014), (1.01)+(1.015), (1.01)+(1.016), (1.01)+(1.017), (1.01)+(1.018), (1.01)+(1.019), (1.01)+(1.020), (1.01)+(1.021), (1.01)+(1.022), (1.01)+(1.023), (1.01)+(1.024), (1.01)+(1.025), (1.01)+(1.026), (1.01)+(1.027), (1.01)+(1.028), (1.01)+(1.029), (1.01)+(1.030), (1.01)+(1.031), (1.01)+(1.032), (I.01)+(1.033), (I.01)+(1.034), (I.01)+(1.035), (I.01)+(1.036), (I.01)+(1.037), (I.01)+(1.038), (I.01)+(1.039), (I.01)+(1.040), (I.01)+(1.041), (I.01)+(1.042), (I.01)+(1.043), (I.01)+(1.044), (I.01)+(1.045), (I.01)+(1.046), (I.01)+(1.047), (I.01)+(1.048), (I.01)+(1.049), (I.01)+(1.050), (I.01)+(1.051), (I.01)+(1.052), (I.01)+(1.053), (I.01)+(1.054), (I.01)+(1.055), (I.01)+(1.056), (I.01)+(1.057), (I.01)+(1.058), (I.01)+(1.059), (I.01)+(1.060), (I.01)+(1.061), (I.01)+(1.062), (I.01)+(1.063), (I.01)+(1.064), (1.01)+(1.065), (1.01)+(1.066), (1.01)+(1.067), (1.01)+(1.068), (1.01)+(1.069), (1.01)+(1.070), (1.01)+(1.071), (1.01)+(1.072), (1.01)+(1.073), (1.01)+(1.074), (1.01)+(1.075), (1.01)+(1.076), (1.01)+(1.077), (1.01)+(1.078), (1.01)+(1.079), (1.01)+(1.080), (1.01)+(1.081), (1.01)+(1.082), (1.01)+(1.083), (1.01)+(1.084), (1.01)+(1.085), (1.01)+(1.086), (1.01)+(1.087), (1.01)+(2.001), (1.01)+(2.002), (1.01)+(2.003), (1.01)+(2.004), (1.01)+(2.005), (1.01)+(2.006), (1.01)+(2.007), (1.01)+(2.008), (1.01)+(2.009), (1.01)+(2.010), (1.01)+(2.011), (1.01)+(2.012), (1.01)+(2.013), (1.01)+(2.014), (1.01)+(2.015), (1.01)+(2.016), (1.01)+(2.017), (1.01)+(2.018), (1.01)+(2.019), (1.01)+(2.020), (1.01)+(2.021), (1.01)+(2.022), (1.01)+(2.023), (1.01)+(2.024), (1.01)+(2.025), (1.01)+(2.026), (1.01)+(2.027), (I.01)+(2.028), (I.01)+(2.029), (I.01)+(2.030), (I.01)+(2.031), (I.01)+(2.032), (I.01)+(2.033), (I.01)+(2.034), (I.01)+(2.035), (I.01)+(2.036), (I.01)+(2.037), (I.01)+(2.038), (I.01)+(2.039), (I.01)+(2.040), (I.01)+(2.041), (I.01)+(2.042), (I.01)+(2.043), (I.01)+(2.044), (I.01)+(2.045), (I.01)+(2.046), (I.01)+(2.047), (I.01)+(2.048), (I.01)+(2.049), (I.01)+(2.050), (I.01)+(2.051), (I.01)+(2.052), (I.01)+(2.053), (I.01)+(2.054), (I.01)+(2.055), (I.01)+(2.056), (I.01)+(2.057), (I.01)+(3.001), (I.01)+(3.002), (I.01)+(3.003), (I.01)+(3.004), (I.01)+(3.005), (I.01)+(3.006), (I.01)+(3.007), (I.01)+(3.008), (I.01)+(3.009), (I.01)+(3.010), (I.01)+(3.011), (I.01)+(3.012), (I.01)+(3.013), (I.01)+(3.014), (I.01)+(3.015), (I.01)+(3.016), (I.01)+(3.017), (I.01)+(3.018), (I.01)+(3.019), (I.01)+(3.020), (I.01)+(3.021), (I.01)+(3.022), (I.01)+(3.023), (I.01)+(3.024), (I.01)+(3.025), (I.01)+(3.026), (I.01)+(3.027), (I.01)+(3.028), (I.01)+(3.029), (I.01)+(3.030), (I.01)+(3.031), (I.01)+(4.001), (I.01)+(4.002), (I.01)+(4.003), (I.01)+(4.004), (I.01)+(4.005), (I.01)+(4.006), (I.01)+(4.007), (I.01)+(4.008), (I.01)+(4.009), (I.01)+(4.010), (I.01)+(4.011), (I.01)+(4.012), (I.01)+(4.013), (I.01)+(4.014), (I.01)+(4.015), (I.01)+(4.016), (I.01)+(4.017), (I.01)+(4.018), (I.01)+(4.019), (I.01)+(4.020), (I.01)+(4.021), (I.01)+(4.022), (I.01)+(4.023), (I.01)+(4.024), (I.01)+(4.025), (I.01)+(5.001), (I.01)+(5.002), (I.01)+(5.003), (I.01)+(5.004), (I.01)+(5.005), (I.01)+(5.006), (I.01)+(5.007), (I.01)+(5.008), (I.01)+(5.009), (I.01)+(5.010), (I.01)+(5.011), (I.01)+(5.012), (I.01)+(5.013), (I.01)+(5.014), (I.01)+(5.015), (I.01)+(5.016), (I.01)+(5.017), (I.01)+(5.018), (I.01)+(5.019), (I.01)+(5.020), (I.01)+(5.021), (I.01)+(5.022), (I.01)+(5.023), (I.01)+(6.001), (I.01)+(6.002), (I.01)+(6.003), (I.01)+(6.004), (I.01)+(7.001), (I.01)+(7.002), (I.01)+(7.003), (I.01)+(7.004), (I.01)+(7.005), (I.01)+(7.006), (I.01)+(8.001), (I.01)+(9.001), (I.01)+(9.002), (I.01)+(9.003), (I.01)+(9.004), (I.01)+(9.005), (I.01)+(9.006), (I.01)+(9.007), (1.01)+(9.008), (1.01)+(9.009), (1.01)+(10.001), (1.01)+(10.002), (1.01)+(10.003), (1.01)+(11.001), (1.01)+(11.002), (1.01)+(12.001), (1.01)+(12.002), (1.01)+(12.003), (1.01)+(12.004), (1.01)+(13.001), (I.01)+(13.002), (I.01)+(13.003), (I.01)+(13.004), (I.01)+(13.005), (I.01)+(13.006), (I.01)+(14.001), (I.01)+(14.002), (I.01)+(15.001), (I.01)+(15.002), (I.01)+(15.003), (I.01)+(15.004), (I.01)+(15.005), (I.01)+(15.006), (I.01)+(15.007), (I.01)+(15.008), (I.01)+(15.009), (I.01)+(15.010), (I.01)+(15.011), (I.01)+(15.012), (I.01)+(15.013), (I.01)+(15.014), (I.01)+(15.015), (I.01)+(15.016), (I.01)+(15.017), (I.01)+(15.018), (I.01)+(15.019), (I.01)+(15.020), (I.01)+(15.021), (I.01)+(15.022), (I.01)+(15.023), (I.01)+(15.024), (I.01)+(15.025), (I.01)+(15.026), (I.01)+(15.027), (I.01)+(15.028), (I.01)+(15.029), (I.01)+(15.030), (I.01)+(15.031), (I.01)+(15.032), (I.01)+(15.033), (I.01)+(15.034), (I.01)+(15.035), (I.01)+(15.036), (I.01)+(15.037), (I.01)+(15.038), (I.01)+(15.039), (I.01)+(15.040), (I.01)+(15.041), (I.01)+(15.042), (I.01)+(15.043), (I.01)+(15.044), (I.01)+(15.045), (I.01)+(15.046), (I.01)+(15.047), (I.01)+(15.048), (I.01)+(15.049), (I.01)+(15.050), (I.01)+(15.051), (I.01)+(15.052), (I.01)+(15.053), (I.01)+(15.054), (I.01)+(15.055), (I.01)+(15.056), (I.01)+(15.057), (I.01)+(15.058), (I.01)+(15.059), (I.01)+(15.060), (I.01)+(15.061), (I.01)+(15.062), (I.01)+(15.063) , (I.01)+(15.064), (I.01)+(15.065), (I.01)+(15.066), (I.01)+(15.067), (I.01)+(15.068), (I.01)+(15.069), (I.01)+(15.070), (I.01)+(15.071), (I.01)+(15.072), (I.01)+(15.073), (I.01)+(15.074), (I.01)+(15.075), (I.01)+(15.076), (I.01)+(15.077), (I.01)+(15.078), (I.01)+(15.079), (I.01)+(15.080), (I.01)+(15.081), (I.01)+(15.082), (I.01)+(15.083), (I.01)+(15.084), (I.01)+(15.085), (I.01)+(15.086), (I.01)+(15.087), (I.01)+(15.088), (I.01)+(15.089), (I.01)+(15.090), (I.01)+(15.091), (I.01)+(15.092), (I.01)+(15.093), (I.01)+(15.094), (I.01)+(15.095), (I.01)+(15.096), (I.01)+(15.097), (I.01)+(15.098), (I.01)+(15.099), (I.01)+(15.100), (I.01)+(15.101), (I.01)+(15.102), (I.01)+(15.103), (I.01)+(15.104), (I.01)+(15.105), (I.01)+(15.106), (I.01)+(15.107), (I.01)+(15.108), (I.01)+(15.109), (I.01)+(15.110), (I.01)+(15.111), (I.01)+(15.112), (I.01)+(15.113), (I.01)+(15.114), (I.01)+(15.115) and (I.01)+(15.116).

Also preferred compound combinations are selected from group (G2) consisting of the following mixtures:

(I.02)+(1.001), (I.02)+(1.002), (I.02)+(1.003), (I.02)+(1.004), (I.02)+(1.005), (I.02)+(1.006), (I.02)+(1.007), (1.02)+(1.008), (1.02)+(1.009), (1.02)+(1.010), (1.02)+(1.011), (1.02)+(1.012), (1.02)+(1.013), (1.02)+(1.014), (1.02)+(1.015), (1.02)+(1.016), (1.02)+(1.017), (1.02)+(1.018), (1.02)+(1.019), (1.02)+(1.020), (1.02)+(1.021), (1.02)+(1.022), (1.02)+(1.023), (1.02)+(1.024), (1.02)+(1.025), (1.02)+(1.026), (1.02)+(1.027), (1.02)+(1.028), (1.02)+(1.029), (1.02)+(1.030), (1.02)+(1.031), (1.02)+(1.032), (I.02)+(1.033), (I.02)+(1.034), (I.02)+(1.035), (I.02)+(1.036), (I.02)+(1.037), (I.02)+(1.038), (I.02)+(1.039), (I.02)+(1.040), (I.02)+(1.041), (I.02)+(1.042), (I.02)+(1.043), (I.02)+(1.044), (I.02)+(1.045), (I.02)+(1.046), (I.02)+(1.047), (I.02)+(1.048), (I.02)+(1.049), (I.02)+(1.050), (I.02)+(1.051), (I.02)+(1.052), (I.02)+(1.053), (I.02)+(1.054), (I.02)+(1.055), (I.02)+(1.056), (I.02)+(1.057), (1.02)+(1.058), (1.02)+(1.059), (1.02)+(1.060), (1.02)+(1.061), (1.02)+(1.062), (1.02)+(1.063), (1.02)+(1.064), (1.02)+(1.065), (1.02)+(1.066), (1.02)+(1.067), (1.02)+(1.068), (1.02)+(1.069), (1.02)+(1.070), (1.02)+(1.071), (1.02)+(1.072), (1.02)+(1.073), (1.02)+(1.074), (1.02)+(1.075), (1.02)+(1.076), (1.02)+(1.077), (1.02)+(1.078), (1.02)+(1.079), (1.02)+(1.080), (1.02)+(1.081), (1.02)+(1.082), (1.02)+(1.083), (1.02)+(1.084), (1.02)+(1.085), (1.02)+(1.086), (1.02)+(1.087), (1.02)+(2.001), (1.02)+(2.002), (1.02)+(2.003), (1.02)+(2.004), (1.02)+(2.005), (1.02)+(2.006), (1.02)+(2.007), (1.02)+(2.008), (1.02)+(2.009), (1.02)+(2.010), (1.02)+(2.011), (1.02)+(2.012), (1.02)+(2.013), (1.02)+(2.014), (1.02)+(2.015), (1.02)+(2.016), (1.02)+(2.017), (1.02)+(2.018), (1.02)+(2.019), (1.02)+(2.020), (1.02)+(2.021), (1.02)+(2.022), (1.02)+(2.023), (1.02)+(2.024), (1.02)+(2.025), (1.02)+(2.026), (1.02)+(2.027), (1.02)+(2.028), (1.02)+(2.029), (1.02)+(2.030), (1.02)+(2.031), (1.02)+(2.032), (1.02)+(2.033), (1.02)+(2.034), (1.02)+(2.035), (1.02)+(2.036), (1.02)+(2.037), (1.02)+(2.038), (1.02)+(2.039), (1.02)+(2.040), (1.02)+(2.041), (1.02)+(2.042), (1.02)+(2.043), (1.02)+(2.044), (1.02)+(2.045), (1.02)+(2.046), (1.02)+(2.047), (1.02)+(2.048), (1.02)+(2.049), (1.02)+(2.050), (1.02)+(2.051), (1.02)+(2.052), (1.02)+(2.053), (1.02)+(2.054), (1.02)+(2.055), (1.02)+(2.056), (1.02)+(2.057), (1.02)+(3.001), (1.02)+(3.002), (1.02)+(3.003), (1.02)+(3.004), (1.02)+(3.005), (1.02)+(3.006), (1.02)+(3.007), (I.02)+(3.008), (1.02)+(3.009), (1.02)+(3.010), (1.02)+(3.011), (1.02)+(3.012), (1.02)+(3.013), (1.02)+(3.014), (1.02)+(3.015), (1.02)+(3.016), (1.02)+(3.017), (1.02)+(3.018), (1.02)+(3.019), (1.02)+(3.020), (1.02)+(3.021), (1.02)+(3.022), (1.02)+(3.023), (1.02)+(3.024), (1.02)+(3.025), (1.02)+(3.026), (1.02)+(3.027), (1.02)+(3.028), (1.02)+(3.029), (1.02)+(3.030), (1.02)+(3.031), (1.02)+(4.001), (1.02)+(4.002), (1.02)+(4.003), (1.02)+(4.004), (1.02)+(4.005), (1.02)+(4.006), (1.02)+(4.007), (1.02)+(4.008), (1.02)+(4.009), (1.02)+(4.010), (1.02)+(4.011), (1.02)+(4.012), (1.02)+(4.013), (1.02)+(4.014), (1.02)+(4.015), (1.02)+(4.016), (1.02)+(4.017), (1.02)+(4.018), (1.02)+(4.019), (1.02)+(4.020), (1.02)+(4.021), (1.02)+(4.022), (1.02)+(4.023), (1.02)+(4.024), (1.02)+(4.025), (1.02)+(5.001), (1.02)+(5.002), (1.02)+(5.003), (1.02)+(5.004), (1.02)+(5.005), (1.02)+(5.006), (1.02)+(5.007), (1.02)+(5.008), (1.02)+(5.009), (1.02)+(5.010), (1.02)+(5.011), (1.02)+(5.012), (1.02)+(5.013), (1.02)+(5.014), (1.02)+(5.015), (1.02)+(5.016), (1.02)+(5.017), (1.02)+(5.018), (1.02)+(5.019), (1.02)+(5.020), (1.02)+(5.021), (1.02)+(5.022), (1.02)+(5.023), (1.02)+(6.001), (1.02)+(6.002), (1.02)+(6.003), (1.02)+(6.004), (1.02)+(7.001), (1.02)+(7.002), (1.02)+(7.003), (1.02)+(7.004), (1.02)+(7.005), (1.02)+(7.006), (1.02)+(8.001), (1.02)+(9.001), (1.02)+(9.002), (1.02)+(9.003), (1.02)+(9.004), (1.02)+(9.005), (1.02)+(9.006), (1.02)+(9.007), (1.02)+(9.008), (1.02)+(9.009), (1.02)+(10.001), (1.02)+(10.002), (1.02)+(10.003), (1.02)+(11.001), (1.02)+(11.002), (1.02)+(12.001), (1.02)+(12.002), (1.02)+(12.003), (1.02)+(12.004), (1.02)+(13.001), (1.02)+(13.002), (1.02)+(13.003), (1.02)+(13.004), (1.02)+(13.005), (1.02)+(13.006), (1.02)+(14.001), (1.02)+(14.002), (1.02)+(15.001), (1.02)+(15.002), (1.02)+(15.003), (1.02)+(15.004), (1.02)+(15.005), (1.02)+(15.006), (1.02)+(15.007), (1.02)+(15.008), (1.02)+(15.009), (1.02)+(15.010), (1.02)+(15.011), (1.02)+(15.012), (1.02)+(15.013), (1.02)+(15.014), (1.02)+(15.015), (1.02)+(15.016), (1.02)+(15.017), (1.02)+(15.018), (1.02)+(15.019), (1.02)+(15.020), (1.02)+(15.021), (1.02)+(15.022), (1.02)+(15.023), (1.02)+(15.024), (1.02)+(15.025), (1.02)+(15.026), (1.02)+(15.027), (1.02)+(15.028), (1.02)+(15.029), (1.02)+(15.030), (1.02)+(15.031), (1.02)+(15.032), (1.02)+(15.033), (1.02)+(15.034), (1.02)+(15.035), (1.02)+(15.036), (1.02)+(15.037), (1.02)+(15.038), (1.02)+(15.039), (1.02)+(15.040), (1.02)+(15.041), (1.02)+(15.042), (1.02)+(15.043), (1.02)+(15.044), (1.02)+(15.045), (1.02)+(15.046), (1.02)+(15.047), (1.02)+(15.048), (1.02)+(15.049), (1.02)+(15.050), (1.02)+(15.051), (1.02)+(15.052), (1.02)+(15.053), (1.02)+(15.054), (1.02)+(15.055), (1.02)+(15.056), (1.02)+(15.057), (1.02)+(15.058), (1.02)+(15.059), (1.02)+(15.060), (1.02)+(15.061), (1.02)+(15.062), (1.02)+(15.063) , (1.02)+(15.064), (1.02)+(15.065), (1.02)+(15.066), (1.02)+(15.067), (1.02)+(15.068), (1.02)+(15.069), (1.02)+(15.070), (1.02)+(15.071), (1.02)+(15.072), (1.02)+(15.073), (1.02)+(15.074), (1.02)+(15.075), (1.02)+(15.076), (1.02)+(15.077), (1.02)+(15.078), (1.02)+(15.079), (1.02)+(15.080), (1.02)+(15.081), (1.02)+(15.082), (1.02)+(15.083), (I.02)+(15.084), (I.02)+(15.085), (I.02)+(15.086), (I.02)+(15.087), (I.02)+(15.088), (I.02)+(15.089), (I.02)+(15.090), (I.02)+(15.091), (I.02)+(15.092), (I.02)+(15.093), (I.02)+(15.094), (I.02)+(15.095), (I.02)+(15.096), (I.02)+(15.097), (I.02)+(15.098), (I.02)+(15.099), (I.02)+(15.100), (I.02)+(15.101), (I.02)+(15.102), (I.02)+(15.103), (I.02)+(15.104), (I.02)+(15.105), (I.02)+(15.106), (I.02)+(15.107), (I.02)+(15.108), (I.02)+(15.109), (I.02)+(15.110), (I.02)+(15.111), (I.02)+(15.112), (I.02)+(15.113), (I.02)+(15.114), (I.02)+(15.115) and (I.02)+(15.116).

More preferred the compound combinations are selected from the mixtures belonging to group (G1).

(I.01)+(1.001), (I.01)+(1.002), (I.01)+(1.003), (I.01)+(1.004), (I.01)+(1.005), (I.01)+(1.006), (I.01)+(1.007), (1.01)+(1.008), (1.01)+(1.009), (1.01)+(1.010), (1.01)+(1.011), (1.01)+(1.012), (1.01)+(1.013), (1.01)+(1.014), (1.01)+(1.015), (1.01)+(1.016), (1.01)+(1.017), (1.01)+(1.018), (1.01)+(1.019), (1.01)+(1.020), (1.01)+(1.021), (1.01)+(1.022), (1.01)+(1.023), (1.01)+(1.025), (1.01)+(1.082), (1.01)+(1.087), (1.01)+(2.001), (1.01)+(2.002), (1.01)+(2.003), (1.01)+(2.005), (1.01)+(2.007), (1.01)+(2.009), (1.01)+(2.010), (1.01)+(2.011), (1.01)+(2.012), (1.01)+(2.013), (1.01)+(2.014), (1.01)+(2.015), (1.01)+(2.016), (1.01)+(2.017), (1.01)+(2.018), (1.01)+(2.019), (1.01)+(2.020), (1.01)+(2.021), (1.01)+(2.030), (I.01)+(2.038), (I.01)+(2.057), (I.01)+(3.003), (I.01)+(3.006), (I.01)+(3.010), (I.01)+(3.012), (I.01)+(3.014), (I.01)+(3.016), (I.01)+(3.017), (I.01)+(3.020), (I.01)+(3.025), (I.01)+(3.031), (I.01)+(4.004), (I.01)+(4.005), (I.01)+(4.008), (I.01)+(5.001), (I.01)+(5.003), (I.01)+(5.004), (I.01)+(5.005), (I.01)+(5.006), (I.01)+(5.007), (I.01)+(5.008), (I.01)+(5.009), (I.01)+(5.011), (I.01)+(5.012), (I.01)+(5.013), (I.01)+(5.015), (I.01)+(5.016), (I.01)+(5.018), (I.01)+(5.019), (I.01)+(6.001), (I.01)+(6.002), (I.01)+(6.003), (I.01)+(6.004), (I.01)+(7.001), (I.01)+(7.002), (I.01)+(7.003), (I.01)+(7.005), (1.01)+(9.001), (1.01)+(9.002), (1.01)+(9.004), (1.01)+(9.005), (1.01)+(9.006), (1.01)+(9.007), (1.01)+(10.001), (1.01)+(10.002), (1.01)+(12.003), (1.01)+(12.004), (1.01)+(13.001), (1.01)+(13.002), (I.01)+(15.009), (I.01)+(15.011), (I.01)+(15.012), (I.01)+(15.013), (I.01)+(15.014), (I.01)+(15.022), (I.01)+(15.026), (I.01)+(15.041), (I.01)+(15.047), (I.01)+(15.063).

Also preferred compound combinations are selected from group (G2) consisting of the following mixtures:

(I.02)+(1.001), (I.02)+(1.002), (I.02)+(1.003), (I.02)+(1.004), (I.02)+(1.005), (I.02)+(1.006), (I.02)+(1.007), (1.02)+(1.008), (1.02)+(1.009), (1.02)+(1.010), (1.02)+(1.011), (1.02)+(1.012), (1.02)+(1.013), (1.02)+(1.014), (1.02)+(1.015), (1.02)+(1.016), (1.02)+(1.017), (1.02)+(1.018), (1.02)+(1.019), (1.02)+(1.020), (1.02)+(1.021), (1.02)+(1.022), (1.02)+(1.023), (1.02)+(1.025), (1.02)+(1.082), (1.02)+(1.087), (1.02)+(2.001), (1.02)+(2.002), (1.02)+(2.003), (1.02)+(2.005), (1.02)+(2.007), (1.02)+(2.009), (1.02)+(2.010), (1.02)+(2.011), (1.02)+(2.012), (1.02)+(2.013), (1.02)+(2.014), (1.02)+(2.015), (1.02)+(2.016), (1.02)+(2.017), (1.02)+(2.018), (1.02)+(2.019), (1.02)+(2.020), (1.02)+(2.021), (1.02)+(2.030), (I.02)+(2.038), (I.02)+(2.057), (I.02)+(3.003), (I.02)+(3.006), (I.02)+(3.010), (I.02)+(3.012), (I.02)+(3.014), (I.02)+(3.016), (I.02)+(3.017), (I.02)+(3.020), (I.02)+(3.025), (I.02)+(3.031), (I.02)+(4.004), (I.02)+(4.005), (I.02)+(4.008), (I.02)+(5.001), (I.02)+(5.003), (I.02)+(5.004), (I.02)+(5.005), (I.02)+(5.006), (I.02)+(5.007), (I.02)+(5.008), (I.02)+(5.009), (I.02)+(5.011), (I.02)+(5.012), (I.02)+(5.013), (I.02)+(5.015), (I.02)+(5.016), (I.02)+(5.018), (I.02)+(5.019), (I.02)+(6.001), (I.02)+(6.002), (I.02)+(6.003), (I.02)+(6.004), (I.02)+(7.001), (I.02)+(7.002), (I.02)+(7.003), (I.02)+(7.005), (1.02)+(9.001), (1.02)+(9.002), (1.02)+(9.004), (1.02)+(9.005), (1.02)+(9.006), (1.02)+(9.007), (1.02)+(10.001), (1.02)+(10.002), (1.02)+(12.003), (1.02)+(12.004), (1.02)+(13.001), (1.02)+(13.002), (I.02)+(15.009), (I.02)+(15.011), (I.02)+(15.012), (I.02)+(15.013), (I.02)+(15.014), (I.02)+(15.022), (I.02)+(15.026), (I.02)+(15.041), (I.02)+(15.047), (I.02)+(15.063).

Even more preferred compound combinations are selected from the group (G1-A) consisting ofthe following mixtures:

(I.01)+(1.002), (I.01)+(1.004), (I.01)+(1.005), (I.01)+(1.006), (I.01)+(1.012), (I.01)+(1.013), (I.01)+(1.017), (1.01)+(1.018), (1.01)+(1.020), (1.01)+(1.021), (1.01)+(1.082), (1.01)+(1.087), (1.01)+(2.001), (1.01)+(2.002), (1.01)+(2.003), (1.01)+(2.005), (1.01)+(2.007), (1.01)+(2.010), (1.01)+(2.011), (1.01)+(2.012), (1.01)+(2.013), (1.01)+(2.014), (1.01)+(2.015), (1.01)+(2.016), (1.01)+(2.017), (1.01)+(2.018), (I.01)+(2.019), (I.01)+(2.038), (I.01)+(3.003), (I.01)+(3.012), (I.01)+(3.016), (I.01)+(3.017), (I.01)+(3.020), (I.01)+(3.025), (I.01)+(3.031), (I.01)+(4.004), (I.01)+(4.008), (I.01)+(5.005), (I.01)+(5.006), (I.01)+(5.007), (I.01)+(5.008), (I.01)+(5.009), (I.01)+(5.011), (I.01)+(5.012), (I.01)+(5.013), (I.01)+(5.018), (I.01)+(5.019), (I.01)+(6.002), (I.01)+(7.005), (I.01)+(9.001), (I.01)+(9.002), (I.01)+(9.004), (I.01)+(9.005), (I.01)+(10.001), (I.01)+(10.002), (I.01)+(13.001), (I.01)+(13.002), (I.01)+(15.012), (I.01)+(15.022), (I.01)+(15.041), (I.01)+(15.047), (I.01)+(15.063).

Even more preferred compound combinations are also selected from the group (G2-A) consisting of the following mixtures:

(I.02)+(1.002), (I.02)+(1.004), (I.02)+(1.005), (I.02)+(1.006), (I.02)+(1.012), (I.02)+(1.013), (I.02)+(1.017), (1.02)+(1.018), (1.02)+(1.020), (1.02)+(1.021), (1.02)+(1.082), (1.01)+(1.087), (1.02)+(2.001), (1.02)+(2.002), (1.02)+(2.003), (1.02)+(2.005), (1.02)+(2.007), (1.02)+(2.010), (1.02)+(2.011), (1.02)+(2.012), (1.02)+(2.013), (1.02)+(2.014), (1.02)+(2.015), (1.02)+(2.016), (1.02)+(2.017), (1.02)+(2.018), (I.02)+(2.019), (I.02)+(2.038), (I.02)+(3.003), (I.02)+(3.012), (I.02)+(3.016), (I.02)+(3.017), (I.02)+(3.020), (I.02)+(3.025), (I.02)+(3.031), (I.02)+(4.004), (I.02)+(4.008), (I.02)+(5.005), (I.02)+(5.006), (I.02)+(5.007), (I.02)+(5.008), (I.02)+(5.009), (I.02)+(5.011), (I.02)+(5.012), (I.02)+(5.013), (I.02)+(5.018), (I.02)+(5.019), (I.02)+(6.002), (I.02)+(7.005), (I.02)+(9.001), (I.02)+(9.002), (I.02)+(9.004), (I.02)+(9.005), (I.02)+(10.001), (I.02)+(10.002), (I.02)+(13.001), (I.02)+(13.002), (I.02)+(15.012), (I.02)+(15.022), (I.02)+(15.041), (I.02)+(15.047), (I.02)+(15.063).

Most preferred the compound combinations are selected from the mixtures belonging to group (G2-A).

In another even more preferred embodiment, the agent active against at least plant pathogen and/or active in plant growth promotion is selected from the group consisting of (5.005) copper hydroxide, (5.006) copper naphthenate, (5.007) copper oxide, (5.008) copper oxychloride, (5.009) copper(2+) sulfate, (5.017) oxine-copper and (5.019) sulfur and sulfur preparations including calcium polysulfide.

As can be seen in the examples, active agents selected from the above group provide excellent pathogen control when applied together with fatty acids or salts or derivatives thereof, in particular with potassium salts of fatty acids as defined herein. As the mode of action of all listed copper salts is the same, it is to be expected that the beneficial effect observed extends to any copper salt. The same holds true for sulfur which can be present in several different sulfur preparations including certains salts such as polysulfides. These agents are preferably applied as foliar treatment.

In another embodiment, the agent active against at least one plant pathogen and/or active in plant growth promotion is a biological control agent.

As used herein, the term “biological control” is defined as control of harmful organisms such as a phytopathogenic fungi and/or insects and/or acarids and/or nematodes by the use or employment of a biological control agent.

As used herein, the term “biological control agent” is defined as an organism other than the harmful organisms and/or proteins or secondary metabolites produced by such an organism for the purpose of biological control. Mutants of the second organism shall be included within the definition of the biological control agent. The term “mutant” refers to a variant of the parental strain as well as methods for obtaining a mutant or variant in which the pesticidal activity is greater than that expressed by the parental strain. The “parent strain” is defined herein as the original strain before mutagenesis. To obtain such mutants the parental strain may be treated with a chemical such as N-methyl-N′-nitro-N-nitrosoguanidine, ethylmethanesulfone, or by irradiation using gamma, x-ray, or UV-irradiation, or by other means well known to those skilled in the art. Known mechanisms of biological control agents comprise enteric bacteria that control root rot by out-competing fungi for space on the surface of the root. Bacterial toxins, such as antibiotics, have been used to control pathogens. The toxin can be isolated and applied directly to the plant or the bacterial species may be administered so it produces the toxin in situ.

A “variant” is a strain having all the identifying characteristics of the NRRL or ATCC Accession Numbers as indicated in this text and can be identified as having a genome that hybridizes under conditions of high stringency to the genome of the NRRL or ATCC Accession Numbers.

“Hybridization” refers to a reaction in which one or more polynucleotides react to fonn a complex that is stabilized via hydrogen bonding between the bases of the nucleotide residues. The hydrogen bonding may occur by Watson-Crick base pairing, Hoogstein binding, or in any other sequence-specific manner. The complex may comprise two strands forming a duplex structure, three or more strands forming a multi-stranded complex, a single self-hybridizing strand, or any combination of these. Hybridization reactions can be performed under conditions of different “stringency”. In general, a low stringency hybridization reaction is carried out at about 40° C. in 10×SSC or a solution of equivalent ionic strength/temperature. A moderate stringency hybridization is typically performed at about 50° C. in 6×SSC, and a high stringency hybridization reaction is generally performed at about 60° C. in 1×SSC.

A variant of the indicated NRRL or ATCC Accession Number may also be defined as a strain having a genomic sequence that is greater than 85%, more preferably greater than 90% or more preferably greater than 95% sequence identity to the genome of the indicated NRRL or ATCC Accession Number. A polynucleotide or polynucleotide region (or a polypeptide or polypeptide region) has a certain percentage (for example, 80%, 85%, 90%, or 95%) of “sequence identity” to another sequence means that, when aligned, that percentage of bases (or amino acids) are the same in comparing the two sequences. This alignment and the percent homology or sequence identity can be determined using software programs known in the art, for example, those described in Current Protocols in Molecular Biology (F. M. Ausubel et al., eds., 1987).

NRRL is the abbreviation for the Agricultural Research Service Culture Collection, an international depositary authority for the purposes of deposing microorganism strains under the Budapest treaty on the international recognition of the deposit of microorganisms for the purposes of patent procedure, having the address National Center for Agricultural Utilization Research, Agricultural Research service, U.S. Department of Agriculture, 1815 North university Street, Peroira, Illinois 61604 USA.

ATCC is the abbreviation for the American Type Culture Collection, an international depositary authority for the purposes of deposing microorganism strains under the Budapest treaty on the international recognition of the deposit of microorganisms for the purposes of patent procedure, having the address ATCC Patent Depository, 10801 University Blvd., Manassas, VA 10110 USA.

The biological control agent may be a bactericidally active agent. Such bactericidally active biological control agents comprise

(A1) bacteria, such as (A1.1) Bacillus subtilis, in particular strain QST713/AQ713 (available as SERENADE OPTI or SERENADE ASO from Bayer CropScience LP, US, having NRRL Accession No. B21661, U.S. Pat. No. 6,060,051); (A1.2) Bacillus sp., in particular strain D747 (available as DOUBLE NICKEL® from Kumiai Chemical Industry Co., Ltd.), having Accession No. FERM BP-8234, U.S. Pat. No. 7,094,592; (A1.3) Bacillus pumilus, in particular strain BU F-33, having NRRL Accession No. 50185 (available as part of the CARTISSA® product from BASF, EPA Reg. No. 71840-19); (A1.4) Bacillus subtilis var. amyloliquefaciens strain FZB24 having Accession No. DSM 10271 (available from Novozymes as TAEGRO® or TAEGRO® ECO (EPA Registration No. 70127-5)); (A1.5) a Paenibacillus sp. strain having Accession No. NRRL B-50972 or Accession No. NRRL B-67129, WO 2016/154297; (A1.6) Bacillus subtilis strain BU1814, (available as VELONDIS EXTRA from BASF SE); (A1.7) Bacillus mojavensis strain R3B (Accession No. NCAIM (P) B001389) (WO 2013/034938) from Certis USA LLC, a subsidiary of Mitsui & Co.; (A1.8) Bacillus subtilis CX-9060 from Certis USA LLC, a subsidiary of Mitsui & Co.; (A1.9) Paenibacillus polymyxa, in particular strain AC-1 (e.g. TOPSEED® from Green Biotech Company Ltd.); (A1.10) Pseudomonas proradix (e.g. PRORADIX® from Sourcon Padena); (A1.11) Pantoea agglomerans, in particular strain E325 (Accession No. NRRL B-21856) (available as BLOOMTIME BIOLOGICAL™ FD BIOPESTICIDE from Northwest Agri Products); and

(A2) fungi, such as (A2.1) Aureobasidium pullulans strain DSM14940, strain DSM 14941 or mixtures of strains DSM14940 and DSM14941 (e.g., BOTECTOR® and BLOSSOM PROTECT®from bio-ferm, CH); (A2.2) Pseudozyma aphidis (as disclosed in WO2011/151819 by Yissum Research Development Company of the Hebrew University of Jerusalem); (A2.3) Saccharomyces cerevisiae, in particular strains CNCM No. 1-3936, CNCM No. 1-3937, CNCM No. 1-3938 or CNCM No. 1-3939 (WO 2010/086790) from Lesaffre et Compagnie, FR.

The biological control agent may be a fungicidally active agent or an agent active against oomycetes. Such biological control agents comprise

(B1) bacteria, for example (B1.1) Bacillus subtilis, in particular strain QST713/AQ713 (available as SERENADE OPTI or SERENADE ASO from Bayer CropScience LP, US, having NRRL Accession No. B21661 and described in U.S. Pat. No. 6,060,051); (B1.2) Bacillus pumilus, in particular strain QST2808 (available as SONATA® from Bayer CropScience LP, US, having Accession No. NRRL B-30087 and described in U.S. Pat. No. 6,245,551); (B1.3) Bacillus pumilus, in particular strain GB34 (available as Yield Shield® from Bayer AG, DE); (B1.4) Bacillus pumilus, in particular strain BU F-33, (having NRRL Accession No. 50185 (available as part of the CARTISSA product from BASF, EPA Reg. No. 71840-19)); (B1.5) Bacillus amyloliquefaciens, in particular strain D747 (available as Double Nickel™ from Kumiai Chemical Industry Co., Ltd. Certis, US, having accession number FERM BP-8234, and disclosed in US Pat. No. 7,094,592); (B1.6) Bacillus subtilis Y1336 (available as BIOBAC® WP from Bion-Tech, Taiwan, registered as a biological fungicide in Taiwan under Registration Nos. 4764, 5454, 5096 and 5277); (B1.7) Bacillus amyloliquefaciens subtilis strain MBI 600 (available as SUBTILEX from BASF SE), having Accession Number NRRL B-50595, U.S. Pat. No. 5,061,495; (B1.8) Bacillus subtilis strain GB03 (available as Kodiak® from Bayer AG, DE); (B1.9) Bacillus subtilis var. amyloliquefaciens strain FZB24 having Accession No. DSM 10271 (available from Novozymes as TAEGRO® or TAEGRO® ECO (EPA

Registration No. 70127-5))(available from Novozymes Biologicals Inc., Salem, Virginia or Syngenta Crop Protection, LLC, Greensboro, North Carolina as the fungicide TAEGRO® or TAEGRO® ECO (EPA Registration No. 70127-5); (B1.10) Bacillus mycoides, isolate J , having Accession No. B-30890 (available as BMJ TGAI® WG and LifeGard™ from Certis USA LLC, a subsidiary of Mitsui & Co.)(available as BmJ TGAI or WG from Certis USA); (B1.11) Bacillus licheniformis, in particular strain SB3086 , having Accession No. ATCC 55406, WO 2003/000051 (available as ECOGUARD® Biofungicide and GREEN RELEAF™ from Novozymes)(available as EcoGuard TM Biofungicide and Green Releaf from Novozymes); (B1.12) a Paenibacillus sp. strain having Accession No. NRRL B-50972 or Accession No. NRRL B-67129, and described in International Patent Publication No. WO 2016/154297; (B1.13) Bacillus subtilis strain BU1814, (available as VELONDIS® PLUS, VELONDIS® FLEX and VELONDIS® EXTRA from BASF SE); (B1.14) Bacillus subtilis CX-9060 from Certis USA LLC, a subsidiary of Mitsui & Co.; (B1.15) Bacillus amyloliquefaciens strain F727 (also known as strain MBI110) (NRRL Accession No. B-50768; WO 2014/028521) (STARGUS® from Marrone Bio Innovations); (B1.16) Bacillus amyloliquefaciens strain FZB42, Accession No. DSM 23117 (available as RHIZOVITAL® from ABiTEP, DE); (B1.17) Bacillus licheniformis FMCH001 and Bacillus subtilis FMCH002 (QUARTZO® (WG) and PRESENCE® (\VP) from FMC Corporation); (B1.18) Bacillus mojavensis strain R3B (Accession No. NCAIM (P) B001389) (WO 2013/034938) from Certis USA LLC, a subsidiary of Mitsui & Co.; (B1.19) Paenibacillus polymyxa ssp. plantarum (WO 2016/020371) from BASF SE; (B1.20) Paenibacillus epiphyticus (WO 2016/020371) from BASF SE; (B.1.21) Pseudomonas chlororaphis strain AFS009, having Accession No. NRRL B-50897, WO 2017/019448 (e.g., HOWLER™ and ZIO® from AgBiome Innovations, US); (B1.22) Pseudomonas chlororaphis, in particular strain MA342 (e.g. CEDOMON®, CERALL®, and CEDRESS® by Bioagri and Koppert); (B1.23) Streptomyces lydicus strain WYEC108 (also known as Streptomyces lydicus strain WYCD108US) (ACTINO-IRON® and ACTINOVATEO from Novozymes); (B1.24) Agrobacterium radiobacter strain K84 (e.g. GALLTROL-A® from AgBioChem, CA); (B1.25) Agrobacterium radiobacter strain K1026 (e.g. NOGALLTM from BASF SE); (B1.26) Bacillus subtilis KTSB strain (FOLIACTIVE® from Donaghys); (B1.27) Bacillus subtilis IAB/BS03 (AVIV™ from STK Bio-Ag Technologies); (B1.28) Bacillus subtilis strain Y1336 (available as BIOBAC® WP from Bion-Tech, Taiwan, registered as a biological fungicide in Taiwan under Registration Nos. 4764, 5454, 5096 and 5277); (B1.29) Bacillus amyloliquefaciens isolate B246 (e.g. AVOGREEN™ from University of Pretoria); (B1.30) Bacillus methylotrophicus strain BAC-9912 (from Chinese Academy of Sciences' Institute of Applied Ecology); (B1.31) Pseudomonas proradix (e.g. PRORADIX® from Sourcon Padena); (B1.32) Streptomyces griseoviridis strain K61 (also known as Streptomyces galbus strain K61) (Accession No. DSM 7206) (MYCOSTOP® from Verdera; PREFENCE® from BioWorks; cf. Crop Protection 2006, 25, 468-475); (B1.33) Pseudomonas fluorescens strain A506 (e.g. BLIGHTBAN® A506 by NuFarm); and.

(B2) fungi, for example: (B2.1) Coniothyrium minitans strain CON/M/91-8 (Accession No. DSM-9660; e.g. Contans® from Bayer CropScience Biologics GmbH); (B2.2) Talaromyces flavus strain V117b; (B2.3) Trichoderma atroviride strain CNCM 1-1237 (e.g. Esquive® WP from Agrauxine, FR); (B2.4) Gliocladium catenulatum (Synonym: Clonostachys rosea f catenulate) strain J1446 (e.g. Prestop ® by Lallemand); (B2.5) Trichoderma viride strain B35 (Pietr et al., 1993, Zesz. Nauk. A R w Szczecinie 161: 125-137); (B2.6) Metschnikowia fructicola strain NRRL Y-30752; (B2.7) Gliocladium roseum (also known as Clonostachys rosea f rosea), in particular strain 321U from Adjuvants Plus, strain ACM941 as disclosed in Xue (Efficacy of Clonostachys rosea strain ACM941 and fungicide seed treatments for controlling the root tot complex of field pea, Can Jour Plant Sci 83(3): 519-524), strain IK726 (Jensen DF, et al. Development of a biocontrol agent for plant disease control with special emphasis on the near commercial fungal antagonist Clonostachys rosea strain ‘IK726’; Australas Plant Pathol. 2007;36:95-101); (B2.8) Trichoderma asperellum strain SKT-1, having Accession No. FERM P-16510 (e.g., ECO-HOPE® from Kumiai Chemical Industry); Trichoderma asperellum T34 (ASPERELLO® from Biobest Group NV and T34 BIOCONTROL® by Biocontrol Technologies S. L., ES); (B2.9) Trichoderma asperelloides JM41R (Accession No. NRRL B-50759) (TRICHO PLUS® from BASF SE); (B2.10) Trichoderma asperellum strain ICC 012 (Isagro); Trichoderma atroviride strain SC1, having Accession No. CBS 122089, WO 2009/116106 and U.S. Pat. No. 8,431,120 (from Bi-PA), strain 77B (T77 from Andermatt Biocontrol), strain LU132 (e.g. Sentinel from Agrimm Technologies Limited), strain having Accession No. NMI V08/002387, strain having Accession No. NMI V08/002388, strain having Accession No. NMI V08/002389, strain having Accession No. NMI V08/002390, strain having Accession No. ATCC 20476 (IMI 206040), strain SKT-1, having Accession No. FERM P-16510, JP Patent Publication (Kokai) 11-253151 A, strain SKT-2, having Accession No. FERM P-16511, JP Patent Publication (Kokai) 11-253151 A, strain SKT-3, having Accession No. FERM P-17021, JP Patent Publication (Kokai) 11-253151 A; (B2.11) Trichoderma harzianum strain T-22 (e.g. Trianum-P from Andermatt Biocontrol or Koppert), strain DB 103 (available as T-GRO® 7456 by Dagutat Biolab); (B2.12) Trichoderma virens (also known as Gliocladium virens), in particular strain GL-21 (e.g. SoilGard by Certis, US); (B2.13) Trichoderma harzianum strain Cepa Simb-T5 (from Simbiose Agro); (B2.14) Aspergillus flavus strain NRRL 21882 (products known as AFLA-GUARD® from Syngenta/ChemChina); (B2.15) Chaetomium cupreum (Accession No. CABI 353812) (e.g. BIOKUPRUM ™ by AgriLife); (B2.16) Microsphaeropsis ochracea; (B2.17) Saccharomyces cerevisiae strain LASO2 (from Agro-Levures et Dérivés), strain LAS117 cell walls (CEREVISANE® from Lesaffre; ROMEO® from BASF SE), strains CNCM No. 1-3936, CNCM No. 1-3937, CNCM No. 1-3938, CNCM No. 1-3939 (WO 2010/086790) from Lesaffre et Compagnie, FR; (B2.18) Trichoderma virens strain G-41, formerly known as Gliocladium virens (Accession No. ATCC 20906) (e.g., ROOTSHIELD® PLUS WP and TURFSHIELD® PLUS WP from BioWorks, US); (B2.19) Gliocladium roseum strain 321 U, having Accession No. ATCC 10406, from W. F. Stoneman Company LLC; (B2.20) Trichoderma hamatum, having Accession No. ATCC 28012; (B2.21) Trichoderma harzianum strain TH35 (e.g., ROOT-PRO® by Mycontrol); (B2.22) Ampelomyces quisqualis strain AQ10, having Accession No. CNCM 1-807 (e.g., AQ 10® by IntrachemBio Italia); (B2.23) Aureobasidium pullulans having Accession No. DSM 14940, strain having Accession No. DSM 14941; (B2.24) Cladosporium cladosporioides strain H39, having Accession No. CBS122244, US 2010/0291039 (by Stichting Dienst Landbouwkundig Onderzoek); (B2.25) Lecanicillium longisporum (formerly known as Lecanicillium lecanii and also Verticillium lecanii) strain KV01 (e.g., VERTALEC® by Koppert BV, Netherlands/Arysta); (B2.26) Penicillium vermiculatum; (B2.27) Pichia anomala strain WRL-076, having Accession No. NRRL Y-30842, U.S. Pat. No. 7,579,183; (B2.28) Trichoderma asperellum strain kd (e.g. T-Gro from Andermatt Biocontrol); (B2.29) Trichoderma polysporum strain IMI 206039, having Accession No. IMI 206039 (e.g., BINAB® TF WP by BINAB Bio-Innovation AB, Sweden); (B2.30) Trichoderma stromaticum, having Accession No. Ts3550 (e.g., TRICOVAB® by CEPLAC, Brazil); (B2.31) Ulocladium oudemansii strain U3, having Accession No. NM 99/06216 (e.g., BOTRY-ZEN® by Botry-Zen Ltd, New Zealand and BOTRYSTOP from BioWorks, Inc.); (B2.32) Verticillium albo-atrum (formerly V. dahliae), having Accession No. WCS850, deposited at the Central Bureau for Fungi Cultures (e.g., DUTCH TRIG® by Tree Care Innovations); (B2.33) Verticillium chlamydosporium; (B2.34) mixtures of Trichoderma asperellum strain ICC 012 (also known as Trichoderma harzianum ICC012), having Accession No. CABI CC IMI 392716, (B2.35) Trichoderma gamsii (formerly T. viride) strain ICC 080, having Accession No. IMI 392151 (e.g., BIO-TAM™ from Isagro USA, Inc. and BIODERMA® by Agrobiosol de Mexico, S.A. de C.V.); (B2.36) Phlebiopsis gigantea strain VRA 1992 (ROTSTOP® C from Danstar Ferment); (B2.37) Penicillium steckii (DSM 27859; WO 2015/067800) from BASF SE; (B2.38) Chaetomium globosum (available as RIVADIOM® by Rivale); (B2.39) Cryptococcus flavescens, strain 3C (NRRL Y-50378); (B2.40) Dactylaria candida; (B2.41) Dilophosphora alopecuri (available as TWIST FUNGUS®); (B2.42) Fusarium oxysporum, strain Fo47 (available as FUSACLEAN® by Natural Plant Protection); (B2.43) Lecanicillium lecanii (formerly known as Verticillium lecanii) strain KV01 (available as VERTALEC® by Koppert/Arysta); (B2.44) Penicillium vermiculatum; (B2.45) Pichia anomala, strain WRL-076 (NRRL Y-30842); (B2.46) Pseudozyma flocculosa, strain PF-A22 UL (available as SPORODEX® L by Plant Products Co., CA); (B2.47) Trichoderma gamsii (formerly T viride), strain ICC080 (IMI CC 392151 CABI) (available as BIODERMA® by AGROBIOSOL DE MEXICO, S.A. DE C.V.); Trichoderma polysporum, strain IMI 206039 (available as BINAB TF® WP by BINAB Bio-Innovation AB, Sweden); Trichoderma stromaticum (available as TRICOVAB® by Ceplac, Brazil); Tsukamurella paurometabola, strain C-924 (available as HEBERNEM® by Gavac?); Ulocladium oudemansii, in particular strain HRU3 (available as BOTRY-ZEN® by Botry-Zen Ltd, NZ); Verticillium albo-atrum (formerly V dahliae), strain WCS850 (CBS 276.92); Trichoderma fertile (e.g. product TrichoPlus from BASF); Muscodor roseus, in particular strain A3-5 (Accession No. NRRL 30548); mixtures of Trichoderma asperellum strain ICC 012 and Trichoderma gamsii strain ICC 080 (e.g., BIO-TAM™ from Isagro USA, Inc. and BIODERMA® by Agrobiosol de Mexico, S.A. de C.V.); Simplicillium lanosoniveum.

The biological control agent may be a plant growth promotion agent. Such plant growth promotion agents comprise

(E1) bacteria selected from (E1.1) Bacillus pumilus, in particular strain QST2808 (having Accession No. NRRL No. B-30087) or strain GB34 (e.g. YIELD SHIELD® from Bayer Crop Science, DE); (E1.2) Bacillus subtilis, in particular strain QST713/AQ713 (having NRRL Accession No. B-2166 land described in U.S. Pat. No. 6,060,051; available as SERENADE® OPTI or SERENADE® ASO from Bayer CropScience LP, US), strain AQ30002 (having Accession Nos. NRRL B-50421 and described in U.S. patent application Ser. No. 13/330,576), strain AQ30004 (and NRRL B-50455 and described in U.S. patent application Ser. No. 13/330,576), strain MBI 600 (e.g. SUBTILEX® from BASF SE); (E1.3) Sinorhizobium meliloti strain NRG-185-1 (NITRAGIN® GOLD from Bayer CropScience); (E1.4) Bacillus subtilis strain BU1814, (available as TEQUALIS® from BASF SE); (E1.5) Bacillus subtilis rm303 (RHIZOMAX® from Biofilm Crop Protection); (E1.6) Bacillus amyloliquefaciens strain pm414 (LOLI-PEPTA® from Biofilm Crop Protection), strain SB3281 (ATCC # PTA-7542; WO 2017/205258), strain TJ1000 (available as QUIKROOTS from Novozymes), strain IN937a strain FZB42 (e.g. RHIZOVITAL® from ABiTEP, DE), strain BS27 (Accession No. NRRL B-5015); (E1.7) Bacillus mycoides strain BT155 (NRRL No. B-50921), strain EE118 (NRRL No. B-50918), strain EE141 (NRRL No. B-50916), strain BT46-3 (NRRL No. B-50922), (E1.8) Bacillus cereus family member EE128 (NRRL No. B-50917) or family member EE349 (NRRL No. B-50928), (E1.9) Bacillus thuringiensis BT013A (NRRL No. B-50924) also known as Bacillus thuringiensis 4Q7, (E1.10) Bacillus firmus, in particular strain CNMC 1-1582 (e.g. VOTIVO® from BASF SE); (E1.11) a mixture of Bacillus licheniformis FMCH001 and Bacillus subtilis FMCH002 (available as QUARTZO® (WG), PRESENCE® (WP) from FMC Corporation); (E1.12) Bacillus cereus, in particular strain BP01 (ATCC 55675; e.g. MEPICHLOR® from Arysta Lifescience, US); (E1.13) Bradyrhizobium japonicum (e.g. OPTIMIZE® from Novozymes); (E1.14) Mesorhizobium cicer (e.g., NODULATOR from BASF SE); (E1.15) Rhizobium leguminosarium biovar viciae (e.g., NODULATOR from BASF SE); (E1.16) Delfia acidovorans, in particular strain RAY209 (e.g. BIOBOOST® from Brett Young Seeds); (E1.17) Lactobacillus sp. (e.g. LACTOPLANT® from LactoPAFI); (E1.18) Paenibacillus polymyxa, in particular strain AC-1 (e.g. TOPSEED® from Green Biotech Company Ltd.); (E1.19) Pseudomonas proradix (e.g. PRORADIX® from Sourcon Padena); (E1.20) Azospirillum brasilense (e.g., VIGOR® from KALO, Inc.); (E1.21) Azospirillum lipoferum (e.g., VERTEX-IF™ from TerraMax, Inc.); (E1.22) a mixture of Azotobacter vinelandii and Clostridium pasteurianum (available as INVIGORATE® from Agrinos); (E1.23) Pseudomonas aeruginosa, in particular strain PN1; (E1.24) Rhizobium leguminosarum, in particular by. viceae strain Z25 (Accession No. CECT 4585); (E1.25) Azorhizobium caulinodans, in particular strain ZB-SK-5; (E1.26) Azotobacter chroococcum, in particular strain H23; (E1.27) Azotobacter vinelandii, in particular strain ATCC 12837; (E1.28) Bacillus siamensis, in particular strain KCTC 13613T; (E1.29) Bacillus tequilensis, in particular strain NII-0943; (E1.30) Serratia marcescens, in particular strain SRM (Accession No. MTCC 8708); (E1.31) Thiobacillus sp. (e.g. CROPAID® from Cropaid Ltd UK); and

(E2) fungi selected from (E2.1) Purpureocillium lilacinum (previously known as Paecilomyces lilacinus) strain 251 (AGAL 89/030550; e.g. BioAct from Bayer CropScience Biologics GmbH); (E2.2) Penicillium bilaii, strain ATCC 22348 (e.g. JumpStart® from Acceleron BioAg), (E2.3) Talaromyces flavus, strain V117b; (E2.4) Trichoderma atroviride strain CNCM 1-1237 (e.g. Esquive® WP from Agrauxine, FR), (E2.5) Trichoderma viride, e.g. strain B35 (Pietr et al., 1993, Zesz. Nauk. A R w Szczecinie 161: 125-137); (E2.6) Trichoderma atroviride strain LC52 (also known as Trichoderma atroviride strain LU132; e.g. Sentinel from Agrimm Technologies Limited); (E2.7) Trichoderma atroviride strain SC1 described in International Application No. PCT/IT2008/000196); (E2.8) Trichoderma asperellum strain kd (e.g. T-Gro from Andermatt Biocontrol); (E2.9) Trichoderma asperellum strain Eco-T (Plant Health Products, ZA); (E2.10) Trichoderma harzianum strain T-22 (e.g. Trianum-P from Andermatt Biocontrol or Koppert); (E2.11) Myrothecium verrucaria strain AARC-0255 (e.g. DiTera™ from Valent Biosciences); (E2.12) Penicillium bilaii strain ATCC20851; (E2.13) Pythium oligandrum strain M1 (ATCC 38472; e.g. Polyversum from Bioprepraty, CZ); (E2.14) Trichoderma vixens strain GL-21 (e.g. SoilGard® from Certis, USA); (E2.15) Verticillium albo-atrum (formerly V. dahliae) strain WCS850 (CBS 276.92; e.g. Dutch Trig from Tree Care Innovations); (E2.16) Trichoderma atroviride, in particular strain no. V08/002387, strain no. NMI No. V08/002388, strain no. NMI No. V08/002389, strain no. NMI No. V08/002390; (E2.17) Trichoderma harzianum strain ITEM 908, strain TSTh20, strain 1295-22; (E2.18) Pythium oligandrum strain DV74; (E2.19) Rhizopogon amylopogon (e.g. comprised in Myco-Sol from Helena Chemical Company); (E2.20) Rhizopogon fitivigleba (e.g. comprised in Myco-Sol from Helena Chemical Company); (E2.21) Trichoderma koningii; (E2.22) Glomus aggregatum; (E2.23) Glomus clarum; (E2.24) Glomus deserticola; (E2.25) Glomus etunicatum; (E2.26) Glomus intraradices; (E2.27) Glomus monosporum; (E2.28) Glomus mosseae; (E2.29) Laccaria bicolor; (E2.30) Rhizopogon luteolus; (E2.31) Rhizopogon tinctorus; (E2 .32) Rhizopogon villosulus; (E2 .33) Scleroderma cepa; (E2.34) Suillus granulatus; (E2 .35) Suillus punctatapies; (E2.36) Trichoderma vixens strain GI-3; (E2.37) Pseudozyma aphidis (e.g. from Yissum Research Development Company of the Hebrew University of Jerusalem).

Plant growth promoting control agents also include (F) bacteria and fungi which can be added as ‘inoculant’ to plants or plant parts or plant organs and which, by virtue of their particular properties, promote plant growth and plant health. Examples are: Agrobacterium spp., Azorhizobium caulinodans, Azospirillum spp., Azotobacter spp., Bradyrhizobium spp., Burkholderia spp., in particular Burkholderia cepacia (formerly known as Pseudomonas cepacia), Gigaspora spp., or Gigaspora monosporum, Glomus spp., Laccaria spp., Lactobacillus buchneri, Paraglomus spp., Pisolithus tinctorus, Pseudomonas spp., Rhizobium spp., in particular Rhizobium trifolii, Rhizopogon spp., Scleroderma spp., Suillus spp., and Streptomyces spp.; and

(G) plant extracts and products formed by microorganisms including proteins and secondary metabolites which can be used as biological control agents, such as Allium sativum, Artemisia absinthium, azadirachtin, Biokeeper WP, Cassia nigricans, Celastrus angulatus, Chenopodium anthelminticum, chitin, Armour-Zen, Dryopteris filix-mas, Equisetum arvense, Fortune Aza, Fungastop, Heads Up (Chenopodium quinoa saponin extract), Pyrethrum/Pyrethrins, Quassia amara, Quercus, Quillaja, Regalia, “Requiem™ Insecticide”, rotenone, ryania/ryanodine, Symphytum officinale, Tanacetum vulgare, thymol, Triact 70, TriCon, Tropaeulum majus, Urtica dioica, Veratrin, Viscum album, Brassicaceae extract, in particular oilseed rape powder or mustard powder.

Preferably, the biological control agent is selected from

Bacillus subtilis strain QST713/AQ713; a Paenibacillus sp. having Accession No. NRRL B-50972 or Accession No. NRRL B-67129, Bacillus pumilus strain BU F-33; Bacillus subtilis strain BU1814; Bacillus sp. D747; Bacillus subtilis var. amyloliquefaciens strain FZB24; Bacillus mojavensis strain R3B; Bacillus subtilis CX-9060, Bacillus pumilus strain QST2808,Coniothyrium minitans strain CON/M/91-8; Talaromyces flavus strain V117b; Trichoderma atroviride strain CNCM 1-1237; Gliocladium catenulatum strain J1446; Trichoderma viride strain B35; Metschnikowia fructicola strain NRRL Y-30752; Gliocladium roseum strain 321U, strain ACM941, strain IK726; Trichoderma asperellum strain SKT-1; Trichoderma asperellum T34; Trichoderma asperellum strain T34; Trichoderma asperelloides JM41R; Sinorhizobium meliloti strain NRG-185-1, Purpureocillium lilacinum strain 251, Penicillium bilaii, strain ATCC 22348, Trichoderma atroviride strain LC52; Trichoderma atroviride strain SC1; Trichoderma asperellum strain kd; Trichoderma asperellum strain Eco-T; Trichoderma harzianum strain T-22; Myrothecium verrucaria strain AARC-0255; Penicillium bilaii strain ATCC ATCC20851.

More preferably, the biological control agent is selected from Bacillus subtilis strain QST713/AQ713; a Paenibacillus sp. strain having Accession No. NRRL B-50972 or Accession No. NRRL B-67129, Bacillus pumilus strain QST2808, Coniothyrium minitans strain CON/M/91-8; Trichoderma atroviride strain CNCM 1-1237; Gliocladium catenulatum strain J1446; Trichoderma viride strain B35, Metschnikowia fructicola strain NRRL Y-30752; Sinorhizobium meliloti strain NRG-185-1, Purpureocillium lilacinum strain 251, Penicillium bilaii, strain ATCC 22348.

Accordingly, preferred combinations comprise

(1.01)+Bacillus subtilis strain QST713/AQ713, (1.01)+Paenibacillus sp. strain having Accession No. NRRL B-50972, (1.01)+Paenibacillus sp. strain having Accession No. NRRL B-67129, (1.01)+Bacillus pumilus strain QST2808, (1.01)+Coniothyrium minitans strain CON/M/91-8, (1.01)+Trichoderma atroviride strain CNCM 1-1237, (1.01)+Gliocladium catenulatum strain J1446, (1.01)+Trichoderma viride strain B35, (1.01)+Metschnikowiafructicola strain NRRL Y-30752, (1.01)+Sinorhizobium meliloti strain NRG-185-1, (1.01)+Purpureocillium lilacinum strain 251, (1.01)+Penicillium bilaii, strain ATCC 22348.

Alternative preferred combinations comprise (1.02)+Bacillus subtilis strain QST713/AQ713, (1.02)+Paenibacillus sp. strain having Accession No. NRRL B-50972, (1.02)+Paenibacillus sp. strain having Accession No. NRRL B-67129, (1.02)+Bacillus pumilus strain QST2808, (1.02)+Coniothyrium minitans strain CON/M/91-8, (1.02)+Trichoderma atroviride strain CNCM 1-1237, (1.02)+Gliocladium catenulatum strain J1446, (1.02)+Trichoderma viride strain B35, (1.02)+Metschnikowia fructicola strain NRRL Y-30752, (1.02)+Sinorhizobium meliloti strain NRG-185-1, (1.02)+Purpureocillium lilacinum strain 251, (1.02)+Penicillium bilaii, strain ATCC 22348.

Combinations comprising 1.02 are most preferred.

According to the invention, the expression “combination” stands for the various combinations of compounds (A) and (B), for example in a single “ready-mix” form, in a combined spray mixture composed from separate formulations of the single active compounds, such as a “tank-mix”, and in a combined use of the single active ingredients when applied in a sequential manner, i.e. one after the other within a reasonably short period, such as a few hours or days. Preferably the order of applying the compounds (A) and (B) is not essential for working the present invention.

In the combinations according to the invention the compounds (A) and (B) can be present in a broad range of effective weight ratio of A:B, for example in a range of 5000:1 to 1:5000, preferably in a weight ratio of 1000:1 to 1:1000, more preferably in a weight ratio of 500:1 to 1:500, and most preferably in a weight ratio of 100:1 to 1:100.

Further ratios of A:B which can be used according to the present invention are: 95:1 to 1:95, 90:1 to 1:90, 85:1 to 1:85, 80:1 to 1:80, 75:1 to 1:75, 70:1 to 1:70, 65:1 to 1:65, 60:1 to 1:60, 55:1 to 1:55, 50:1 to 1:50, 45:1 to 1:45, 40:1 to 1:40, 35:1 to 1:35, 30:1 to 1:30, 25:1 to 1:25, 20:1 to 1:20, 15:1 to 1:15, 10:1 to 1:10, 5:1 to 1:5, 4:1 to 1:4,3:1 to 1:3,2:1 to 1:2.

Further ratios of A:B which can be used according to the present invention are: 1000:1 to 1:1, 500:1 to 1:1, 250:1 to 1:1, 100:1 to 1:1, 95:1 to 1:1, 90:1 to 1:1, 85:1 to 1:1, 80:1 to 1:1, 75:1 to 1:1, 70:1 to 1:1, 65:1 to 1:1, 60:1 to 1:1, 55:1 to 1:1, 50:1 to 1:1, 45:1 to 1:1, 40:1 to 1:1, 35:1 to 1:1, 30:1 to 1:1, 25:1 to 1:1, 20:1 to 1:1, 15:1 to 1:1, 10:1 to 1:1,5:1 to 1:1,4:1 to 1:1,3:1 to 1:1,2:1 to 1:1.

Where B is a copper salt such as, but not limited to, copper hydroxide, preferred ratio ranges are between 500:1 and 1:1, more preferably 250:1 to 1:1, even more preferably 100:1 to 1:1. Most preferred are ratios between 80:1 and 20:1, such as between 70:1 and 30:1, between 60:1 and 40:1 or even between 60:1 and 50:1.

Where B is sulfur or a sulfur preparation, preferred ratio ranges are between 50:1 and 1:1, more preferably 25:1 to 1:1, even more preferably 15:1 to 1:1. Most preferred are ratios between 10:1 and 1:1, such as between 9:1 and 4:1 or between 8:1 and 5:1.

Further ratios of A:B which can be used according to the present invention are: 1:1 to 1:1000, 1:1 to 1:500, 1:1 to 1:250, 1:1 to 1:100, 1:1 to 1:95, 1:1 to 1:90, 1:1 to 1:85, 1:1 to 1:80, 1:1 to 1:75, 1:1 to 1:70, 1:1 to 1:65, 1:1 to 1:60, 1:1 to 1:55, 1:1 to 1:50, 1:1 to 1:45, 1:1 to 1:40, 1:1 to 1:35, 1:1 to 1:30, 1:1 to 1:25, 1:1 to 1:20, 1:1 to 1:15, 1:1 to 1:10, 1:1 to 1:5, 1:1 to 1:4, 1:1 to 1:3, 1:1 to 1:2.

If more than one, e.g. 2 or 3, compounds (B) are present, the weight ratio refers to the total amount of compound (B), i.e. to the sum of the amount of each compound (B) present in the combination. This applies mutatis mutandis if more than one, e.g. 2 or 3, compounds (A) are present.

If more than one, e.g. 2 or 3, compounds (B) are present in the combinations according to the invention the individual compounds (B) can be present in abroad range of effective weight ratio. If for example 2 compounds (B) are present, which are in the following referred to as compounds (B1) and (B2) the effective weight ratio of Bl:B2, can vary for example in a range of 100:1 to 1:100, preferably in a weight ratio of 50:1 to 1:50, most preferably in a weight ratio of 20:1 to 1:20. Further ratios of Bl:B2 which can be used according to the present invention with increasing preference in the order given are: 95:1 to 1:95, 90:1 to 1:90, 85:1 to 1:85, 80:1 to 1:80, 75:1 to 1:75, 70:1 to 1:70, 65:1 to 1:65, 60:1 to 1:60, 55:1 to 1:55, 50:1 to 1:50, 45:1 to 1:45, 40:1 to 1:40, 35:1 to 1:35,30:1 to 1:30,25:1 to 1:25, 15:1 to 1:15, 10:1 to 1:10,5:1 to 1:5,4:1 to 1:4,3:1 to 1:3,2:1 to 1:2.

Further ratios of Bl:B2 which can be used according to the present invention are: 95:1 to 1:1, 90:1 to 1:1, 85:1 to 1:1,80:1 to 1:1,75:1 to 1:1,70:1 to 1:1,65:1 to 1:1,60:1 to 1:1,55:1 to 1:1,50:1 to 1:1,45:1 to 1:1,40:1 to 1:1,35:1 to 1:1,30:1 to 1:1,25:1 to 1:1,20:1 to 1:1, 15:1 to 1:1, 10:1 to 1:1,5:1 to 1:1,4:1 to 1:1,3:1 to 1:1, 2:1 to 1:1.

Further ratios of B 1:B2 which can be used according to the present invention are: 1:1 to 1:95, 1:1 to 1:90, 1:1 to 1:85, 1:1 to 1:80, 1:1 to 1:75, 1:1 to 1:70, 1:1 to 1:65, 1:1 to 1:60, 1:1 to 1:55, 1:1 to 1:50, 1:1 to 1:45, 1:1 to 1:40,1:1 to 1:35, 1:1 to 1:30, 1:1 to 1:25, 1:1 to 1:20, 1:1 to 1:15, 1:1 to 1:10, 1:1 to 1:5, 1:1 to 1:4, 1:1 to 1:3, 1:1 to 1:2.

Any of the above ratios are preferably synergistic weight ratios. The skilled person is able to find out the synergistic weight ratios for the present invention by routine methods. The skilled person understands that these ratios refer to the ratio within a combined-formulation as well as to the calculative ratio of the one or more fatty acids or derivatives thereof described herein and the at least one agent active against at least one plant pathogen and/or active in plant growth promotion when both components are applied as mono-formulations to a plant to be treated. The skilled person can calculate this ratio by simple mathematics since the volume and the amount of the one or more fatty acids or derivatives thereof and the at least one agent active against at least one plant pathogen and/or active in plant growth promotion , respectively, in a mono-formulation is known to the skilled person.

Isomers

Depending on the nature of the substituents of compound (A) and the nature of compound (B), those compounds may be present in the compound combinations of the invention in the form of different stereoisomers. These stereoisomers are, for example, enantiomers, diastereomers, atropisomers or geometric isomers. Accordingly, the invention encompasses both pure stereoisomers and any mixture of these isomers. Where a compound can be present in two or more tautomer forms in equilibrium, reference to the compound by means of one tautomeric description is to be considered to include all tautomer forms. Where a compound can be present in isomeric forms and/or tautomeric forms, such a compound is understood hereinabove and hereinbelow also to include, where applicable, corresponding isomeric and/or tautomeric forms or mixtures thereof, even when these are not specifically mentioned in each case.

Salts/N-Oxides

The compounds present in the compound combination of the invention may independently of one another be present in the form of the free compound or, if applicable, an agrochemically active salt or N-oxide thereof.

Agrochemically active salts include acid addition salts of inorganic and organic acids well as salts of customary bases. Examples of inorganic acids are hydrohalic acids, such as hydrogen fluoride, hydrogen chloride, hydrogen bromide and hydrogen iodide, sulfuric acid, phosphoric acid and nitric acid, and acidic salts, such as sodium bisulfate and potassium bisulfate. Useful organic acids include, for example, formic acid, carbonic acid and alkanoic acids such as acetic acid, trifluoroacetic acid, trichloroacetic acid and propionic acid, and also glycolic acid, thiocyanic acid, lactic acid, succinic acid, citric acid, benzoic acid, cinnamic acid, oxalic acid, saturated or mono- or diunsaturated fatty acids having 6 to 20 carbon atoms, alkylsulphuric monoesters, alkylsulphonic acids (sulphonic acids having straight-chain or branched alkyl radicals having 1 to 20 carbon atoms), arylsulphonic acids or aryldisulphonic acids (aromatic radicals, such as phenyl and naphthyl, which bear one or two sulphonic acid groups), alkylphosphonic acids (phosphonic acids having straight-chain or branched alkyl radicals having 1 to 20 carbon atoms), arylphosphonic acids or aryldiphosphonic acids (aromatic radicals, such as phenyl and naphthyl, which bear one or two phosphonic acid radicals), where the alkyl and aryl radicals may bear further substituents, for example p-toluenesulphonic acid, salicylic acid, p-aminosalicylic acid, 2-phenoxybenzoic acid, 2-acetoxybenzoic acid.

N-oxides of compounds present in the compound combination of the invention or intermediates thereof can be obtained in a simple manner by customary processes, for example by N-oxidation with hydrogen peroxide (H₂O), peracids, for example peroxy sulfuric acid or peroxy carboxylic acids, such as meta-chloroperoxybenzoic acid or peroxymonosulfuric acid (Caro's acid).

E.g. the corresponding N-oxides may be prepared starting from the respective compounds using conventional oxidation methods, e.g. by treating the compounds with an organic peracid such as metachloroperbenzoic acid (e.g. WO-A 2003/64572 or J. Med. Chem. 38 (11), 1892-1903, 1995); or with inorganic oxidizing agents such as hydrogen peroxide (e.g. J. Heterocyc. Chem. 18 (7), 1305-1308, 1981) or oxone (e.g. J. Am. Chem. Soc. 123 (25), 5962-5973, 2001). The oxidation may lead to pure mono-N-oxides or to a mixture of different N-oxides, which can be separated by conventional methods such as chromatography.

Crystalline Form

The compounds present in the compound combinations of the invention may exist in multiple crystalline and/or amorphous forms. Crystalline forms include unsolvated crystalline forms, solvates and hydrates, in each case of the individual compounds or adducts thereof.

Solvates of the compounds present in the compound combinations of the invention or their salts are stoichiometric compositions of the compounds with solvents.

Compositions/Formulations

The present invention further relates to compositions for controlling unwanted microorganisms, comprising the compound combination according to the invention. The compositions may be applied to the microorganisms and/or in their habitat.

The composition comprises the compound combination of the invention and at least one agriculturally suitable auxiliary, e.g. carrier(s) and/or surfactant(s). In some cases, the composition may be composed of two ready-made formulations.

A carrier is a solid or liquid, natural or synthetic, organic or inorganic substance that is generally inert. The carrier generally improves the application of the compounds, for instance, to plants, plants parts or seeds. Examples of suitable solid carriers include, but are not limited to, ammonium salts, in particular ammonium sulfates, ammonium phosphates and ammonium nitrates, natural rock flours, such as kaolins, clays, talc, chalk, quartz, attapulgite, montmorillonite and diatomaceous earth, silica gel and synthetic rock flours, such as finely divided silica, alumina and silicates. Examples of typically useful solid carriers for preparing granules include, but are not limited to crushed and fractionated natural rocks such as calcite, marble, pumice, sepiolite and dolomite, synthetic granules of inorganic and organic flours and granules of organic material such as paper, sawdust, coconut shells, maize cobs and tobacco stalks. Examples of suitable liquid carriers include, but are not limited to, water, organic solvents and combinations thereof. Examples of suitable solvents include polar and nonpolar organic chemical liquids, for example from the classes of aromatic and nonaromatic hydrocarbons (such as cyclohexane, paraffins, alkylbenzenes, xylene, toluene, tetrahydronaphthalene, alkylnaphthalenes, chlorinated aromatics or chlorinated aliphatic hydrocarbons such as chlorobenzenes, chloroethylenes or methylene chloride), alcohols and polyols (which may optionally also be substituted, etherified and/or esterified, such as ethanol, propanol, butanol, benzylalcohol, cyclohexanol or glycol), ketones (such as acetone, methyl ethyl ketone, methyl isobutyl ketone or cyclohexanone), esters (including fats and oils) and (poly)ethers, unsubstituted and substituted amines, amides (such as dimethylformamide or fatty acid amides) and esters thereof, lactams (such as N-alkylpyrrolidones, in particular N-methylpyrrolidone) and lactones, sulfones and sulfoxides (such as dimethyl sulfoxide), oils of vegetable or animal origin. The carrier may also be a liquefied gaseous extender, i.e. liquid which is gaseous at standard temperature and under standard pressure, for example aerosol propellants such as halohydrocarbons, butane, propane, nitrogen and carbon dioxide.

Preferred solid carriers are selected from clays, talc and silica.

Preferred liquid carriers are selected from water, fatty acid amides and esters thereof, aromatic and nonaromatic hydrocarbons, lactams and carbonic acid esters. It is preferred, in particular in cases where component b) is present as a composition, that the carrier is water, optionally in combination with a polyol.

The amount of carrier typically ranges from 1 to 99.99%, preferably from 5 to 99.9%, more preferably from 10 to 99.5%, and most preferably from 20 to 99% by weight of the composition.

Liquid carriers are typically present in a range of from 20 to 90%, for example 30 to 80% by weight of the composition.

Solid carriers are typically present in a range of from 0 to 50%, preferably 5 to 45%, for example 10 to 30% by weight of the composition.

If the composition comprises two or more carriers, the outlined ranges refer to the total amount of carriers.

The surfactant can be an ionic (cationic or anionic), amphoteric or non-ionic surfactant, such as ionic or non-ionic emulsifier(s), foam former(s), dispersant(s), wetting agent(s), penetration enhancer(s) and any mixtures thereof Examples of suitable surfactants include, but are not limited to, salts of polyacrylic acid, salts of lignosulfonic acid (such as sodium lignosulfonate), salts of phenolsulfonic acid or naphthalenesulfonic acid, polycondensates of ethylene oxide and/or propylene oxide with fatty alcohols, fatty acids or fatty amines (for example, polyoxyethylene fatty acid esters such as castor oil ethoxylate or polyoxyehtylene sorbitan monooleate, polyoxyethylene fatty alcohol ethers, for example alkylaryl polyglycol ethers), substituted phenols (preferably alkylphenols or arylphenols) and ethoxylates thereof (such as tristyrylphenol ethoxylate), salts of sulfosuccinic esters, taurine derivatives (preferably alkyl taurates), phosphoric esters of polyethoxylated alcohols or phenols, fatty esters of polyols (such a fatty acid esters of glycerol, sorbitol or sucrose), sulfates (such as alkyl sulfates and alkyl ether sulfates), sulfonates (for example, alkylsulfonates, arylsulfonates and alkylbenzene sulfonates), phosphate esters, protein hydrolysates, lignosulfite waste liquors and methylcellulose. Any reference to salts in this paragraph refers preferably to the respective alkali, alkaline earth and ammonium salts.

Preferred surfactants are selected from polyoxyethylene fatty alcohol ethers, polyoxyethylene fatty acid esters, such as castor oil ethoxylate or polyoxyehtylene sorbitan monooleate, alkylbenzene sulfonates, such as calcium dodecylbenzenesulfonate, sodium lignosulfonate and arylphenol ethoxylates, such as tristyrylphenol ethoxylate.

The amount of surfactants typically ranges from 5 to 40%, for example 10 to 20%, by weight of the composition.

Further examples of suitable auxiliaries include water repellents, siccatives, binders (adhesive, tackifier, fixing agent, such as carboxymethylcellulose, natural and synthetic polymers in the form of powders, granules or latices, such as gum arabic, polyvinyl alcohol and polyvinyl acetate, natural phospholipids such as cephalins and lecithins and synthetic phospholipids, polyvinylpyrrolidone and tylose), thickeners and secondary thickeners (such as cellulose ethers, acrylic acid derivatives, xanthan gum, modified clays, e.g. the products available under the name Bentone, and finely divided silica), stabilizers (e.g. cold stabilizers, preservatives (e.g. dichlorophen and benzyl alcohol hemiformal), antioxidants, light stabilizers, in particular UV stabilizers, or other agents which improve chemical and/or physical stability), dyes or pigments (such as inorganic pigments, e.g. iron oxide, titanium oxide and Prussian Blue; organic dyes, e.g. alizarin, azo and metal phthalocyanine dyes), antifoams (e.g. silicone antifoams and magnesium stearate), antifreezes, stickers, gibberellins and processing auxiliaries, mineral and vegetable oils, perfumes, waxes, nutrients (including trace nutrients, such as salts of iron, manganese, boron, copper, cobalt, molybdenum and zinc), protective colloids, thixotropic substances, penetrants, sequestering agents and complex formers.

The choice of the auxiliaries depends on the intended mode of application of the compound combination of the invention and/or on the physical properties of the active compound(s) present in said compound combination. Furthermore, the auxiliaries may be chosen to impart particular properties (technical, physical and/or biological properties) to the compositions or use forms prepared therefrom. The choice of auxiliaries may allow customizing the compositions to specific needs.

The composition of the invention may be provided to the end user as ready-for-use formulation, i.e. the compositions may be directly applied to the plants or seeds by a suitable device, such as a spraying or dusting device. Alternatively, the compositions may be provided to the end user in the form of concentrates which have to be diluted, preferably with water, prior to use.

The composition of the invention can be prepared in conventional manners, for example by mixing the compound combination of the invention with one or more suitable auxiliaries, such as disclosed herein above.

The composition comprises a fungicidally effective amount of a compound combination of the invention. The term “effective amount” denotes an amount, which is sufficient for controlling harmful fungi on cultivated plants or in the protection of materials and which does not result in a substantial damage to the treated plants. Such an amount can vary in a broad range and is dependent on various factors, such as the fungal species to be controlled, the treated cultivated plant or material, the climatic conditions and the specific compound combination of the invention used. Usually, the composition according to the invention contains from 0.01 to 99% by weight, preferably from 0.05 to 98% by weight, more preferred from 0.1 to 95% by weight, even more preferably from 0.5 to 90% by weight, most preferably from 1 to 80% by weight of the compound combination of the invention.

The composition of the invention may be in any customary composition type, such as solutions (e.g aqueous solutions), emulsions, water- and oil-based suspensions, powders (e.g. wettable powders, soluble powders), dusts, pastes, granules (e.g. soluble granules, granules for broadcasting), suspoemulsion concentrates, natural or synthetic products impregnated with the compound combination of the invention, fertilizers and also microencapsulations in polymeric substances. The compound combination of the invention may be present in a suspended, emulsified or dissolved form. Examples of particular suitable composition types are solutions, watersoluble concentrates (e.g. SL, LS), dispersible concentrates (DC), suspensions and suspension concentrates (e.g. SC, OD, OF, FS), emulsifiable concentrates (e.g. EC), emulsions (e.g. EW, EO, ES, ME, SE), capsules (e.g. CS, ZC), pastes, pastilles, wettable powders or dusts (e.g. WP, SP, WS, DP, DS), pressings (e.g. BR, TB, DT), granules (e.g. WG, SG, GR, FG, GG, MG), insecticidal articles (e.g. LN), as well as gel formulations for the treatment of plant propagation materials such as seeds (e.g. GW, GF).

These and further compositions types are defined by the Food and Agriculture Organization of the United Nations (FAO). An overview is given in the “Catalogue of pesticide formulation types and international coding system”, Technical Monograph No. 2, 6th Ed. May 2008, Croplife International.

Preferably, the composition of the invention is in form of one of the following types: EC, SC, FS, SE, OD and WG, more preferred EC, SC, OD and WG.

Further details about examples of composition types and their preparation are given below. The outlined amount of compound combination of the invention refers to the total amount of compounds (A) and (B) present in the compound combination of the present invention. If two or more representatives of any further component of the composition, e.g. wetting agent, binder, are present, the outlined amounts of the respective component refers to the total amount of all representatives of said component, e.g. all wetting agents, all binders, all solvents and so on.

i) Water-soluble concentrates (SL, LS)

10-60% by weight of the compound combination of the invention and 5-15% by weight surfactant (e.g. polyoxyethylene fatty alcohol ether) are dissolved in such amount of water and/or water-soluble solvent (e.g. alcohols such as propylene glycol or carbonates such as propylene carbonate) to result in a total amount of 100% by weight. Before application the concentrate is diluted with water.

ii) Dispersible concentrates (DC)

5-25% by weight of the compound combination of the invention and 1-10% by weight surfactant and/or binder (e.g. polyvinylpyrrolidone) are dissolved in such amount of organic solvent (e.g. cyclohexanone) to result in a total amount of 100% by weight. Dilution with water gives a dispersion.

iii) Emulsifiable concentrates (EC)

15-70% by weight of the compound combination of the invention and 5-10% by weight surfactant (e.g. a mixture of calcium dodecylbenzenesulfonate and castor oil ethoxylate) are dissolved in such amount of water-insoluble organic solvent (e.g. aromatic hydrocarbon or fatty acid amide) and if needed additional water-soluble solvent to result in a total amount of 100% by weight. Dilution with water gives an emulsion.

iv) Emulsions (EW, EO, ES)

5-40% by weight of the compound combination of the invention and 1-10% by weight surfactant (e.g. a mixture of calcium dodecylbenzenesulfonate and castor oil ethoxylate) are dissolved in 20-40% by weight water-insoluble organic solvent (e.g. aromatic hydrocarbon). This mixture is added to such amount of water by means of an emulsifying machine to result in a total amount of 100% by weight. The resulting composition is a homogeneous emulsion. Before application the emulsion may be further diluted with water.

v) Suspensions and suspension concentrates

v-1) Water-based (SC, FS)

In a suitable grinding equipment, e.g. an agitated ball mill, 20-60% by weight ofthe compound combination of the invention are comminuted with addition of 2-10% by weight surfactant (e.g. sodium lignosulfonate and polyoxyethylene fatty alcohol ether), 0.1-2% by weight thickener (e.g. xanthan gum) and water to give a fine active substance suspension. Water is added in such amount to result in a total amount of 100% by weight. Dilution with water gives a stable suspension of the active substances. For FS type compositions up to 40% by weight binder (e.g. polyvinylalcohol) is added.

v-2) Oil-based (OD, OF)

In a suitable grinding equipment, e.g. an agitated ball mill, 20-60% by weight ofthe compound combination of the invention are comminuted with addition of 2-10% by weight surfactant (e.g. sodium lignosulfonate and polyoxyethylene fatty alcohol ether), 0.1-2% by weight thickener (e.g. modified clay, in particular Bentone, or silica) and an organic carrier to give a fine active substance oil suspension. The organic carrier is added in such amount to result in a total amount of 100% by weight. Dilution with water gives a stable dispersion of the active substances.

vi) Water-dispersible granules and water-soluble granules (WG, SG)

50-80% by weight of the compound combination of the invention are ground finely with addition of surfactant (e.g. sodium lignosulfonate and polyoxyethylene fatty alcohol ether) and converted to water-dispersible or water-soluble granules by means of technical appliances (e. g. extrusion, spray tower, fluidized bed). The surfactant is used in such amount to result in a total amount of 100% by weight. Dilution with water gives a stable dispersion or solution of the active substances.

vii) Water-dispersible powders and water-soluble powders (WP, SP, WS)

50-80% by weight of the compound combination of the invention are ground in a suitable mill, preferably a rotor-stator mill, with addition of 1-8% by weight surfactant (e.g. sodium lignosulfonate, polyoxyethylene fatty alcohol ether) and such amount of solid carrier, e.g. silica gel, to result in a total amount of 100% by weight. Dilution with water gives a stable dispersion or solution of the active substances.

viii) Gel (GW, GF)

In a suitable mill, e.g. an agitated ball mill, 5-25% by weight of the compound combination of the invention are comminuted with addition of 3-10% by weight surfactant (e.g. sodium lignosulfonate), 1-5% by weight binder (e.g. carboxymethylcellulose) and such amount of water to result in a total amount of 100% by weight. This results in a fine suspension of the active substance. Dilution with water gives a stable suspension of the active substances.

ix) Microemulsion (ME)

5-20% by weight of the compound combination of the invention are added to 5-30% by weight organic solvent blend (e.g. fatty acid dimethylamide and cyclohexanone), 10-25% by weight surfactant blend (e.g. polyoxyethylene fatty alcohol ether and arylphenol ethoxylate), and such amount of water to result in a total amount of 100% by weight. This mixture is stirred for 1 h to produce spontaneously a thermodynamically stable microemulsion.

x) Microcapsules (CS)

An oil phase comprising 5-50% by weight of the compound combination of the invention, 0-40% by weight water-insoluble organic solvent (e.g. aromatic hydrocarbon), 2-15% by weight acrylic monomers (e.g.

methylmethacrylate, methacrylic acid and a di- or triacrylate) are dispersed into an aqueous solution of a protective colloid (e.g. polyvinyl alcohol). Radical polymerization initiated by a radical initiator results in the formation of poly(meth)acrylate microcapsules. Alternatively, an oil phase comprising 5-50% by weight of the compound combination of the invention, 0-40% by weight water-insoluble organic solvent (e.g. aromatic hydrocarbon), and an isocyanate monomer (e.g. diphenylmethene-4,4′-diisocyanatae) are dispersed into an aqueous solution of a protective colloid (e.g. polyvinyl alcohol). The addition of a polyamine (e.g. hexamethylenediamine) results in the formation of polyurea microcapsules. The monomers amount to 1-10% by weight of the total CS composition.

xi) Dustable powders (DP, DS)

1-10% by weight of the compound combination of the invention are ground finely and mixed intimately with such amount of solid carrier, e.g. finely divided kaolin, to result in a total amount of 100% by weight.

xii) Granules (GR, FG)

0.5-30% by weight of the compound combination of the invention are ground finely and associated with such amount of solid carrier (e.g. silicate) to result in a total amount of 100% by weight. Granulation is achieved by extrusion, spray-drying or the fluidized bed.

xiii) Ultra-low volume liquids (UL)

1-50% by weight of the compound combination of the invention are dissolved in such amount of organic solvent, e.g. aromatic hydrocarbon, to result in a total amount of 100% by weight.

The compositions types i) to xiii) may optionally comprise further auxiliaries, such as 0.1-1% by weight preservatives, 0.1-1% by weight antifoams, 0.1-1% by weight dyes and/or pigments, and 5-10% by weight antifreezes.

Further active ingredients

Compound combinations according to the invention can be used as such or in compositions/formulations thereof and can be mixed with further known active ingredients, for example biological control agents, bactericides, acaricides, nematicides or insecticides, in order thus to broaden, for example, the activity spectrum or to prevent development of resistance.

A mixture with other known active ingredients, such as herbicides, fertilizers, growth regulators, safeners, nitrification inhibitors, semiochemicals and/or other agriculturally beneficial agents is also possible.

“Insecticides” as well as the term “insecticidal” refers to the ability of a substance to increase mortality or inhibit growth rate of insects. As used herein, the term “insects” comprises all organisms in the class “Insecta”.

“Nematicide” and “nematicidal” refers to the ability of a substance to increase mortality or inhibit the growth rate of nematodes. In general, the term “nematode” comprises eggs, larvae, juvenile and mature forms of said organism.

“Acaricide” and “acaricidal” refers to the ability of a substance to increase mortality or inhibit growth rate of ectoparasites belonging to the class Arachnida, sub-class Acari.

The compound combination of the invention may be combined with one or more agriculturally beneficial agents.

Examples of agriculturally beneficial agents include biostimulants, plant growth regulators, plant signal molecules, growth enhancers, microbial stimulating molecules, biomolecules, soil amendments, nutrients, plant nutrient enhancers, etc., such as lipo-chitooligosaccharides (LCO), chitooligosaccharides (CO), chitinous compounds, flavonoids, jasmonic acid or derivatives thereof (e.g., jasmonates), cytokinins, auxins, gibberellins, absiscic acid, ethylene, brassinosteroids, salicylates, macro- and micro-nutrients, linoleic acid or derivatives thereof, linolenic acid or derivatives thereof, karrikins, and beneficial microorganisms (e.g., Rhizobium spp., Bradyrhizobium spp., Sinorhizobium spp., Azorhizobium spp., Glomus spp., Gigaspora spp., Hymenoscyphous spp., Oidiodendron spp., Laccaria spp., Piso/ithits spp., Rhizopogon spp., Scleroderma spp., Rhizoctonia spp., Acinetobacter spp., Arthrobacter spp., Arthrobotrys spp., Aspergillus spp., Azospirillum spp., Bacillus spp., Burkholderia spp., Candida spp., Chryseomonas spp., Enterobacter spp., Eupenicillium spp., Exiguobacterium spp., Klebsiella spp., Kluyvera spp., Microbacterium spp., Mucor spp., Paecilomyces spp., Paenibacillus spp., Penicillium spp., Pseudomonas spp., Serratia spp., Stenotrophomonas spp., Streptomyces spp., Streptosporangium spp., Swaminathania spp., Thiobacillus spp., Torulospora spp., Vibrio spp., Xanthobacter spp., Xanthomonas spp., etc.), and combinations thereof.

Methods and uses

The compound combination and the composition of the invention have potent microbicidal activity and/or plant defense modulating potential. They can be used for controlling unwanted microorganisms, such as unwanted fungi and bacteria, on plants. They can be particularly useful in crop protection (they control microorganisms that cause plants diseases) or for protecting materials (e.g. industrial materials, timber, storage goods) as described in more details herein below. More specifically, compound combination and the composition of the invention can be used to protect seeds, germinating seeds, emerged seedlings, plants, plant parts, fruits, harvest goods and/or the soil in which the plants grow from unwanted microorganisms.

Control or controlling as used herein encompasses protective, curative and eradicative treatment ofunwanted microorganisms. Unwanted microorganisms may be pathogenic bacteria, pathogenic virus, pathogenic oomycetes or pathogenic fungi, more specifically phytopathogenic bacteria, phytopathogenic virus, phytopathogenic oomycetes or phytopathogenic fungi. As detailed herein below, these phytopathogenic microorganims are the causal agents of a broad spectrum of plants diseases.

More specifically, the compound combination and the composition of the invention can be used as fungicides. For the purpose of the specification, the term “fungicide” refers to a compound or composition that can be used in crop protection for the control of unwanted fungi, such as Plasmodiophoromycetes, Chytridiomycetes, Zygomycetes, Ascomycetes, Basidiomycetes and Deuteromycetes and/or for the control of Oomycetes.

The compound combination and the composition of the invention may also be used as antibacterial agent. In particular, they may be used in crop protection, for example for the control of unwanted bacteria, such as Pseudomonadaceae, Rhizobiaceae, Xanthomonadaceae, Enterobacteriaceae, Corynebacteriaceae and Streptomycetaceae.

The present invention also relates to a method for controlling unwanted microorganisms, such as unwanted fungi, oomycetes and bacteria, on plants comprising the step of applying the compound combination or the composition of the invention to the microorganisms and/or their habitat (to the plants, plant parts, seeds, fruits or to the soil in which the plants grow), wherein the compounds (A) and (B) may be applied in a simultaneous, separate or sequential manner. If the single compounds are applied in a sequential manner, i.e. at different times, they are applied one after the other within a reasonably short period, such as a few hours or days.

The present invention furthermore relates to a method for reducing overall damage of plants and plant parts as well as losses in harvested fruits or vegetables caused by phytopathogens comprising the step of simultaneously or sequentially applying one or more fatty acids or derivatives thereof as defined herein and at least one further agent active against at least one plant pathogen and/or active in plant growth promotion as defined herein to a plant or seed or a locus where said plant or seed is intended to be grown.

In another aspect, the present invention relates to a method for increasing crop yield and/or the quality of food commodities comprising the step of simultaneously or sequentially applying one or more fatty acids or derivatives thereof as defined herein and at least one further agent active against at least one plant pathogen and/or active in plant growth promotion biological control agent as defined herein to a plant or seed or a locus where said plant or seed is intended to be grown.

Said applying is preferably effected as a foliar or soil application or as a seed treatment as described elsewhere in more detail.

Typically, when the compound combination and the composition of the invention are used in curative or protective methods for controlling phytopathogenic fungi and/or phytopathogenic oomycetes, an effective and plant-compatible amount thereof is applied to the plants, plant parts, fruits, seeds or to the soil or substrates in which the plants grow. Suitable substrates that may be used for cultivating plants include inorganic based substrates, such as mineral wool, in particular stone wool, perlite, sand or gravel; organic substrates, such as peat, pine bark or sawdust; and petroleum based substrates such as polymeric foams or plastic beads. Effective and plant-compatible amount means an amount that is sufficient to control or destroy the fungi present or liable to appear on the cropland and that does not entail any appreciable symptom of phytotoxicity for said crops. Such an amount can vary within a wide range depending on the fungus to be controlled, the type of crop, the crop growth stage, the climatic conditions and the respective compound or composition of the invention used. This amount can be determined by systematic field trials that are within the capabilities of a person skilled in the art.

The invention furthermore relates to a kit-of-parts comprising a biological control agent selected from the group consisting of one or more fatty acids or derivatives thereof as defined herein and at least one further agent active against at least one plant pathogen and/or active in plant growth promotion as defined herein in a spatially separated arrangement

Plants and plant parts

The compound combination and the composition of the invention may be applied to any plants or plant parts.

Plants mean all plants and plant populations, such as desired and undesired wild plants or crop plants (including naturally occurring crop plants). Crop plants may be plants which can be obtained by conventional breeding and optimization methods or by biotechnological and genetic engineering methods or combinations of these methods, including the genetically modified plants (GMO or transgenic plants) and the plant cultivars which are protectable and non-protectable by plant breeders' rights.

Plant cultivars are understood to mean plants which have new properties (“traits”) and have been obtained by conventional breeding, by mutagenesis or by recombinant DNA techniques. They can be cultivars, varieties, bio- or genotypes.

Plant parts are understood to mean all parts and organs of plants above and below the ground, such as shoots, leaves, needles, stalks, stems, flowers, fruit bodies, fruits, seeds, roots, tubers and rhizomes. The plant parts also include harvested material and vegetative and generative propagation material, for example cuttings, tubers, rhizomes, slips and seeds.

Plants which may be treated in accordance with the methods of the invention include the following: cotton, flax, grapevine, fruit, vegetables, such as Rosaceae sp. (for example pome fruits such as apples and pears, but also stone fruits such as apricots, cherries, almonds and peaches, and soft fruits such as strawberries), Ribesioidae sp., Juglandaceae sp., Betulaceae sp., Anacardiaceae sp., Fagaceae sp., Moraceae sp., Oleaceae sp., Actinidaceae sp., Lauraceae sp., Musaceae sp. (for example banana trees and plantations), Rubiaceae sp. (for example coffee), Theaceae sp., Sterculiceae sp., Rutaceae sp. (for example lemons, oranges and grapefruit); Solanaceae sp. (for example tomatoes), Liliaceae sp., Asteraceae sp. (for example lettuce), Umbelliferae sp., Cruciferae sp., Chenopodiaceae sp., Cucurbitaceae sp. (for example cucumber), Alliaceae sp. (for example leek, onion), Papilionaceae sp. (for example peas); major crop plants, such as Gramineae sp. (for example maize, turf, cereals such as wheat, rye, rice, barley, oats, millet and triticale), Asteraceae sp. (for example sunflower), Brassicaceae sp. (for example white cabbage, red cabbage, broccoli, cauliflower, Brussels sprouts, pak Choi, kohlrabi, radishes, and oilseed rape, mustard, horseradish and cress), Fabacae sp. (for example bean, peanuts), Papilionaceae sp. (for example soya bean), Solanaceae sp. (for example potatoes), Chenopodiaceae sp. (for example sugar beet, fodder beet, swiss chard, beetroot); useful plants and ornamental plants for gardens and wooded areas; and genetically modified varieties of each of these plants.

Plants and plant cultivars which may be treated by the above disclosed methods include plants and plant cultivars which are resistant against one or more biotic stresses, i.e. said plants show a better defense against animal and microbial pests, such as against nematodes, insects, mites, phytopathogenic fungi, bacteria, viruses and/or viroids.

Plants and plant cultivars which may be treated by the above disclosed methods include those plants which are resistant to one or more abiotic stresses. Abiotic stress conditions may include, for example, drought, cold temperature exposure, heat exposure, osmotic stress, flooding, increased soil salinity, increased mineral exposure, ozone exposure, high light exposure, limited availability of nitrogen nutrients, limited availability of phosphorus nutrients, shade avoidance.

Plants and plant cultivars which may be treated by the above disclosed methods include those plants characterized by enhanced yield characteristics. Increased yield in said plants may be the result of, for example, improved plant physiology, growth and development, such as water use efficiency, water retention efficiency, improved nitrogen use, enhanced carbon assimilation, improved photosynthesis, increased germination efficiency and accelerated maturation. Yield may furthermore be affected by improved plant architecture (under stress and non-stress conditions), including but not limited to, early flowering, flowering control for hybrid seed production, seedling vigor, plant size, internode number and distance, root growth, seed size, fruit size, pod size, pod or ear number, seed number per pod or ear, seed mass, enhanced seed filling, reduced seed dispersal, reduced pod dehiscence and lodging resistance. Further yield traits include seed composition, such as carbohydrate content and composition for example cotton or starch, protein content, oil content and composition, nutritional value, reduction in anti-nutritional compounds, improved processability and better storage stability.

Plants and plant cultivars which may be treated by the above disclosed methods include plants and plant cultivars which are hybrid plants that already express the characteristic of heterosis or hybrid vigor which results in generally higher yield, vigor, health and resistance towards biotic and abiotic stresses.

Transgenic plants, seed treatment and integration events

The compound combination according to the invention can be advantageously used to treat transgenic plants, plant cultivars or plant parts that received genetic material which imparts advantageous and/or useful properties (traits) to these plants, plant cultivars or plant parts. Therefore, it is contemplated that the present invention may be combined with one or more recombinant traits or transgenic event(s) or a combination thereof. For the purposes of this application, a transgenic event is created by the insertion of a specific recombinant DNA molecule into a specific position (locus) within the chromosome of the plant genome. The insertion creates a novel DNA sequence referred to as an “event” and is characterized by the inserted recombinant DNA molecule and some amount of genomic DNA immediately adjacent to/flanking both ends of the inserted DNA. Such trait(s) or transgenic event(s) include, but are not limited to, pest resistance, water use efficiency, yield performance, drought tolerance, seed quality, improved nutritional quality, hybrid seed production, and herbicide tolerance, in which the trait is measured with respect to a plant lacking such trait or transgenic event. Concrete examples of such advantageous and/or useful properties (traits) are better plant growth, vigor, stress tolerance, standability, lodging resistance, nutrient uptake, plant nutrition, and/or yield, in particular improved growth, increased tolerance to high or low temperatures, increased tolerance to drought or to levels of water or soil salinity, enhanced flowering performance, easier harvesting, accelerated ripening, higher yields, higher quality and/or a higher nutritional value of the harvested products, better storage life and/or processability of the harvested products, and increased resistance against animal and microbial pests, such as against insects, arachnids, nematodes, mites, slugs and snails.

Among DNA sequences encoding proteins which confer properties of tolerance to such animal and microbial pests, in particular insects, mention will particularly be made of the genetic material from Bacillus thuringiensis encoding the Bt proteins widely described in the literature and well known to those skilled in the art. Mention will also be made of proteins extracted from bacteria such as Photorhabdus (WO97/17432 and WO98/08932). In particular, mention will be made of the Bt Cry or VIP proteins which include the CrylA, CryIAb, CryIAc, CryIIA, CryIIIA, CryIIIB2, Cry9c Cry2Ab, Cry3Bb and CryIF proteins or toxic fragments thereof and also hybrids or combinations thereof, especially the CrylF protein or hybrids derived from a CrylF protein (e.g. hybrid CrylA-CrylF proteins or toxic fragments thereof), the CrylA-type proteins or toxic fragments thereof, preferably the CrylAc protein or hybrids derived from the CrylAc protein (e.g. hybrid CrylAb-CrylAc proteins) or the CrylAb or Bt2 protein or toxic fragments thereof, the Cry2Ae, Cry2Af or Cry2Ag proteins or toxic fragments thereof, the CrylA.105 protein or a toxic fragment thereof, the VIP3Aa19 protein, the VIP3Aa20 protein, the VIP3A proteins produced in the COT202 or COT203 cotton events, the VIP3Aa protein or a toxic fragment thereof as described in Estruch et al. (1996), Proc Natl Acad Sci US A. 28;93(11):5389-94, the Cry proteins as described in WO2001/47952, the insecticidal proteins from Xenorhabdus (as described in WO98/50427), Serratia (particularly from S. entomophila) or Photorhabdus species strains, such as Tc-proteins from Photorhabdus as described in WO98/08932. Also any variants or mutants of any one of these proteins differing in some amino acids (1-10, preferably 1-5) from any of the above named sequences, particularly the sequence of their toxic fragment, or which are fused to a transit peptide, such as a plastid transit peptide, or another protein or peptide, is included herein.

Another and particularly emphasized example of such properties is conferred tolerance to one or more herbicides, for example imidazolinones, sulphonylureas, glyphosate or phosphinothricin. Among DNA sequences encoding proteins which confer properties of tolerance to certain herbicides on the transformed plant cells and plants, mention will be particularly be made to the bar or PAT gene or the Streptomyces coelicolor gene described in WO2009/152359 which confers tolerance to glufosinate herbicides, a gene encoding a suitable EPSPS (5-Enolpyruvylshikimat-3-phosphat-synthase) which confers tolerance to herbicides having EPSPS as a target, especially herbicides such as glyphosate and its salts, a gene encoding glyphosate-n-acetyltransferase, or a gene encoding glyphosate oxidoreductase. Further suitable herbicide tolerance traits include at least one ALS (acetolactate synthase) inhibitor (e.g. WO2007/024782), a mutated Arabidopsis ALS/AHAS gene (e.g. U.S. Pat. No. 6,855,533), genes encoding 2,4-D-monooxygenases conferring tolerance to 2,4-D (2,4- dichlorophenoxyacetic acid) and genes encoding Dicamba monooxygenases conferring tolerance to dicamba (3,6-dichloro-2- methoxybenzoic acid).

Yet another example of such properties is resistance to one or more phytopathogenic fungi, for example Asian Soybean Rust. Among DNA sequences encoding proteins which confer properties of resistance to such diseases, mention will particularly be made of the genetic material from glycine tomentella, for example from any one of publically available accession lines PI441001 , PI483224, PI583970, PI446958, PI499939, PI505220, PI499933, PI441008, PI505256 or PI446961 as described in WO2019/103918.

Further and particularly emphasized examples of such properties are increased resistance against bacteria and/or viruses owing, for example, to systemic acquired resistance (SAR), systemin, phytoalexins, elicitors and also resistance genes and correspondingly expressed proteins and toxins.

Particularly useful transgenic events in transgenic plants or plant cultivars which can be treated with preference in accordance with the invention include Event 531/ PV-GHBK04 (cotton, insect control, described in WO2002/040677), Event 1143-14A (cotton, insect control, not deposited, described in WO2006/128569); Event 1143-51B (cotton, insect control, not deposited, described in WO2006/128570); Event 1445 (cotton, herbicide tolerance, not deposited, described in US-A 2002-120964 or WO2002/034946); Event 17053 (rice, herbicide tolerance, deposited as PTA-9843, described in WO2010/117737); Event 17314 (rice, herbicide tolerance, deposited as PTA-9844, described in WO2010/117735); Event 281-24-236 (cotton, insect control - herbicide tolerance, deposited as PTA-6233, described in WO2005/103266 or US-A 2005-216969); Event 3006-210-23 (cotton, insect control - herbicide tolerance, deposited as PTA-6233, described in US-A 2007-143876 orWO2005/103266); Event 3272 (corn, quality trait, deposited as PTA-9972, described in WO2006/098952 or US-A 2006-230473); Event 33391 (wheat, herbicide tolerance, deposited as PTA-2347, described in WO2002/027004), Event 40416 (corn, insect control - herbicide tolerance, deposited as ATCC PTA-11508, described in WO 11/075593); Event 43A47 (corn, insect control-herbicide tolerance, deposited as ATCC PTA-11509, described in WO2011/075595); Event 5307 (corn, insect control, deposited as ATCC PTA-9561, described in WO2010/077816); Event ASR-368 (bent grass, herbicide tolerance, deposited as ATCC PTA-4816, described in US-A 2006-162007 or WO2004/053062); Event B16 (corn, herbicide tolerance, not deposited, described in US-A 2003-126634); Event BPS-CV127-9 (soybean, herbicide tolerance, deposited as NCIMB No. 41603, described in WO2010/080829); Event BLR1 (oilseed rape, restoration of male sterility, deposited as NCIMB 41193, described in WO2005/074671), Event CE43-67B (cotton, insect control, deposited as DSM ACC2724, described in US-A 2009-217423 or WO2006/128573); Event CE44-69D (cotton, insect control, not deposited, described in US-A 2010-0024077); Event CE44-69D (cotton, insect control, not deposited, described in WO2006/128571); Event CE46-02A (cotton, insect control, not deposited, described in WO2006/128572); Event COT102 (cotton, insect control, not deposited, described in US-A 2006-130175 or WO2004/039986); Event C0T202 (cotton, insect control, not deposited, described in US-A 2007-067868 or WO2005/054479); Event C0T203 (cotton, insect control, not deposited, described in WO2005/054480);); Event DAS21606-3/1606 (soybean, herbicide tolerance, deposited as PTA-11028, described in WO2012/033794), Event DAS40278 (corn, herbicide tolerance, deposited as ATCC PTA-10244, described in WO2011/022469); Event DAS-44406-6/pDAB8264.44.06.1 (soybean, herbicide tolerance, deposited as PTA-11336, described in WO2012/075426), Event DAS-14536-7/pDAB8291.45.36.2 (soybean, herbicide tolerance, deposited as PTA-11335, described in WO2012/075429), Event DAS-59122-7 (corn, insectcontrol - herbicide tolerance, deposited as ATCC PTA 11384, described in US-A 2006-070139); Event DAS-59132 (corn, insect control - herbicide tolerance, not deposited, described in WO2009/100188); Event DAS68416 (soybean, herbicide tolerance, deposited as ATCC PTA-10442, described in WO2011/066384 or WO2011/066360); Event DP-098140-6 (corn, herbicide tolerance, deposited as ATCC PTA-8296, described in US-A 2009-137395 orWO 08/112019); Event DP-305423-1 (soybean, quality trait, not deposited, described in US-A 2008-312082 or WO2008/054747); Event DP-32138-1 (corn, hybridization system, deposited as ATCC PTA-9158, described in US-A 2009-0210970 or WO2009/103049); Event DP-356043-5 (soybean, herbicide tolerance, deposited as ATCC PTA-8287, described in US-A 2010-0184079 or WO2008/002872); Event EE-I (brinjal, insect control, not deposited, described in WO 07/091277); Event Fil 17 (corn, herbicide tolerance, deposited as ATCC 209031, described in US-A 2006-059581 or WO 98/044140); Event FG72 (soybean, herbicide tolerance, deposited as PTA-11041, described in WO2011/063413), Event GA21 (corn, herbicide tolerance, deposited as ATCC 209033, described in US-A 2005-086719 or WO 98/044140); Event GG25 (corn, herbicide tolerance, deposited as ATCC 209032, described in US-A 2005-188434 or WO98/044140); Event GHB119 (cotton, insect control - herbicide tolerance, deposited as ATCC PTA-8398, described in WO2008/151780); Event GHB614 (cotton, herbicide tolerance, deposited as ATCC PTA-6878, described in US-A 2010-050282 or WO2007/017186); Event GM (corn, herbicide tolerance, deposited as ATCC 209030, described in US-A 2005-188434 or WO98/044140); Event GM RZ13 (sugar beet, virus resistance, deposited as NCIMB-41601, described in WO2010/076212); Event H7-1 (sugar beet, herbicide tolerance, deposited as NCIMB 41158 or NCIMB 41159, described in US-A 2004-172669 or WO 2004/074492); Event JOPLIN1 (wheat, disease tolerance, not deposited, described in US-A 2008-064032); Event LL27 (soybean, herbicide tolerance, deposited as NCIMB41658, described in WO2006/108674 or US-A 2008-320616); Event LL55 (soybean, herbicide tolerance, deposited as NCIMB 41660, described in WO 2006/108675 or US-A 2008-196127); Event LLcotton25 (cotton, herbicide tolerance, deposited as ATCC PTA-3343, described in WO2003/013224 or US- A 2003-097687); Event LLRICE06 (rice, herbicide tolerance, deposited as ATCC 203353, described in US 6,468,747 or WO2000/026345); Event LLRice62 (rice, herbicide tolerance, deposited as ATCC 203352, described in WO2000/026345), Event LLRICE601 (rice, herbicide tolerance, deposited as ATCC PTA-2600, described in US-A 2008-2289060 or WO2000/026356); Event LY038 (corn, quality trait, deposited as ATCC PTA-5623, described in US-A 2007-028322 or WO2005/061720); Event MIR162 (corn, insect control, deposited as PTA-8166, described in US-A 2009-300784 or WO2007/142840); Event MIR604 (corn, insect control, not deposited, described in US-A 2008-167456 or WO2005/103301); Event MON15985 (cotton, insect control, deposited as ATCC PTA-2516, described in US-A 2004-250317 or WO2002/100163); Event MON810 (corn, insect control, not deposited, described in US-A 2002-102582); Event MON863 (corn, insect control, deposited as ATCC PTA-2605, described in WO2004/011601 or US-A 2006-095986); Event MON87427 (corn, pollination control, deposited as ATCC PTA-7899, described in WO2011/062904); Event MON87460 (corn, stress tolerance, deposited as ATCC PTA-8910, described in WO2009/111263 or US-A 2011-0138504); Event MON87701 (soybean, insect control, deposited as ATCC PTA-8194, described in US-A 2009-130071 or WO2009/064652); Event MON87705 (soybean, quality trait - herbicide tolerance, deposited as ATCC PTA-9241, described in US-A 2010-0080887 or WO2010/037016); Event MON87708 (soybean, herbicide tolerance, deposited as ATCC PTA-9670, described in WO2011/034704); Event MON87712 (soybean, yield, deposited as PTA-10296, described in WO2012/051199), Event MON87754 (soybean, quality trait, deposited as ATCC PTA-9385, described in WO2010/024976); Event MON87769 (soybean, quality trait, deposited as ATCC PTA-8911, described in US-A 2011-0067141 or WO2009/102873); Event MON88017 (corn, insect control - herbicide tolerance, deposited as ATCC PTA-5582, described in US-A 2008-028482 or WO2005/059103); Event MON88913 (cotton, herbicide tolerance, deposited as ATCC PTA-4854, described in WO2004/072235 or US-A 2006-059590); Event MON88302 (oilseed rape, herbicide tolerance, deposited as PTA-10955, described in WO2011/153186), Event MON88701 (cotton, herbicide tolerance, deposited as PTA-11754, described in WO2012/134808), Event MON89034 (corn, insect control, deposited as ATCC PTA-7455, described in WO 07/140256 or US-A 2008-260932); Event MON89788 (soybean, herbicide tolerance, deposited as ATCC PTA-6708, described in US-A 2006-282915 or WO2006/130436); Event MS11 (oilseed rape, pollination control - herbicide tolerance, deposited as ATCC PTA-850 or PTA-2485, described in WO2001/031042); Event MS8 (oilseed rape, pollination control-herbicide tolerance, deposited as ATCC PTA-730, described in WO2001/041558 or US-A 2003-188347); Event NK603 (corn, herbicide tolerance, deposited as ATCC PTA-2478, described in US-A 2007-292854); Event PE-7 (rice, insect control, not deposited, described in WO2008/114282); Event RF3 (oilseed rape, pollination control - herbicide tolerance, deposited as ATCC PTA-730, described in WO2001/041558 or US-A 2003-188347); Event RT73 (oilseed rape, herbicide tolerance, not deposited, described in WO2002/036831 or US-A 2008-070260); Event SYHT0H2/SYN-000H2-5 (soybean, herbicide tolerance, deposited as PTA-11226, described in WO2012/082548), Event T227-1 (sugar beet, herbicide tolerance, not deposited, described in WO2002/44407 or US-A 2009-265817); Event T25 (corn, herbicide tolerance, not deposited, described in US-A 2001-029014 or WO2001/051654); Event T304-40 (cotton, insect control-herbicide tolerance, deposited as ATCC PTA-8171, described in US-A 2010-077501 or WO2008/122406); Event T342-142 (cotton, insect control, not deposited, described in WO2006/128568); Event TC1507 (corn, insect control-herbicide tolerance, not deposited, described in US-A 2005-039226 or WO2004/099447); Event VIP1034 (corn, insect control-herbicide tolerance, deposited as ATCC PTA-3925, described in WO2003/052073), Event 32316 (corn, insect control-herbicide tolerance, deposited as PTA-11507, described in WO2011/084632), Event 4114 (corn, insect control-herbicide tolerance, deposited as PTA-11506, described in WO2011/084621), event EE-GM3 / FG72 (soybean, herbicide tolerance, ATCC Accession N° PTA-11041) optionally stacked with event EE-GM1/LL27 or event EE-GM2/LL55 (WO2011/063413A2), event DAS-68416-4 (soybean, herbicide tolerance, ATCC Accession N° PTA-10442, WO2011/066360A1), event DAS-68416-4 (soybean, herbicide tolerance, ATCC Accession N° PTA-10442, WO2011/066384A1), event DP-040416-8 (corn, insect control, ATCC Accession N° PTA-11508, WO2011/075593A1), event DP-043A47-3 (corn, insect control, ATCC Accession N° PTA-11509, WO2011/075595A1), event DP-004114-3 (corn, insect control, ATCC Accession N° PTA-11506, WO2011/084621A1), event DP-032316-8 (corn, insect control, ATCC Accession N° PTA-11507, WO2011/084632A1), event MON-88302-9 (oilseed rape, herbicide tolerance, ATCC Accession N° PTA-10955, WO2011/153186A1), event DAS-21606-3 (soybean, herbicide tolerance, ATCC Accession No. PTA-11028, WO2012/033794A2), event MON-87712-4 (soybean, quality trait, ATCC Accession N°. PTA-10296, WO2012/051199A2), event DAS-44406-6 (soybean, stacked herbicide tolerance, ATCC Accession N°. PTA-11336, WO2012/075426A1), event DAS-14536-7 (soybean, stacked herbicide tolerance, ATCC Accession N°. PTA-11335, WO2012/075429A1), event SYN-000H2-5 (soybean, herbicide tolerance, ATCC Accession N°. PTA-11226, WO2012/082548A2), event DP-061061-7 (oilseed rape, herbicide tolerance, no deposit N° available, WO2012071039A1), event DP-073496-4 (oilseed rape, herbicide tolerance, no deposit N° available, US2012131692), event 8264.44.06.1 (soybean, stacked herbicide tolerance, Accession N° PTA-11336, WO2012075426A2), event 8291.45.36.2 (soybean, stacked herbicide tolerance, Accession N°. PTA-11335, WO2012075429A2), event SYHT0H2 (soybean, ATCC Accession N°. PTA-11226, WO2012/082548A2), event MON88701 (cotton, ATCC Accession N° PTA-11754, WO2012/134808A1), event KK179-2 (alfalfa, ATCC Accession N° PTA-11833, WO2013/003558A1), event pDAB8264.42.32.1 (soybean, stacked herbicide tolerance, ATCC Accession N° PTA-11993, WO2013/010094A1), event MZDTO9Y (corn, ATCC Accession N° PTA-13025, WO2013/012775A1).

Further, a list of such transgenic event(s) is provided by the United States Department of Agriculture's (USDA) Animal and Plant Health Inspection Service (APHIS) and can be found on their website on the world wide web at aphis.usda.gov. For this application, the status of such list as it is/was on the filing date of this application, is relevant.

The genes/events which impart the desired traits in question may also be present in combinations with one another in the transgenic plants. Examples of transgenic plants which may be mentioned are the important crop plants, such as cereals (wheat, rice, triticale, barley, rye, oats), maize, soya beans, potatoes, sugar beet, sugar cane, tomatoes, peas and other types of vegetable, cotton, tobacco, oilseed rape and also fruit plants (with the fruits apples, pears, citrus fruits and grapes), with particular emphasis being given to maize, soya beans, wheat, rice, potatoes, cotton, sugar cane, tobacco and oilseed rape. Traits which are particularly emphasized are the increased resistance of the plants to insects, arachnids, nematodes and slugs and snails, as well as the increased resistance of the plants to one or more herbicides.

Commercially available examples of such plants, plant parts or plant seeds that may be treated with preference in accordance with the invention include commercial products, such as plant seeds, sold or distributed under the GENUITY®, DROUGHTGARD®, SMARTSTAX®, RIB COMPLETE®, ROUNDUP READY®, VT DOUBLE PRO®, VT TRIPLE PRO®, BOLLGARD II®, ROUNDUP READY 2 YIELD®, YIELDGARD®, ROUNDUP READY® 2 XTEN^{DTM}, INTACTA RR2 PRO®, VISTIVE GOLD®, and/or XTENDFLEX™ trade names.

Pathogens

Non-limiting examples of pathogens of fungal diseases which may be treated in accordance with the invention include:

diseases caused by powdery mildew pathogens, for example Blumeria species, for example Blumeria graminis; Podosphaera species, for example Podosphaera leucotricha; Sphaerotheca species, for example Sphaerotheca fuliginea; Uncinula species, for example Uncinula necator;

diseases caused by rust disease pathogens, for example Gymnosporangium species, for example Gymnosporangium sabinae; Hemileia species, for example Hemileia vastatrix; Phakopsora species, for example Phakopsora pachyrhizi or Phakopsora meibomiae; Puccinia species, for example Puccinia recondita, Puccinia graminis oder Puccinia striiformis; Uromyces species, for example Uromyces appendiculatus;

diseases caused by pathogens from the group of the Oomycetes, for example Albugo species, for example Albugo candida; Bremia species, for example Bremia lactucae; Peronospora species, for example Peronospora pisi or P. brassicae; Phytophthora species, for example Phytophthora infestans; Plasmopara species, for example Plasmopara viticola; Pseudoperonospora species, for example Pseudoperonospora humuli or Pseudoperonospora cubensis; Pythium species, for example Pythium ultimum;

leaf blotch diseases and leaf wilt diseases caused, for example, by Alternaria species, for example Alternaria solani; Cercospora species, for example Cercospora beticola; Cladiosporium species, for example Cladiosporium cucumerinum; Cochliobolus species, for example Cochliobolus sativus (conidial form: Drechslera, syn: Helminthosporium) or Cochliobolus miyabeanus; Colletotrichum species, for example Colletotrichum lindemuthanium; Corynespora species, for example Corynespora cassiicola; Cycloconium species, for example Cycloconium oleaginum; Diaporthe species, for example Diaporthe citri; Elsinoe species, for example Elsinoe fawcettii; Gloeosporium species, for example Gloeosporium laeticolor; Glomerella species, for example Glomerella cingulata; Guignardia species, for example Guignardia bidwelli; Leptosphaeria species, for example Leptosphaeria maculans; Magnaporthe species, for example Magnaporthe grisea; Microdochium species, for example Microdochium nivale; Mycosphaerella species, for example Mycosphaerella graminicola, Mycosphaerella arachidicola or Mycosphaerella fijiensis; Phaeosphaeria species, for example Phaeosphaeria nodorum; Pyrenophora species, for example Pyrenophora teres or Pyrenophora tritici repentis; Ramularia species, for example Ramularia collo-cygni or Ramularia areola; Rhynchosporium species, for example Rhynchosporium secalis; Septoria species, for example Septoria apii or Septoria lycopersici; Stagonospora species, for example Stagonospora nodorum; Typhula species, for example Typhula incarnata; Venturia species, for example Venturia inaequalis;

root and stem diseases caused, for example, by Corticium species, for example Corticium graminearum; Fusarium species, for example Fusarium oxysporum; Gaeumannomyces species, for example Gaeumannomyces graminis; Plasmodiophora species, for example Plasmodiophora brassicae; Rhizoctonia species, for example Rhizoctonia solani; Sarocladium species, for example Sarocladium oryzae; Sclerotium species, for example Sclerotium oryzae; Tapesia species, for example Tapesia acuformis; Thielaviopsis species, for example Thielaviopsis basicola;

ear and panicle diseases (including corn cobs) caused, for example, by Alternaria species, for example Alternaria spp.; Aspergillus species, for example Aspergillus flavus; Cladosporium species, for example Cladosporium cladosporioides; Claviceps species, for example Claviceps purpurea; Fusarium species, for example Fusarium culmorum; Gibberella species, for example Gibberella zeae; Monographella species, for example Monographella nivalis; Stagnospora species, for example Stagnospora nodorum;

diseases caused by smut fungi, for example Sphacelotheca species, for example Sphacelotheca reiliana; Tilletia species, for example Tilletia caries or Tilletia controversa; Urocystis species, for example Urocystis occulta; Ustilago species, for example Ustilago nuda;

fruit rot caused, for example, by Aspergillus species, for example Aspergillus flavus; Botrytis species, for example Botrytis cinerea; Monilinia species, for example Monilinia taxa; Penicillium species, for example Penicillium expansum or Penicillium purpurogenum; Rhizopus species, for example Rhizopus stolonifer; Sclerotinia species, for example Sclerotinia sclerotiorum; Verticilium species, for example Verticilium alboatrum;

seed- and soil-borne rot and wilt diseases, and also diseases of seedlings, caused, for example, by Alternaria species, for example Alternaria brassicicola; Aphanomyces species, for example Aphanomyces euteiches; Ascochyta species, for example Ascochyta lentis; Aspergillus species, for example Aspergillus flavus; Cladosporium species, for example Cladosporium herbarum; Cochliobolus species, for example Cochliobolus sativus (conidial form: Drechslera, Bipolaris Syn: Helminthosporium); Colletotrichum species, for example Colletotrichum coccodes; Fusarium species, for example Fusarium culmorum; Gibberella species, for example Gibberella zeae; Macrophomina species, for example Macrophomina phaseolina; Microdochium species, for example Microdochium nivale; Monographella species, for example Monographella nivalis; Penicillium species, for example Penicillium expansum; Phoma species, for example Phoma lingam; Phomopsis species, for example Phomopsis sojae; Phytophthora species, for example Phytophthora cactorum; Pyrenophora species, for example Pyrenophora graminea; Pyricularia species, for example Pyricularia oryzae; Pythium species, for example Pythium ultimum; Rhizoctonia species, for example Rhizoctonia solani; Rhizopus species, for example Rhizopus oryzae; Sclerotium species, for example Sclerotium rolfsii; Septoria species, for example Septoria nodorum; Typhula species, for example Typhula incarnata; Verticillium species, for example Verticillium dahliae;

cancers, galls and witches' broom caused, for example, by Nectria species, for example Nectria galligena;

wilt diseases caused, for example, by Verticillium species, for example Verticillium longisporum; Fusarium species, for example Fusarium oxysporum;

deformations of leaves, flowers and fruits caused, for example, by Exobasidium species, for example Exobasidium vexans; Taphrina species, for example Taphrina deformans;

degenerative diseases in woody plants, caused, for example, by Esca species, for example Phaeomoniella chlamydospora, Phaeoacremonium aleophilum or Fomitiporia mediterranea; Ganoderma species, for example Ganoderma boninense;

diseases of plant tubers caused, for example, by Rhizoctonia species, for example Rhizoctonia solani; Helminthosporium species, for example Helminthosporium solani;

diseases caused by bacterial pathogens, for example Xanthomonas species, for example Xanthomonas campestris pv. oryzae; Pseudomonas species, for example Pseudomonas syringae pv. lachrymans; Erwinia species, for example Erwinia amylovora; Liberibacter species, for example Liberibacter asiaticus; Xyella species, for example Xylella fastidiosa; Ralstonia species, for example Ralstonia solanacearum; Dickeya species, for example Dickeya solani; Clavibacter species, for example Clavibacter michiganensis; Streptomyces species, for example Streptomyces scabies.

diseases of soya beans:

Fungal diseases on leaves, stems, pods and seeds caused, for example, by Alternaria leaf spot (Alternaria spec. atrans tenuissima), Anthracnose (Colletotrichum gloeosporoides dematium var. truncatum), brown spot (Septoria glycines), cercospora leaf spot and blight (Cercospora kikuchii), choanephora leaf blight (Choanephora infitndibulifera trispora (Syn.)), dactuliophora leaf spot (Dactuliophora glycines), downy mildew (Peronospora manshurica), drechslera blight (Drechslera glycini), frogeye leaf spot (Cercospora sojina), leptosphaerulina leaf spot (Leptosphaerulina trifolii), phyllostica leaf spot (Phyllosticta sojaecola), pod and stem blight (Phomopsis sojae), powdery mildew (Microsphaera diffusa), pyrenochaeta leaf spot (Pyrenochaeta glycines), rhizoctonia aerial, foliage, and web blight (Rhizoctonia solani), rust (Phakopsora pachyrhizi, Phakopsora meibomiae), scab (Sphaceloma glycines), stemphylium leaf blight (Stemphylium botryosum), sudden death syndrome (Fusarium virguliforme), target spot (Corynespora cassiicola).

Fungal diseases on roots and the stem base caused, for example, by black root rot (Calonectria crotalariae), charcoal rot (Macrophomina phaseolina), fusarium blight or wilt, root rot, and pod and collar rot (Fusarium oxysporum, Fusarium orthoceras, Fusarium semitectum, Fusarium equiseti), mycoleptodiscus root rot (Mycoleptodiscus terrestris), neocosmospora (Neocosmospora vasinfecta), pod and stem blight (Diaporthe phaseolorum), stem canker (Diaporthe phaseolorum var. caulivora), phytophthora rot (Phytophthora megasperma), brown stem rot (Phialophora gregata), pythium rot (Pythium aphanidermatum, Pythium irregulare, Pythium debaryanum, Pythium myriotylum, Pythium ultimum), rhizoctonia root rot, stem decay, and damping-off (Rhizoctonia solani), sclerotinia stem decay (Sclerotinia sclerotiorum), sclerotinia southern blight (Sclerotinia thielaviopsis root rot (Thielaviopsis basicola).

Preferably, the active compound combinations according to the invention are effective against at least one of the following plant pathogens

Venturia, Sclerotinia, Rhizoctonia; Plasmodiophora; Helminthosporium, Phytium, Altemaria; Cercospora; Cladiosporium; Cochliobolus; Colletotrichum; Diaporthe; Gloeosporium; Corynespora; Guignardia; Elsinoe; Magnaporthe; Microdochium; Mycosphaerella; Pyrenophora; Pyricularia; Ramularia; Rhynchosporium; Botrytis, Phytophthora; Bremia; Peronospora; Plasmopara; Pseudoperonospora, Puccinia; Hemileia; Phakopsora; Uromyces; Blumeria; Podosphaera; Sphaerotheca; Uncinula, Fusarium, Septoria, Aspergillus; Cladosporium; Claviceps; Gibberella; Monographella, Sphacelotheca; Tilletia; Ustilago, Monilinia; Rhizopus; Verticillium, Taphrina, Xanthomonas; Pseudomonas; Erwinia; Liberibacter; Xyella; Ralstonia; Clavibacter; Streptomyces, Anthracnose; Cercospora; Phomopsis; Stemphylium; Corynespora; Diaporthe.

It is most preferred that the plant pathogen is selected from Plasmopara viticola and Uncinula necator.

Mycotoxins

In addition, the compound combination and the composition of the invention may reduce the mycotoxin content in the harvested material and the foods and feeds prepared therefrom. Mycotoxins include particularly, but not exclusively, the following: deoxynivalenol (DON), nivalenol, 15-Ac-DON, 3-Ac-DON, T2- and HT2-toxin, fumonisins, zearalenon, moniliformin, fusarin, diaceotoxyscirpenol (DAS), beauvericin, enniatin, fusaroproliferin, fusarenol, ochratoxins, patulin, ergot alkaloids and aflatoxins which can be produced, for example, by the following fungi: Fusarium spec., such as F. acuminatum, F. asiaticum, F. avenaceum, F. crookwellense, F. culmorum, F. graminearum (Gibberella zeae), F. equiseti, F. fujikoroi, F. musarum, F. oxysporum, F. proliferatum, F. poae, F. pseudograminearum, F. sambucinum, F. scirpi, F. semitectum, F. solani, F. sporotrichoides, F. langsethiae, F. subglutinans, F. tricinctum, F. verticillioides, and also by Aspergillus spec., such as A. flavus, A. parasiticus, A. nomius, A. ochraceus, A. clavatus, A. terreus, A. versicolor, Penicillium spec., such as P. verrucosum, P. viridicatum, P. citrinum, P. expansum, P. claviforme, P. roqueforti, Claviceps spec., such as C. purpurea, C. fusiformis, C. paspali, C. africana, Stachybotrys spec. and others.

Accordingly, the present invention also relates to a method for reducing the mycotoxin contant in harvested material and foods and/or feed prepared therefrom, comprising applying the active compound combination or the composition according to the invention to a plant, plant parts, fruits, seeds or soil.

Material Protection

The compound combination and the composition of the invention may also be used in the protection of materials, especially for the protection of industrial materials against attack and destruction by phytopathogenic fungi.

In addition, the compound combination and the composition of the invention may be used as antifouling compositions, alone or in combinations with other active ingredients.

Industrial materials in the present context are understood to mean inanimate materials which have been prepared for use in industry. For example, industrial materials which are to be protected from microbial alteration or destruction may be adhesives, glues, paper, wallpaper and board/cardboard, textiles, carpets, leather, wood, fibers and tissues, paints and plastic articles, cooling lubricants and other materials which can be infected with or destroyed by microorganisms. Parts of production plants and buildings, for example cooling-water circuits, cooling and heating systems and ventilation and air-conditioning units, which may be impaired by the proliferation of microorganisms may also be mentioned within the scope of the materials to be protected. Industrial materials within the scope of the present invention preferably include adhesives, sizes, paper and card, leather, wood, paints, cooling lubricants and heat transfer fluids, more preferably wood.

The compound combination and the composition of the invention may prevent adverse effects, such as rotting, decay, discoloration, decoloration or formation of mould.

In the case of treatment of wood the compound combination and the composition of the invention may also be used against fungal diseases liable to grow on or inside timber.

Timber means all types of species of wood, and all types of working of this wood intended for construction, for example solid wood, high-density wood, laminated wood, and plywood. In addition, the compound and the composition of the invention may be used to protect objects which come into contact with saltwater or brackish water, especially hulls, screens, nets, buildings, moorings and signalling systems, from fouling

The compound combination and the composition of the invention may also be employed for protecting storage goods. Storage goods are understood to mean natural substances of vegetable or animal origin or processed products thereof which are of natural origin, and for which long-term protection is desired. Storage goods of vegetable origin, for example plants or plant parts, such as stems, leaves, tubers, seeds, fruits, grains, may be protected freshly harvested or after processing by (pre)drying, moistening, comminuting, grinding, pressing or roasting. Storage goods also include timber, both unprocessed, such as construction timber, electricity poles and barriers, or in the font) of finished products, such as furniture. Storage goods of animal origin are, for example, hides, leather, furs and hairs. The compound combination and the composition of the invention may prevent adverse effects, such as rotting, decay, discoloration, decoloration or formation of mould.

Microorganisms capable of degrading or altering industrial materials include, for example, bacteria, fungi, yeasts, algae and slime organisms. The compound combination and the composition of the invention preferably act against fungi, especially moulds, wood-discoloring and wood-destroying fungi (Ascomycetes, Basidiomycetes, Deuteromycetes and Zygomycetes), and against slime organisms and algae. Examples include microorganisms of the following genera: Alternaria, such as Alternaria tenuis; Aspergillus, such as Aspergillus niger; Chaetomium, such as Chaetomium globosum; Coniophora, such as Coniophora puetana; Lentinus, such as Lentinus tigrinus; Penicillium, such as Penicillium glaucum; Polyporus, such as Polyporus versicolor; Aureobasidium, such as Aureobasidium pullulans; Sclerophoma, such as Sclerophoma pityophila; Trichoderma, such as Trichoderma viride; Ophiostoma spp., Ceratocystis spp., Humicola spp., Petriella spp., Trichurus spp., Coriolus spp., Gloeophyllum spp., Pleurotus spp., Poria spp., Serpula spp. and Tyromyces spp., Cladosporium spp., Paecilomyces spp. Mucor spp Escherichia, such as Escherichia coli; Pseudomonas, such as Pseudomonas aeruginosa; Staphylococcus, such as Staphylococcus aureus, Candida spp. and Saccharomyces spp., such as Saccharomyces cerevisae.

Seed Treatment

The compound combination and the composition of the invention may also be used to protect seeds from unwanted microorganisms, such as phytopathogenic microorganisms, for instance phytopathogenic fungi or phytopathogenic oomycetes. The term seed(s) as used herein include dormant seeds, primed seeds, pregerminated seeds and seeds with emerged roots and leaves.

Thus, the present invention also relates to a method for protecting seeds from unwanted microorganisms which comprises the step of treating the seeds with the compound combination or the composition of the invention, wherein the seeds may be treated simultaneously, separately or sequentially with the compounds (A) and (B).

The treatment of seeds with the compound combination or the composition of the invention protects the seeds from phytopathogenic microorganisms, but also protects the germinating seeds, the emerging seedlings and the plants after emergence from the treated seeds. Therefore, the present invention also relates to a method for protecting seeds, germinating seeds and emerging seedlings

The seeds treatment may be performed prior to sowing, at the time of sowing or shortly thereafter.

When the seeds treatment is performed prior to sowing (e.g. so-called on-seed applications), the seeds treatment may be performed as follows: the seeds may be placed into a mixer with a desired amount of the compound combination or the composition of the invention, the seeds and the compound combination or the composition of the invention are mixed until an homogeneous distribution on seeds is achieved. If appropriate, the seeds may then be dried.

The invention also relates to seeds coated with the compound combination or the composition of the invention.

Preferably, the seeds are treated in a state in which it is sufficiently stable for no damage to occur in the course of treatment. In general, seeds can be treated at any time between harvest and shortly after sowing. It is customary to use seeds which have been separated from the plant and freed from cobs, shells, stalks, coats, hairs or the flesh of the fruits. For example, it is possible to use seeds which have been harvested, cleaned and dried down to a moisture content of less than 15% by weight. Alternatively, it is also possible to use seeds which, after drying, for example, have been treated with water and then dried again, or seeds just after priming, or seeds stored in primed conditions or pre-germinated seeds, or seeds sown on nursery trays, tapes or paper.

The amount of the compound combination or the composition of the invention applied to the seeds is typically such that the germination of the seed is not impaired, or that the resulting plant is not damaged. This must be ensured particularly in case the compounds contained in the compound combination of the invention would exhibit phytotoxic effects at certain application rates. The intrinsic phenotypes of transgenic plants should also be taken into consideration when determining the amount of the compound combination of the invention to be applied to the seed in order to achieve optimum seed and germinating plant protection with a minimum amount of compound being employed.

The compounds contained in the compound combination of the invention can be applied as such, directly to the seeds, i.e. without the use of any other components and without having been diluted. They can be applied in a simultaneous, separate or sequential manner. Also compositions containing the compounds contained in the compound combination of the invention, such as the composition of the invention, can be applied to the seeds.

The compound combination and the composition of the invention are suitable for protecting seeds of any plant variety. Preferred seeds are that of cereals (such as wheat, barley, rye, millet, triticale, and oats), oilseed rape, maize, cotton, soybean, rice, potatoes, sunflower, beans, coffee, peas, beet (e.g. sugar beet and fodder beet), peanut, vegetables (such as tomato, cucumber, onions and lettuce), lawns and ornamental plants. More preferred are seeds of wheat, soybean, oilseed rape, maize and rice.

The compound combination and the composition of the invention may be used for treating transgenic seeds, in particular seeds of plants capable of expressing a polypeptide or protein which acts against pests, herbicidal damage or abiotic stress, thereby increasing the protective effect. Seeds of plants capable of expressing a polypeptide or protein which acts against pests, herbicidal damage or abiotic stress may contain at least one heterologous gene which allows the expression of said polypeptide or protein. These heterologous genes in transgenic seeds may originate, for example, from microorganisms of the species Bacillus, Rhizobium, Pseudomonas, Serratia, Trichoderma, Clavibacter, Glomus or Gliocladium. These heterologous genes preferably originate from Bacillus sp., in which case the gene product is effective against the European corn borer and/or the Western corn rootworm. Particularly preferably, the heterologous genes originate from Bacillus thuringiensis.

Application

The compound combination of the invention can be applied as such, or for example in the form of as ready-to-use solutions, emulsions, water- or oil-based suspensions, powders, wettable powders, pastes, soluble powders, dusts, soluble granules, granules for broadcasting, suspoemulsion concentrates, natural products impregnated with the compound combination of the invention, synthetic substances impregnated with the compound combination of the invention, fertilizers or microencapsulations in polymeric substances.

Application is accomplished in a customary manner, for example by watering, spraying, atomizing, broadcasting, dusting, foaming or spreading-on. It is also possible to deploy the compound combination of the invention by the ultra-low volume method, via a drip irrigation system or drench application, to apply it in-furrow or to inject it into the soil stem or trunk. It is further possible to apply the compound combination of the invention by means of a wound seal, paint or other wound dressing.The effective and plant-compatible amount of the compound combination of the invention which is applied to the plants, plant parts, fruits, seeds or soil will depend on various factors, such as the compound/composition employed, the subject of the treatment (plant, plant part, fruit, seed or soil), the type of treatment (dusting, spraying, seed dressing), the purpose of the treatment (curative and protective), the type of microorganisms, the development stage of the microorganisms, the sensitivity of the microorganisms, the crop growth stage and the environmental conditions.

When the compound combination of the invention is used as a fungicide, the application rates can vary within a relatively wide range, depending on the kind of application. For the treatment of plant parts, such as leaves, the application rate may range from 0.1 to 10 000 g/ha, preferably from 10 to 1000 g/ha, more preferably from 50 to 300 g/ha (in the case of application by watering or dripping, it is even possible to reduce the application rate, especially when inert substrates such as rockwool or perlite are used). For the treatment of seeds, the application rate may range from 0.1 to 200 g per 100 kg of seeds, preferably from 1 to 150 g per 100 kg of seeds, more preferably from 2.5 to 25 g per 100 kg of seeds, even more preferably from 2.5 to 12.5 g per 100 kg of seeds. For the treatment of soil, the application rate may range from 0.1 to 10 000 g/ha, preferably from 1 to 5000 g/ha. The outlined application rates refer to the total application rates of compounds (A) and (B) present in the compound combination of the present invention.

These application rates are merely examples and are not intended to limit the scope of the present invention.

The compound combination of the invention can be used in combination with models e.g. embedded in computer programs for site specific crop management, satellite farming, precision farming or precision agriculture. Such models support the site specific management of agricultural sites with data from various sources such as soils, weather, crops (e.g. type, growth stage, plant health), weeds (e.g. type, growth stage), diseases, pests, nutrients, water, moisture, biomass, satellite data, yield etc. with the purpose to optimize profitability, sustainability and protection of the environment. In particular, such models can help to optimize agronomical decisions, control the precision of pesticide applications and record the work performed.

As an example, the compound of the invention can be applied to a crop plant according to appropriate dose regime if a model models the development of a fungal disease and calculates that a threshold has been reached for which it is recommendable to apply the compound of the invention to the crop plant.

Commercially available systems which include agronomic models are e.g. FieldScripts™ from The Climate Corporation, Xarvio™ from BASF, AGLogic™ from John Deere, etc.

The compounds of the invention can also be used in combination with smart spraying equipment such as e.g. spot spraying or precision spraying equipment attached to or housed within a farm vehicle such as a tractor, robot, helicopter, airplane, unmanned aerial vehicle (UAV) such as a drone, etc. Such an equipment usually includes input sensors (such as e.g. a camera) and a processing unit configured to analyze the input data and configured to provide a decision based on the analysis of the input data to apply the compound of the invention to the crop plants (respectively the weeds) in a specific and precise manner. The use of such smart spraying equipment usually also requires positions systems (e.g. GPS receivers) to localize recorded data and to guide or to control farm vehicles; geographic information systems (GIS) to represent the information on intelligible maps, and appropriate farm vehicles to perform the required farm action such as the spraying.

In an example, fungal diseases can be detected from imagery acquired by a camera. In an example fungal diseases can be identified and/or classified based on that imagery. Such identification and/ classification can make use of image processing algorithms. Such image processing algorithms can utilize machine learning algorithms, such as trained neutral networks, decision trees and utilize artificial intelligence algorithms. In this manner, the compounds described herein can be applied only where needed.

The advanced fungicidal activity of the active compound combinations according to the invention is evident from the example below. While the individual active compounds exhibit weaknesses with regard to the fungicidal activity, the combinations have an activity which exceeds a simple addition of activities.

A synergistic effect of fungicides is always present when the fungicidal activity of the active compound combinations exceeds the total of the activities of the active compounds when applied individually. The expected activity for a given combination of two active compounds can be calculated as follows (cf. Colby, S. R., “Calculating Synergistic and Antagonistic Responses of Herbicide Combinations”, Weeds 1967, 15, 20-22):

If
X is the efficacy when active compound A is applied at an application rate of m ppm (or g/ha),
Y is the efficacy when active compound B is applied at an application rate of n ppm (or g/ha),
E is the efficacy when the active compounds A and B are applied at application rates of m and n ppm (or g/ha), respectively, and

then

$$E = X + Y - \frac{X \cdot Y}{100}$$

The degree of efficacy, expressed in % is denoted. 0% means an efficacy which corresponds to that of the control while an efficacy of 100% means that no disease is observed.

If the actual fungicidal activity exceeds the calculated value, then the activity of the combination is superadditive, i.e. a synergistic effect exists. In this case, the efficacy which was actually observed must be greater than the value for the expected efficacy (E) calculated from the abovementioned formula.

A further way of demonstrating a synergistic effect is the method of Tammes (cf. “Isoboles, a graphic representation of synergism in pesticides” in Neth. J. Plant Path., 1964, 70, 73-80).

The invention is illustrated by the following example. However the invention is not limited to the example.

### EXAMPLE 1

Field trials were set up with 10 grape plants per plot as per the scheme according to table 1 and 2 to test the fungicidal efficacy of one formulation comprising carboxylic acid potassium salt, one comprising copper and one comprising both agents. Sprays (foliar) were carried out in BBCA stages as described underneath tables 1 and 2 in the presence of a natural infestation of Plasmopara viticola.

TABLE 1

| Treatment | Treatment of vine grapes (Albarino) |
|---|---|
| Number | against Plasmopara viticola |
| 1. | UTC |
| 2. | 2878.8 g/ha carboxylic acid potassium salt (Flipper ®¹) |
| 3. | 2628 g/ha carboxylic acid potassium salt and 48.6 g/ha copper |
| 4. | 1235 g/ha. Copper (Funguran CO HYD) |

¹Flipper: 479.8 g/l Carboxylic Acid Potassium Salt, sprays at BBCA 55, 57, 65, 71, 75 and 77 with a water volume of 1000 l/ha, application interval between 7 and 10 days;

TABLE 2

| Treatment | Treatment of vine grapes (Barbera) |
|---|---|
| Number | against Plasmopara viticola |
| 1. | UTC |
| 2. | 1439.4 g/ha carboxylic acid potassium salt (Flipper ®¹) |
| 3. | 1314 g/ha carboxylic acid potassium salt and 24.3 g/ha copper |
| 4. | 1235 g/ha. Copper (Funguran CO HYD) |

¹Flipper: 479.8 g/l Carboxylic Acid Potassium Salt, sprays at BBCA 53, 53, 57, 69, 71, 73, 75 and 75 with a water volume of 500 l/ha, application interval between 5 and 7 days

Evaluation:

Assessment was done on bunches (50 bunches/plot) on pest severity. The efficacy was calculated according to Abbott

Results are depicted in tables 3 and 4.

TABLE 3

| Treatment | Replicate | Efficacy Abbott [%] |
|---|---|---|
| 1* | A | 36.2 |
| | B | 42.6 |
| MEAN | | |
| 2 | A | 38.1 |
| | B | 44.9 |
| MEAN | | |
| 3 | A | 55.3 |
| | B | 49.7 |
| MEAN | | |
| 4 | A | 84.7 |
| | B | 83.1 |
| MEAN | | |

Efficacy against Plasmopara viticola, *infestation level in untreated control, assessment timing: 1 day after application 6.

TABLE 4

| Treatment | Efficacy Abbot [%] |
|---|---|
| 1* | 7.6 |
| 2 | 74.6 |
| 3 | 84.2 |
| 4 | 98.7 |

Efficacy against Plasmopara viticola, *infestation level in untreated control, assessment timing 1 day after application 8

Conclusion: The combination of carboxylic acid potassium salt with a low rate of Copper provided increased activity against Plasmopara viticola in grapes, compared to carboxylic acid potassium salt applied on its own. The application of commercial rates of copper (25-fold and 50-fold, respectively, the Co-rate as compared to the Co-rate when combined with carboxylic acid potassium salt) resulted in overall higher control levels. However, by combining carboxylic acid potassium salt with a low rate of copper, good control can be achieved with less copper load for the soil.

### EXAMPLE 2

Field trials were set up with 10 grape plants per plot as per the scheme according to tables 5 and 6 to test the fungicidal efficacy of one formulation comprising carboxylic acid potassium salt, one comprising sulfur and one comprising both agents. Sprays (foliar) were carried out in BBCA stages as described underneath tables 5 and 6 in the presence of a natural infestation of Uncinula necator.

TABLE 5

| Treatment | Treatment of vine grapes (Airen) |
|---|---|
| Number | against Uncinula necator |
| 1. | UTC |
| 2. | 1919.2 g/ha carboxylic acid potassium salt (Flipper ®¹) |
| 3. | 1340 g/ha carboxylic acid potassium salt and 200 g/ha sulfur |
| 4. | 4000 g/ha. Sulfur (Sulfur 4000 G/A/HA) |

¹Flipper: 479.8 g/l Carboxylic Acid Potassium Salt, sprays at BBCA 53, 61, 68, 71, 73 and 75 with a water volume of 1000 l/ha, application interval between 7 and 15 days

TABLE 6

| Treatment | Treatment of vine grapes (Canelli) |
|---|---|
| Number | against Uncinula necator |
| 1. | UTC |
| 2. | 959.6 g/ha carboxylic acid potassium salt (Flipper ®¹) |
| 3. | 670 g/ha carboxylic acid potassium salt and 100 g/ha sulfur |
| 4. | 4000 g/ha. Sulfur (Sulfur 4000 G/A/HA) |

¹Flipper: 479.8 g/l Carboxylic Acid Potassium Salt, sprays at BBCA 53, 53, 57, 69, 71, 73, 75 and 77 with a water volume of 500 l/ha, application interval between 6 and 7 days

Evaluation: Assessment and evaluation was done according to Example 1.

Results are depicted in tables 7 and 8.

TABLE 7

| Treatment | Pest incidence | Pest Severity |
|---|---|---|
| 1* | 13.3 | 10.3 |
| 2 | 67.5 | 41.9 |
| 3 | 92.5 | 77.4 |
| 4 | 82.5 | 87.1 |

Efficacy against Uncinula necator, *infestation level in untreated control, assessment timing 7 days after application 6

TABLE 8

| Treatment | Pest incidence | Pest Severity |
|---|---|---|
| 1 | 53.3 | 1 |
| 2 | 36.3 | 90.7 |
| 3 | 76.3 | 100 |
| 4 | 56.3 | 100 |

Efficacy against Uncinula necator, *infestation level in untreated control, assessment timing 15 days after application 8

Conclusion: The combination of FLIPPER® with low rate of Sulphur (ABP580) provided increased activity against Uncinula viticola in grapes, compared to FLIPPER® (ABP617) applied on its own. The application of commercial rates of Sulphur (20 fold the S-rate of the Flipper mixture) resulted in overall higher control levels.

The combination of carboxylic acid potassium salt with a low rate of sulfur provided increased activity against Uncinula viticola in grapes, compared to carboxylic acid potassium salt applied on its own. The application of commercial rates of sulfur (20-fold the S-rate as compared to the S-rate when combined with carboxylic acid potassium salt) resulted in overall higher control levels. However, by combining carboxylic acid potassium salt with a low rate of sulfur, good control can be achieved with less sulfur load for the soil.

1. An active compound combination comprising
(a) one or more fatty acids or derivatives thereof selected from unsaturated and saturated C₁₂₋₂₄ fatty acids, salts thereof, esters thereof or mixtures of any of the foregoing; and
(b) at least one further agent active against at least one plant pathogen and/or active in plant growth promotion.

2. The combination according to claim 1, wherein said one or more fatty acids or derivatives thereof are selected from unsaturated and saturated C₁₄₋₂₀ fatty acids, salts thereof, esters thereof or mixtures of any of the foregoing.

3. The combination according to claim 1, wherein the one or more fatty acids or derivatives thereof comprises two or more fatty acids selected from C16:0 fatty acids, C16:1 fatty acids, C18:0 fatty acid, C18: lfatty acids, C18:2 fatty acids, and C18:3 fatty acids, or salts thereof.

4. The combination according to claim 1, wherein the one or more fatty acids or derivatives thereof comprises oleic acid or a salt thereof.

5. (canceled)

6. The combination according to claim 1, wherein the fatty acid derivatives are alkali metal salts of fatty acids.

7. The combination according to claim 1, wherein said fatty acid derivatives are salts of lithium, sodium, potassium, magnesium, calcium, aluminum, copper iron or zinc or a mixture thereof.

8. The combination according to claim 1, wherein component a) is a potassium salt of one or more fatty acid.

9. The combination according to claim 1, wherein said agent active against at least one plant pathogen is selected from the group consisting of
(1) inhibitors of the ergosterol synthesis,
(2) inhibitors of the respiratory chain at complex I or II,
(3) inhibitors of the respiratory chain at complex III,
(4) inhibitors of the mitosis and cell division,
(5) compounds capable of having a multisite action,
(6) compounds capable of inducing a host defense,
(7) inhibitors of the amino acid and/or protein biosynthesis,
(8) inhibitors of the ATP production,
(9) inhibitors of the cell wall synthesis,
(10) inhibitors of the lipid and membrane synthesis,
(11) inhibitors of the melanine biosynthesis,
(12) inhibitors of the nucleic acid synthesis,
(13) inhibitors of the signal transduction,
(14) compounds capable of acting as uncoupler, and
(15) other fungicides.

10-16. (canceled)

17. The combination according to claim 1, wherein said at least one agent active against at least one plant pathogen and/or active in plant growth promotion is selected from copper hydroxide, copper naphthenate, copper oxide, copper oxychloride, copper(2+) sulfate, sulfur and sulfur preparations including calcium polysulfide.

18. The combination according to claim 17, wherein said at least one agent active against at least one plant pathogen and/or active in plant growth promotion is selected from copper hydroxide and sulfur and sulfur preparations.

19. The combination according to claim 1 additionally comprising at least one auxiliary selected from the group consisting of extenders, solvents, spontaneity promoters, carriers, emulsifiers, dispersants, frost protectants, thickeners and adjuvants.

20. A seed coated with the active compound combination according to claim 1. 21-24. (Canceled)

25. A method for reducing overall damage of plants and plant parts as well as losses in harvested fruits or vegetables caused by plant pathogens comprising the step of simultaneously or sequentially applying one or more fatty acids or derivatives thereof selected from unsaturated and saturated C₁₂₋₂₄ fatty acids, salts thereof, esters thereof or mixtures of any of the foregoing and at least one further agent active against at least one plant pathogen and/or active in plant growth promotion to a plant or seed or a locus where said plant or seed is intended to be grown.

26. (canceled)

27. The method according to claim 25, wherein the plant pathogen is a strain of a genus selected from the group consisting of Venturia, Sclerotinia, Rhizoctonia; Plasmodiophora; Helminthosporium, Phytium, Alternaria; Cercospora; Cladiosporium; Cochliobolus; Colletotrichum; Diaporthe; Gloeosporium; Corynespora; Guignardia; Elsinoe; Magnaporthe; Microdochium; Mycosphaerella; Pyrcnophora; Pyricularia; Ramularia; Rhynchosporium; Botrytis, Phytophthora; Brcmia; Pcronospora; Plasmopara; Pseudoperonospora, Puccinia; Hemileia; Phakopsora; Uromyces; Blumcria; Podosphaera; Sphaerotheca; Uncinula, Fusarium, Septoria, Aspergillus; Cladosporium; Claviceps; Gibberella; Monographella, Sphacelotheca; Tilletia; Ustilago, Monilinia; Rhizopus; Verticillium, Taphrina, Xanthomonas; Pseudomonas; Envinia; Liberibacter; Xyella; Ralstonia; Clavibacter; Streptomyces, Anthracnose; Cercospora; Phomopsis; Stcmphylium; Corynespora; Diaporthe.

28. The method according to claim 27, wherein said plant pathogen is selected from Plasmopara viticola and Unicnula necator.

29. The method according to claim 25, wherein said applying is effected as a foliar or soil application or as a seed treatment.

30. A kit-of-parts comprising a biological control agent selected from the group consisting of one or more fatty acids or derivatives thereof selected from unsaturated and saturated C₁₂₋₂₄ fatty acids, salts thereof, esters thereof or mixtures of any of the foregoing and at least one further agent active against at least one plant pathogen and/or active in plant growth promotion in a spatially separated arrangement.
